(19) United States
(12) Patent Application Publication
(10) Pub. No.: US 2013/0001472 A1
(43) Pub. Date: Jan. 3, 2013

(54) THIN FILM AND COMPOUND USED IN THE SAME

(75) Inventors: Joji Ohshita, Higashihiroshima-shi (JP); Toshihiro Murafuji, Yamaguchi-shi (JP); Yusuke Kuramochi, Tokorozawa-shi (JP); Takashi Kaikoh, Tsukuba-shi (JP); Hideyuki Higashimura, Tsukuba-shi (JP)

(73) Assignees: SUMITOMO CHEMICAL COMPANY, LIMITED, Chuo-ku, Tokyo (JP); YAMAGUCHI UNIVERSITY, Yamaguchi-shi, Yamaguchi (JP); HIROSHIMA UNIVERSITY, Higashihiroshima-shi, Hiroshima (JP)

(21) Appl. No.: 13/583,177

(22) PCT Filed: Mar. 4, 2011
(86) PCT No.: PCT/JP2011/055056

§ 371 Date: Sep. 6, 2012

(30) Foreign Application Priority Data
Mar. 10, 2010 (JP) 2010-053389
May 28, 2010 (JP) 2010-122762

(51) Int. Cl. C07F 9/94; C09K 11/06; B82Y 30/00

(52) U.S. Cl. 252/301.16; 556/12; 556/68; 546/4; 556/22; 549/3; 549/209; 548/103; 548/402; 428/220; 977/755

(57) ABSTRACT

To provide a novel material exhibiting excellent light-emitting characteristics using a heavy metal element having relatively abundant reserve.

A thin film containing a compound of Formula (1):

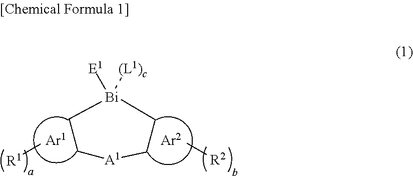

wherein Ar¹ and Ar² are each independently a C₃₋₃₀ aromatic ring; R¹ and R² are a substituent; a and b are each independently an integer of 0 to 12, wherein when a is 2 or more, each R¹ is optionally different from each other and two R¹ are optionally bonded with each other to form a ring structure, and when b is 2 or more, each R² is optionally different from each other and two R² are optionally bonded with each other to form a ring structure; A¹ is any of direct bond, —O—, —S—, —S(═O)—, —S(═O)₂—, —PR³—, —NR⁴—, and —C(—R⁵)₂—; R³ is a hydrogen atom or a substituent; R⁴ is a hydrogen atom or a substituent; R⁵ is a hydrogen atom or a substituent and two R⁵ are optionally different from each other; E¹ is a monovalent group having 50 or less carbon atoms; L¹ is a ligand having 50 or less carbon atoms; c is an integer of 0 to 3, wherein when c is 2 or more, each L¹ is optionally different from each other; and each combination of a combination of E¹ and Ar¹ and a combination of E¹ and Ar² optionally forms a bond; and when c is 1 to 3, each combination of a combination of L¹ and E¹, a combination of L¹ and Ar¹, a combination of L¹ and Ar², and a combination of L¹ and L¹ optionally forms a bond.

### TECHNICAL FIELD

The present invention relates to a thin film comprising an organic compound containing bismuth in the structural skeleton thereof, a coating liquid for forming the thin film, an element comprising the thin film, and a novel compound capable of being used in the thin film.

### BACKGROUND ART

One of the characteristics of an electronic device and an optical device using an organic compound is such a point in that, by forming a thin film controlled in a nano-scale by a method for forming the film in a solution state, a device making the most of the characteristics of the organic compound can be produced. In a device such as an organic electric field electroluminescent device (hereinafter, also called as organic EL element), an organic solar cell, and an organic transistor, which are an electronic device or an optical device of which development has been activated in recent years, such a thin film controlled in a nano-scale or a layered structure of the thin film is used.

Generally, in current excitation, by recombination of an electron and a hole, a singlet exciton and a triplet exciton are generated in a ratio of 1:3 according to the spin statistics theorem. Therefore, in an organic electroluminescent element or the like, a light-emitting material utilizing a light emission from the triplet-excited state (phosphorescence) is, in principle, superior to a material utilizing a light emission from the singlet-excited state (fluorescence) in terms of the light-emitting efficiency. A general organic compound has a singlet state as the ground state, so that a transition of the general organic compound from a triplet excited state to a ground state is a forbidden transition and usually, there is not observed a phosphorescence emission at room temperature. However, in metal complexes using a heavy atom metal or the like, this prohibition is cancelled by the “heavy atom effect” and the forbidden transition is converted into an allowed transition, so that some of such metal complexes or the like emit strong phosphorescence.

As the metal complex used for the organic EL element, a metal complex using iridium as the metal is frequently utilized (Non Patent Literature 1). However, iridium exists in an extremely small amount as a resource in the earth's crust, so that the exhaustion of iridium as the resource is feared, and in addition, iridium is expensive.

### CITATION LIST

### Non Patent Literature

Non Patent Literature 1: Highly Efficient OLEDs with Phosphorescent Materials (edited by Hartmut Yersin, Wiley-VCH Verlag GmbH & Co. KGaA) pp. 31 to 34

### SUMMARY OF THE INVENTION

### Problem to be Solved by the Invention

Taking into consideration the above situation, it is an object of the present invention to provide a novel material exhibiting an excellent light-emitting characteristic using a heavy metal element having relatively abundant reserves.

### Means for Solving Problem

As a result of assiduous research intended to overcome these disadvantages, the inventors of the present invention have found that a material excellent in a light-emitting characteristic can be obtained by using the bismuth compound described below, and have completed the present invention. That is, the present invention provides [1] to [10] below.

[1] A thin film comprising a compound of Formula (1):

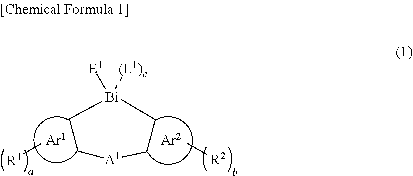

wherein Ar¹ and Ar² are each independently a C₃₋₃₀ aromatic ring; R¹ and R² are a substituent; a and b are each independently an integer of 0 to 12, wherein when a is 2 or more, each R¹ is optionally different from each other and two R¹ are optionally bonded with each other to form a ring structure, and when b is 2 or more, each R² is optionally different from each other and two R² are optionally bonded with each other to form a ring structure; A¹ is any of direct bond, —O—, —S—, —S(═O)—, —S(═O)₂—, —PR³—, —NR⁴—, and —C(—R⁵)₂—; R³ is a hydrogen atom or a substituent; R⁴ is a hydrogen atom or a substituent; R⁵ is a hydrogen atom or a substituent and two R⁵ are optionally different from each other; E¹ is a monovalent group having 50 or less carbon atoms; L¹ is a ligand having 50 or less carbon atoms; c is an integer of 0 to 3, wherein when c is 2 or more, each L¹ is optionally different from each other; and each combination of a combination of E¹ and Ar¹ and a combination of E¹ and Ar² optionally forms a bond; and when c is 1 to 3, each combination of a combination of L¹ and E¹, a combination of L¹ and Ar¹, a combination of L¹ and Ar², and a combination of L¹ and L¹ optionally forms a bond.
[2] The thin film according to above [1], wherein the compound of Formula (1) is a compound of Formula (2):

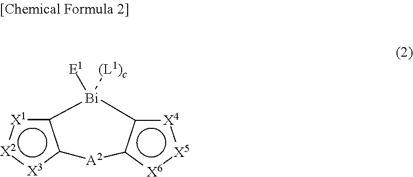

wherein A² is any of direct bond, —O—, —S—, —PR³—, —NR⁴—, and —C(—R⁵)₂—; two of X¹, X², and X³ are —CR⁶═ and remaining one thereof is —S—, —O—, or —NR⁷—; two of X⁴, X⁵, and X⁶ are —CR⁶═ and remaining one thereof is —S—, —O—, or —NR⁷—; E¹, L¹, and c are the same as defined above; R⁶ is a hydrogen atom or a substituent; R⁷ is a hydrogen atom or a substituent; when each R⁶ is adjacent to each other, each R⁶ optionally forms together with each other a bond and when R⁶ and R⁷ are adjacent to each other, R⁶ and R⁷ optionally form together with each other a bond; when X¹ or X² is —CR⁶═ or —NR⁷—, R⁶ or R⁷ optionally forms together with E¹ a bond; when X⁴ or X⁵ is —CR⁶═ or —NR⁷— and c is 1 to 3, R⁶ or R⁷ optionally forms together with L¹ a bond; and when c is 1 to 3, each combination of a combination of E¹ and L¹ and a combination of L¹ and L¹ optionally forms together with each other a bond.
[3] The thin film according to above [2], wherein, in Formula (1) or (2), A¹ or A² is direct bond; two of X¹, X², and X³ are —CR⁶═ and remaining one thereof is —S—; and two of X⁴, X⁵, and X⁶ are —CR⁶═ and remaining one thereof is —S—.
[4] A thin film comprising a compound that has a number average molecular weight in terms of polystyrene of 10³ to 10⁷ and comprises a constitutional unit composed of a structure in which one or two or more hydrogen atoms are removed from a compound of Formula (1):

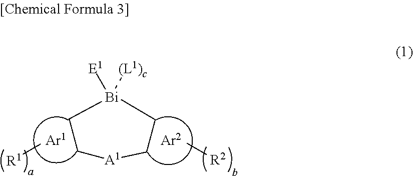

wherein Ar¹ and Ar² are each independently a C₃₋₃₀ aromatic ring; R¹ and R² are each a substituent; a and b are each independently an integer of 0 to 12, wherein when a is 2 or more, R¹ are optionally different from each other and two R¹ are optionally bonded with each other to form a ring structure, and when b is 2 or more, R² are optionally different from each other and two R² are optionally bonded with each other to form a ring structure; A¹ is any of direct bond, —O—, —S—, —S(═O)—, —S(═O)₂—, —PR³—, —NR⁴—, and —C(—R⁵)₂—; R³ is a hydrogen atom or a substituent; R⁴ is a hydrogen atom or a substituent; R⁵ is a hydrogen atom or a substituent and two R⁵ are optionally different from each other; E¹ is a monovalent group having 50 or less carbon atoms; L¹ is a ligand having 50 or less carbon atoms; c is an integer of 0 to 3, wherein when c is 2 or more, each L¹ is optionally different from each other; and each combination of a combination of E¹ and Ar¹ and a combination of E¹ and Ar² optionally forms a bond; and when c is 1 to 3, each combination of a combination of L¹ and E¹, a combination of L¹ and Ar¹, a combination of L¹ and Ar², and a combination of L¹ and L¹ optionally forms a bond.
[5] The thin film according to any one of above [1] to [4], wherein the thin film has a film thickness in a range of 0.2 nm to 1 mm.
[6] An element having the thin film according to any one of above [1] to [5].
[7] A thin film forming composition comprising a compound of Formula (1):

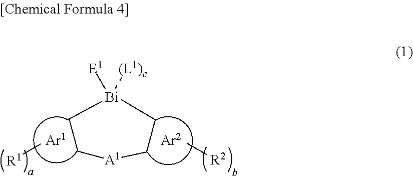

wherein Ar¹ and Ar² are each independently a C₃₋₃₀ aromatic ring; R¹ and R² are each a substituent; a and b are independently an integer of 0 to 12, wherein when a is 2 or more, each R¹ is optionally different from each other and two R¹ are optionally bonded with each other to form a ring structure, and when b is 2 or more, each R² is optionally different from each other and two R² are optionally bonded with each other to form a ring structure; A¹ is any of direct bond, —O—, —S—, —S(═O)—, —S(═O)₂—, —PR³—, —NR⁴—, and —C(—R⁵)₂—; R³ is a hydrogen atom or a substituent; R⁴ is a hydrogen atom or a substituent; R⁵ is a hydrogen atom or a substituent and two R⁵ are optionally different from each other; E¹ is a monovalent group having 50 or less carbon atoms; L¹ is a ligand having 50 or less carbon atoms; c is an integer of 0 to 3, wherein when c is 2 or more, each L¹ is optionally different from each other; and each combination of a combination of E¹ and Ar¹ and a combination of E¹ and Ar² optionally forms a bond; and when c is 1 to 3, each combination of a combination of L¹ and E¹, a combination of L¹ and Ar¹, a combination of L¹ and Ar², and a combination of L¹ and L¹ optionally forms a bond; and an organic solvent.
[8] A compound of Formula (3):

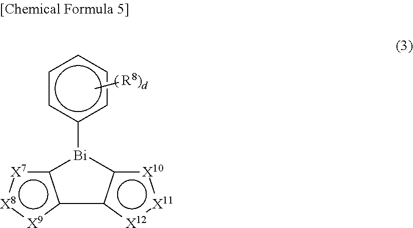

wherein R⁸ is a substituent; d is an integer of 0 to 5, wherein when d is 2 or more, each R⁸ is optionally different from each other and when each R⁸ is adjacent to each other, each R⁸ optionally forms together with each other a bond; two of X⁷, X⁸, and X⁹ are —CR⁹═ and remaining one thereof is —S—; two of X¹⁰, X¹¹, and X¹² are —CR⁹═ and remaining one thereof is —S—; R⁹ is a hydrogen atom or a substituent; a plurality of R⁹ are optionally different from each other; the substituent as R⁹ is selected from the group consisting of a hydrocarbyl group optionally having a substituent, a hydrocarbyloxy group optionally having a substituent, and a silyl group optionally having a substituent; at least one of R⁹ is the substituent; and when a plurality of R⁹ are the substituent, each R⁹ adjacent to each other optionally forms together with each other a bond.
[9] A compound of Formula (3′):

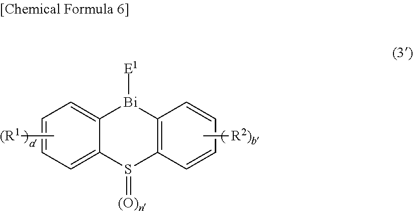

wherein R¹ and R² are a substituent; a′ and b′ are each independently an integer of 0 to 4, wherein when a′ is 2 or more, each R¹ is optionally different from each other and two R¹ are optionally bonded with each other to form a ring structure, and when b′ is 2 or more, each R² is optionally different from each other and two R² are optionally bonded with each other to form a ring structure; E¹ is a monovalent group having 50 or less carbon atoms; and n′ is 1 or 2.
[10] A compound having a number average molecular weight in terms of polystyrene of 10³ to 10⁷ and comprising a constitutional unit composed of a structure in which one or two or more hydrogen atoms are removed from a compound of Formula (1):

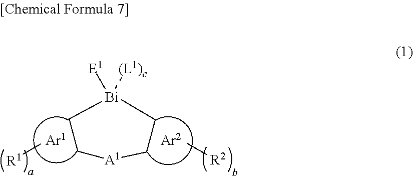

wherein Ar¹ and Ar² are each independently a C₃₋₃₀ aromatic ring; R¹ and R² are each a substituent; a and b are each independently an integer of 0 to 12, wherein when a is 2 or more, R¹ are optionally different from each other and two R¹ are optionally bonded with each other to form a ring structure, and when b is 2 or more, each R² is optionally different from each other and two R² are optionally bonded with each other to form a ring structure; A¹ is any of direct bond, —O—, —S—, —S(═O)—, —S(═O)₂—, —PR³—, —NR⁴—, and —C(—R⁵)₂—; R³ is a hydrogen atom or a substituent; R⁴ is a hydrogen atom or a substituent; R⁵ is a hydrogen atom or a substituent and two R⁵ are optionally different from each other; E¹ is a monovalent group having 50 or less carbon atoms; L¹ is a ligand having 50 or less carbon atoms; c is an integer of 0 to 3, wherein when c is 2 or more, each L¹ is optionally different from each other; and each combination of a combination of E¹ and Ar¹ and a combination of E¹ and Ar² optionally forms a bond; and when c is 1 to 3, each combination of a combination of L¹ and E¹, a combination of L¹ and Ar¹, a combination of L¹ and Ar², and a combination of L¹ and L¹ optionally forms a bond.
[11] The compound according to above [10], wherein the compound of Formula (1) is a compound of Formula (2):

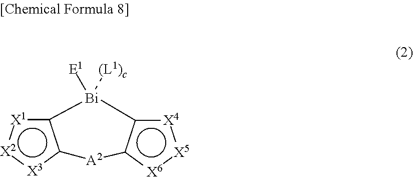

wherein A² is any of direct bond, —O—, —S—, —PR³—, —NR⁴—, and —C(—R⁵)₂—; two of X¹, X², and X³ are —CR⁶═ and remaining one thereof is —S—, —O—, or —NR⁷—; two of X⁴, X⁵, and X⁶ are —CR⁶═ and remaining one thereof is —S—, —O—, or —NR⁷—; E¹, L¹, and c are the same as defined above; R⁶ is a hydrogen atom or a substituent; R⁷ is a hydrogen atom or a substituent; when each R⁶ is adjacent to each other, R⁶ optionally forms together with each other a bond; when R⁶ and R⁷ are adjacent to each other, R⁶ and R⁷ optionally form together with each other a bond; when X¹ or X² is —CR⁶═ or —NR⁷—, R⁶ or R⁷ optionally forms together with E¹ a bond; when X⁴ or X⁵ is —CR⁶═ or —NR⁷— and c is 1 to 3, R⁶ or R⁷ optionally forms together with L¹ a bond; and when c is 1 to 3, each combination of a combination of E¹ and L¹ and a combination of L¹ and L¹ optionally forms together with each other a bond.
[12] The thin film according to above [1], wherein in the compound of Formula (1), an energy difference (S1−T1) between a lowest singlet excitation energy (S1) and a lowest triplet excitation energy (T1) obtained by a computational scientific technique is 1.5 (eV) or less.

### Effects of Invention

According to the present invention, the material contains bismuth having the heaviest isotope capable of stably existing among the elements on the Periodic Table, so that there can be provided a material excellent in a light-emitting characteristic for emitting a phosphorescence by the heavy atom effect of bismuth. Although bismuth is a heavy metal, bismuth has low toxicity, so that bismuth can provide a material applying a small amount of burden on the environment. According to the present invention, a bismuth compound having a high solubility in an organic solvent can be provided and a thin film forming composition capable of being easily applied homogeneously is provided. Using the thin film forming composition of the present invention, a thin film having a uniform thickness can be easily formed. The thin film of the present invention can be formed as a thin film causing a small amount of light emission unevenness on the film surface and generating uniform light emission. Furthermore, by using the thin film of the present invention, an element excellent in a light-emitting characteristic can be obtained.

### DESCRIPTION OF EMBODIMENTS

Hereinafter, the present invention is described. First, terms used for general purpose in the present specification are described.

In the present specification, “light-emitting property” means a property of emitting light and usually, means a property of generating light emission by an external field (such as light, electric field, magnetic field, and pressure).

In the present specification, the expression “may be substituted” or “optionally having a substituent” includes both of a case where a hydrogen atom constituting the compound or the group described immediately before the expression is not substituted and a case where a part or all of the hydrogen atoms is(are) substituted with a substituent. When the hydrogen atom is substituted with a substituent, the expression means that the hydrogen atom may be substituted with a substituent such as a halogen atom, a cyano group, a hydroxy group, a mercapto group, a carboxy group, a sulfo group, a phosphoric acid group, a nitro group, a C₀₋₃₀ amino group, a C₁₋₃₀ hydrocarbyl group, a C₁₋₃₀ hydrocarbyloxy group, and a C₁₋₃₀ hydrocarbylthio group. Among them, the hydrogen atom is preferably substituted with a halogen atom, a C₁₋₁₈ hydrocarbyl group, a C₁₋₁₈ hydrocarbyloxy group, or a C₁₋₁₈ hydrocarbylthio group, more preferably a C₁₋₁₂ hydrocarbyl group, a C₁₋₁₂ hydrocarbyloxy group, or a C₁₋₁₂ hydrocarbylthio group, further preferably a C₁₋₆ hydrocarbyl group, a C₁₋₆ hydrocarbyloxy group, or a C₁₋₆ hydrocarbylthio group. The substituent such as a hydrocarbyl group, a hydrocarbyloxy group, and a hydrocarbylthio group may be each any of a linear substituent, a branched substituent, and a cyclic substituent. In the present specification, the expression “may be substituted” may be changed to the expression “may have a substituent”.

Examples of the halogen atom may include a fluorine atom, a chlorine atom, a bromine atom, and an iodine atom. Among them, preferred are a fluorine atom, a chlorine atom, and a bromine atom, and more preferred are a fluorine atom and a chlorine atom.

Examples of the amino group may include an amino group, a phenylamino group, a diphenylamino group, a methylamino group, a dimethylamino group, an ethylamino group, a diethylamino group, a propylamino group, a dipropylamino group, a butylamino group, and a dibutylamino group. Among them, preferred are a diphenylamino group, a dimethylamino group, a diethylamino group, a dipropylamino group, and a dibutylamino group, and more preferred are a dimethylamino group and a diphenylamino group.

The hydrocarbyl group may be any of a linear group, a branched group, and a cyclic group. Examples of the hydrocarbyl group may include a methyl group, an ethyl group, a 1-propyl group, a 2-propyl group, a 1-butyl group, a 2-butyl group, a sec-butyl group, a tert-butyl group, a pentyl group, a hexyl group, an octyl group, a decyl group, a dodecyl group, a 2-ethylhexyl group, a 3,7-dimethyloctyl group, a cyclopropyl group, a cyclopentyl group, a cyclohexyl group, a 1-adamantyl group, a 2-adamantyl group, a norbornyl group, an ammoniumethyl group, a benzyl group, an α,α-dimethybenzyl group, a 1-phenetyl group, a 2-phenetyl group, a vinyl group, a propenyl group, a butenyl group, an oleyl group, an eicosapentaenyl group, a docosahexaenyl group, a 2,2-diphenylvinyl group, a 1,2,2-triphenylvinyl group, a 2-phenyl-2-propenyl group, a phenyl group, a 2-tolyl group, a 4-tolyl group, a 4-trifluoromethylphenyl group, a 4-methoxyphenyl group, a 4-cyanophenyl group, a 2-biphenylyl group, a 3-biphenylyl group, a 4-biphenylyl group, a terphenylyl group, a 3,5-diphenylphenyl group, a 3,4-diphenylphenyl group, a pentaphenylphenyl group, a 4-(2,2-diphenylvinyl)phenyl group, a 4-(1,2,2-triphenylvinyl)phenyl group, a fluorenyl group, a 1-naphthyl group, a 2-naphthyl group, a 9-anthryl group, a 2-anthryl group, a 9-phenanthryl group, a 1-pyrenyl group, a chrysenyl group, a naphthacenyl group, and a coronyl group. Among them, preferred are a methyl group, an ethyl group, a 1-propyl group, a 2-propyl group, a 1-butyl group, a 2-butyl group, a sec-butyl group, a pentyl group, a hexyl group, an octyl group, a decyl group, a dodecyl group, a 2-ethylhexyl group, a 3,7-dimethyloctyl group, a benzyl group, an α,α-dimethybenzyl group, a 1-phenetyl group, a 2-phenetyl group, a vinyl group, a propenyl group, a butenyl group, an oleyl group, an eicosapentaenyl group, a docosahexaenyl group, a 2,2-diphenylvinyl group, a 1,2,2-triphenylvinyl group, a 2-phenyl-2-propenyl group, a phenyl group, a 2-tolyl group, a 4-tolyl group, a 4-trifluoromethylphenyl group, a 4-methoxyphenyl group, a 4-cyanophenyl group, a 2-biphenylyl group, a 3-biphenylyl group, a 4-biphenylyl group, a terphenylyl group, a 3,5-diphenylphenyl group, a 3,4-diphenylphenyl group, a pentaphenylphenyl group, a 4-(2,2-diphenylvinyl)phenyl group, a 4-(1,2,2-triphenylvinyl)phenyl group, a fluorenyl group, a 1-naphthyl group, a 2-naphthyl group, a 9-anthryl group, a 2-anthryl group, and a 9-phenanthryl group; more preferred are a methyl group, an ethyl group, a 1-propyl group, a 2-propyl group, a 1-butyl group, a 2-butyl group, a sec-butyl group, a pentyl group, a hexyl group, an octyl group, a 2-ethylhexyl group, a 3,7-dimethyloctyl group, a benzyl group, and a phenyl group; further preferred are a methyl group, an ethyl group, a 1-propyl group, a 2-propyl group, a 1-butyl group, a 2-butyl group, a sec-butyl group, a pentyl group, a hexyl group, and a 2-ethylhexyl group; particularly preferred are a methyl group, an ethyl group, and a 2-ethylhexyl group; and the most preferred is a methyl group.

The hydrocarbyloxy group may be any of a linear group, a branched group, and a cyclic group. Examples of the hydrocarbyloxy group may include a methoxy group, an ethoxy group, a 1-propanoxy group, a 2-propanoxy group, a 1-butoxy group, a 2-butoxy group, a sec-butoxy group, a tert-butoxy group, a pentyloxy group, a hexyloxy group, an octyloxy group, a decyloxy group, a dodecyloxy group, a 2-ethylhexyloxy group, a 3,7-dimethyloctyloxy group, a cyclopropanoxy group, a cyclopentyloxy group, a cyclohexyloxy group, a 1-adamantyloxy group, a 2-adamantyloxy group, a norbornyloxy group, an ammoniumethoxy group, a trifluoromethoxy group, a benzyloxy group, an α,α-dimethybenzyloxy group, a 2-phenetyloxy group, a 1-phenetyloxy group, a phenoxy group, an alkoxyphenoxy group, an alkylphenoxy group, a 1-naphthyloxy group, a 2-naphthyloxy group, and a pentafluorophenyloxy group. Among them, preferred are a methoxy group, an ethoxy group, a 1-propanoxy group, a 2-propanoxy group, a 1-butoxy group, a 2-butoxy group, a sec-butoxy group, a tert-butoxy group, a pentyloxy group, a hexyloxy group, an octyloxy group, a decyloxy group, a dodecyloxy group, a 2-ethylhexyloxy group, a 3,7-dimethyloctyloxy group, and further preferred are a methoxy group and an ethoxy group.

The hydrocarbylthio group may be any of a linear group, a branched group, and a cyclic group. Examples of the hydrocarbylthio group may include a methylthio group, an ethylthio group, a 1-propylthio group, a 2-propylthio group, a 1-butylthio group, a 2-butylthio group, a sec-butylthio group, a tert-butylthio group, a pentylthio group, a hexylthio group, an octylthio group, a decylthio group, a dodecylthio group, a 2-ethylhexylthio group, a 3,7-dimethyloctylthio group, a cyclopropylthio group, cyclopentylthio group, a cyclohexylthio group, a 1-adamantylthio group, a 2-adamantylthio group, a norbornylthio group, an ammoniumethylthio group, a trifluoromethylthio group, a benzylthio group, an α,α-dimethybenzylthio group, a 2-phenetylthio group, a 1-phenetylthio group, a phenylthio group, an alkoxyphenylthio group, an alkylphenylthio group, a 1-naphthylthio group, a 2-naphthylthio group, and a pentafluorophenylthio group. Among them, preferred are a methylthio group, an ethylthio group, a 1-propylthio group, a 2-propylthio group, a 1-butylthio group, a 2-butylthio group, a sec-butylthio group, a pentylthio group, a hexylthio group, an octylthio group, a decylthio group, a dodecylthio group, a 2-ethylhexylthio group, and a 3,7-dimethyloctylthio group, and further preferred are a methylthio group and an ethylthio group.

1. A thin film of the present invention, coating liquid for forming the thin film, and an element comprising the thin film

### <1.1 Compound Used for the Thin Film of the Present Invention>

The thin film of the present invention is a thin film containing a bismuth compound of Formula (1) below. The thin film of the present invention can be produced as a thin film having light-emitting property.

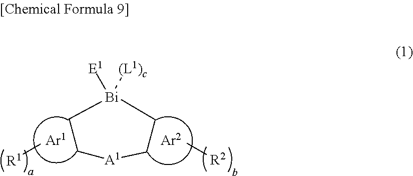

wherein Ar¹ and Ar² are each independently a C₃₋₃₀ aromatic ring; R¹ and R² are a substituent; a and b are each independently an integer of 0 to 12, wherein when a is 2 or more, each R¹ may be different from each other and two R¹ may be bonded with each other to form a ring structure, and when b is 2 or more, R² may be different from each other and two R² may be bonded with each other to form a ring structure; A¹ is any of direct bond, —O—, —S—, —S(═O)—, —S(═O)₂—, —PR³—, —NR⁴—, and —C(—R⁵)₂—; R³ is a hydrogen atom or a substituent; R⁴ is a hydrogen atom or a substituent; R⁵ is a hydrogen atom or a substituent and two R⁵ may be different from each other; E¹ is a monovalent group having 50 or less carbon atoms; L¹ is a ligand having 50 or less carbon atoms; c is an integer of 0 to 3, wherein when c is 2 or more, each L¹ may be different from each other; and each combination of a combination of E¹ and Ar¹ and a combination of E¹ and Ar² may form a bond; and when c is 1 to 3, each combination of a combination of L¹ and E¹, a combination of L¹ and Ar¹, a combination of L¹ and Ar², and a combination of L¹ and L¹ may form a bond.

In Formula (1), Ar¹ and Ar² are each independently a C₃₋₃₀ aromatic ring, preferably a C₃₋₂₀ aromatic ring, more preferably a C₃₋₁₀ aromatic ring, and further preferably a C₄₋₆ aromatic ring.

As the specific structure of Ar¹ and Ar², for example, the structure of Ar¹ is a ring remaining after subtracting (2+a) hydrogen atoms from any one of the rings below (of Formula Ar-1 to Formula Ar-41) and the structure of Ar² is a ring remaining after subtracting (2+b) hydrogen atoms from any one of the rings below (of Formula Ar-1 to Formula Ar-41). Among them, preferred rings are rings of Formula Ar-1, Formula Ar-2, Formula Ar-6 to Formula Ar-8, Formula Ar-14, and Formula Ar-22 to Formula Ar-24, more preferred rings are rings of Formula Ar-1, Formula Ar-6 to Formula Ar-8, and Formula Ar-22 to Formula Ar-24, and further preferred rings are rings of Formula Ar-1, Formula Ar-7, and Formula Ar-24.

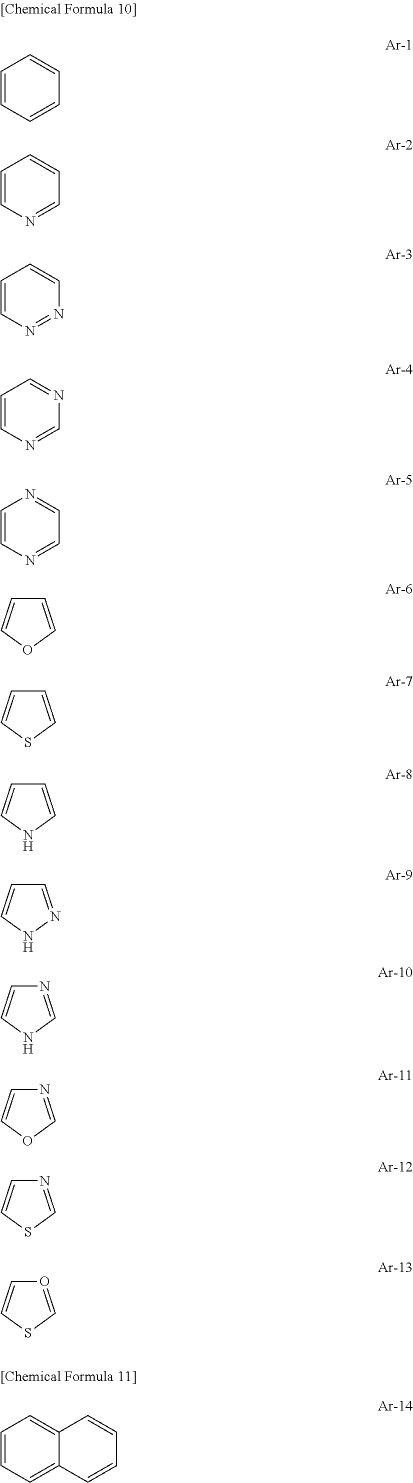

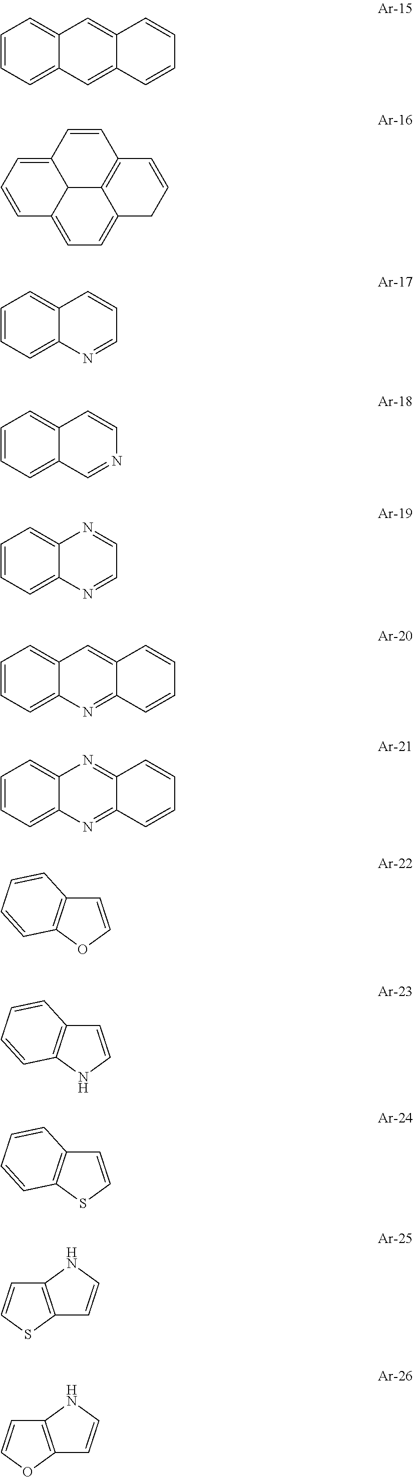

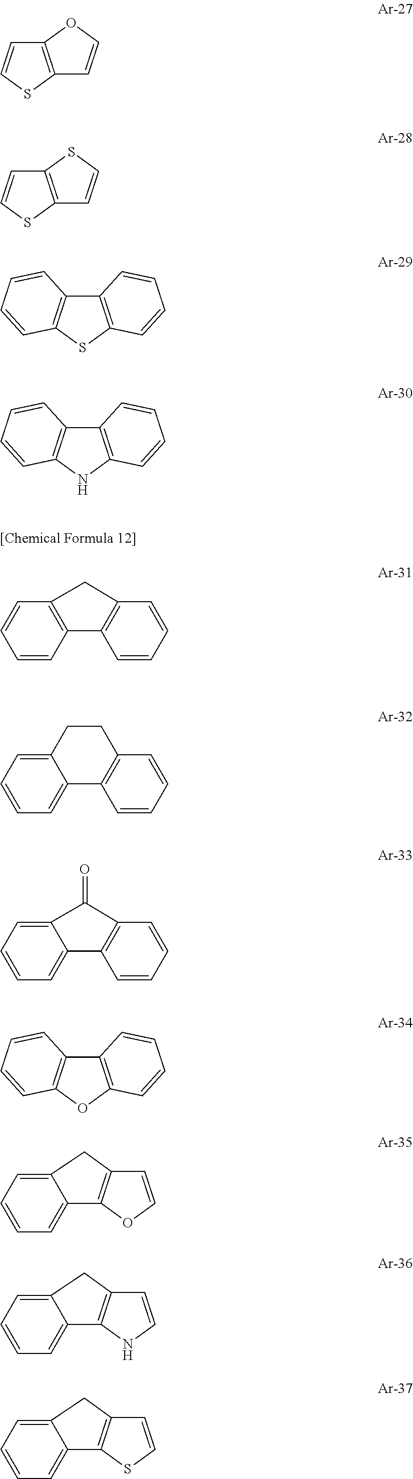

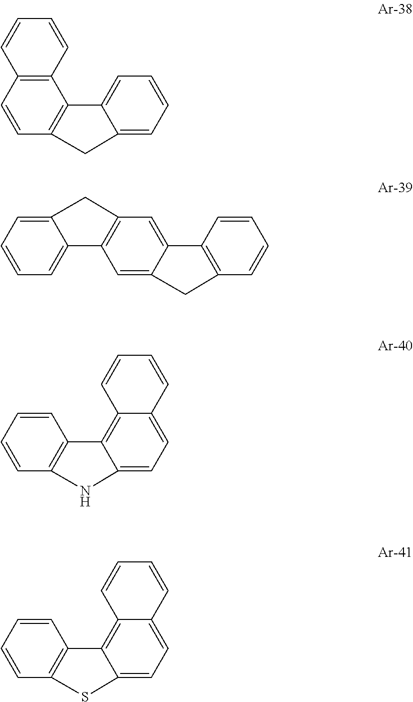

R¹ and R² are each a substituent. R¹ and R² are independently a hydrocarbyl group that may be substituted, a hydrocarbyloxy group that may be substituted, a hydrocarbylthio group that may be substituted, a heterocyclyl group that may be substituted, a halogen atom, a cyano group, an acylamino group that may be substituted, an imino group that may be substituted, a silyl group that may be substituted, a siloxy group that may be substituted, an acyl group that may be substituted, a hydrocarbyloxycarbonyl group that may be substituted, hydrocarbyloxysulfonyl group that may be substituted, hydrocarbyloxyphosphoryl group that may be substituted, a phosphino group that may be substituted, a phosphine oxide group that may be substituted, an amino group that may be substituted, a hydroxy group, a mercapto group, a carboxy group, a sulfo group, a phosphoric acid group, a phosphonic acid group, or a nitro group; preferably a hydrocarbyl group that may be substituted, a hydrocarbyloxy group that may be substituted, a halogen atom, a cyano group, a silyl group that may be substituted, a siloxy group that may be substituted, a hydrocarbyloxysulfonyl group that may be substituted, a hydrocarbyloxyphosphoryl group that may be substituted, a phosphino group that may be substituted, a phosphine oxide group that may be substituted, an amino group that may be substituted, a hydroxy group, a carboxy group, a sulfo group, a phosphoric acid group, a phosphonic acid group, or a nitro group; more preferably a hydrocarbyl group that may be substituted, a hydrocarbyloxy group that may be substituted, a halogen atom, a cyano group, a silyl group that may be substituted, a siloxy group that may be substituted, an amino group that may be substituted, a hydroxy group, a carboxy group, a sulfo group, a phosphoric acid group, or a nitro group; further preferably a hydrocarbyl group that may be substituted, a hydrocarbyloxy group that may be substituted, a silyl group that may be substituted, or an amino group that may be substituted; and particularly preferably a hydrocarbyl group that may be substituted, a hydrocarbyloxy group that may be substituted, or a silyl group that may be substituted.

The hydrocarbyl group as R¹ and R² may be any of a linear group, a branched group, and a cyclic group. When the hydrocarbyl group as R¹ and R² is a group containing a carbon atom and no aromatic ring, the hydrocarbyl group is a C₁₋₃₀ group, preferably a C₁₋₂₀ group, more preferably a C₁₋₁₀ group, further preferably a C₁₋₆ group, and particularly preferably a C₁₋₄ group. When the hydrocarbyl group is a group containing an aromatic ring, the hydrocarbyl group is a C₃₋₃₀ group, preferably a C₃₋₂₀ group, more preferably a C₄₋₁₀ group, further preferably a C₄₋₆ group, and particularly preferably a C₆ group. Examples of the hydrocarbyl group as R¹ and R² may include a methyl group, an ethyl group, a 1-propyl group, a 2-propyl group, a 1-butyl group, a 2-butyl group, a sec-butyl group, a tert-butyl group, a pentyl group, a hexyl group, an octyl group, a decyl group, a dodecyl group, a 2-ethylhexyl group, a 3,7-dimethyloctyl group, a cyclopropyl group, a cyclopentyl group, a cyclohexyl group, a 1-adamantyl group, a 2-adamantyl group, a norbornyl group, an ammoniumethyl group, a benzyl group, an α,α-dimethybenzyl group, a 1-phenetyl group, a 2-phenetyl group, a vinyl group, a propenyl group, a butenyl group, an oleyl group, an eicosapentaenyl group, a docosahexaenyl group, a 2,2-diphenylvinyl group, a 1,2,2-triphenylvinyl group, a 2-phenyl-2-propenyl group, a phenyl group, a 2-tolyl group, a 4-tolyl group, a 4-trifluoromethylphenyl group, a 4-methoxyphenyl group, a 4-cyanophenyl group, a 2-biphenylyl group, a 3-biphenylyl group, a 4-biphenylyl group, a terphenylyl group, a 3,5-diphenylphenyl group, a 3,4-diphenylphenyl group, a pentaphenylphenyl group, a 4-(2,2-diphenylvinyl)phenyl group, a 4-(1,2,2-triphenylvinyl)phenyl group, a fluorenyl group, a 1-naphthyl group, a 2-naphthyl group, a 9-anthryl group, a 2-anthryl group, a 9-phenanthryl group, a 1-pyrenyl group, a chrysenyl group, a naphthacenyl group, and a coronyl group. Among them, preferred are a methyl group, an ethyl group, a 1-propyl group, a 2-propyl group, a 1-butyl group, a 2-butyl group, a sec-butyl group, a pentyl group, a hexyl group, an octyl group, a decyl group, a dodecyl group, a 2-ethylhexyl group, a 3,7-dimethyloctyl group, a benzyl group, an α,α-dimethybenzyl group, a 1-phenetyl group, a 2-phenetyl group, a vinyl group, a propenyl group, a butenyl group, an oleyl group, an eicosapentaenyl group, a docosahexaenyl group, a 2,2-diphenylvinyl group, a 1,2,2-triphenylvinyl group, a 2-phenyl-2-propenyl group, a phenyl group, a 2-tolyl group, a 4-tolyl group, a 4-trifluoromethylphenyl group, a 4-methoxyphenyl group, a 4-cyanophenyl group, a 2-biphenylyl group, a 3-biphenylyl group, a 4-biphenylyl group, a terphenylyl group, a 3,5-diphenylphenyl group, a 3,4-diphenylphenyl group, a pentaphenylphenyl group, a 4-(2,2-diphenylvinyl)phenyl group, a 4-(1,2,2-triphenylvinyl)phenyl group, a fluorenyl group, a 1-naphthyl group, a 2-naphthyl group, a 9-anthryl group, a 2-anthryl group, and a 9-phenanthryl group; more preferred are a methyl group, an ethyl group, a 1-propyl group, a 2-propyl group, a 1-butyl group, a 2-butyl group, a sec-butyl group, a pentyl group, a hexyl group, an octyl group, a 2-ethylhexyl group, a 3,7-dimethyloctyl group, a benzyl group, and a phenyl group; and further preferred are a methyl group, an ethyl group, a 1-propyl group, a 2-propyl group, a 1-butyl group, a 2-butyl group, a sec-butyl group, a pentyl group, a hexyl group, and a 2-ethylhexyl group.

The hydrocarbyloxy group as R¹ and R² may be any of a linear group, a branched group, and a cyclic group. When the hydrocarbyloxy group as R¹ and R² is a group containing a carbon atom and no aromatic ring, the hydrocarbyloxy group is a C₁₋₃₀ group, preferably a C₁₋₂₀ group, more preferably a C₁₋₁₀ group, further preferably a C₁₋₆ group, and particularly preferably a C₁₋₄ group. When the hydrocarbyloxy group is a group containing an aromatic ring, the hydrocarbyloxy group is a C₃₋₃₀ group, preferably a C₃₋₂₀ group, more preferably a C₄₋₁₀ group, further preferably a C₄₋₆ group, and particularly preferably a C₆ group. Examples of the hydrocarbyloxy group as R¹ and R² may include a methoxy group, an ethoxy group, a 1-propanoxy group, a 2-propanoxy group, a 1-butoxy group, a 2-butoxy group, a sec-butoxy group, a tert-butoxy group, a pentyloxy group, a hexyloxy group, an octyloxy group, a decyloxy group, a dodecyloxy group, a 2-ethylhexyloxy group, a 3,7-dimethyloctyloxy group, a cyclopropanoxy group, a cyclopentyloxy group, a cyclohexyloxy group, a 1-adamantyloxy group, a 2-adamantyloxy group, a norbornyloxy group, an ammoniumethoxy group, a trifluoromethoxy group, a benzyloxy group, an α,α-dimethybenzyloxy group, a 2-phenetyloxy group, a 1-phenetyloxy group, a phenoxy group, an alkoxyphenoxy group, an alkylphenoxy group, a 1-naphthyloxy group, a 2-naphthyloxy group, and a pentafluorophenyloxy group. Among them, preferred are a methoxy group, an ethoxy group, a 1-propanoxy group, a 2-propanoxy group, a 1-butoxy group, a 2-butoxy group, a sec-butoxy group, a tert-butoxy group, a pentyloxy group, a hexyloxy group, an octyloxy group, a decyloxy group, a dodecyloxy group, a 2-ethylhexyloxy group, a 3,7-dimethyloctyloxy group, and further preferred are a methoxy group and an ethoxy group.

The hydrocarbylthio group as R¹ and R² may be any of a linear group, a branched group, and a cyclic group. When the hydrocarbylthio group as R¹ and R² is a group containing a carbon atom and no aromatic ring, the hydrocarbylthio group is a C₁₋₃₀ group, preferably a C₁₋₂₀ group, more preferably a C₁₋₁₀ group, further preferably a C₁₋₆ group, and particularly preferably a C₁₋₄ group. When the hydrocarbylthio group is a group containing an aromatic ring, the hydrocarbylthio group is a C₃₋₃₀ group, preferably a C₃₋₂₀ group, more preferably a C₄₋₁₀ group, further preferably a C₄₋₆ group, and particularly preferably a C₆ group. Examples of the hydrocarbylthio group as R¹ and R² may include a methylthio group, an ethylthio group, a 1-propylthio group, a 2-propylthio group, a 1-butylthio group, a 2-butylthio group, a sec-butylthio group, a tert-butylthio group, a pentylthio group, a hexylthio group, an octylthio group, a decylthio group, a dodecylthio group, 2-ethylhexylthio group, a 3,7-dimethyloctylthio group, a cyclopropylthio group, a cyclopentylthio group, a cyclohexylthio group, a 1-adamantylthio group, a 2-adamantylthio group, a norbornylthio group, an ammoniumethylthio group, a trifluoromethylthio group, a benzylthio group, an α,α-dimethybenzylthio group, a 2-phenetylthio group, a 1-phenetylthio group, a phenylthio group, an alkoxyphenylthio group, an alkylphenylthio group, a 1-naphthylthio group, a 2-naphthylthio group, and a pentafluorophenylthio group. Among them, preferred are a methylthio group, an ethylthio group, a 1-propylthio group, a 2-propylthio group, a 1-butylthio group, a 2-butylthio group, a sec-butylthio group, a pentylthio group, a hexylthio group, an octylthio group, a decylthio group, a dodecylthio group, a 2-ethylhexylthio group, and a 3,7-dimethyloctylthio group, and further preferred are a methylthio group and an ethylthio group.

The heterocyclyl group as R¹ and R² is a C₃₋₃₀ group, preferably a C₃₋₂₀ alkyl group, more preferably a C₄₋₁₀ group, and further preferably a C₄₋₆ group. Examples of the heterocyclyl group as R¹ and R² may include a furyl group, a thienyl group, a pyrrolyl group, an imidazolyl group, an oxazolyl group, a thiazolyl group, and a pyridyl group. Among them, preferred are a furyl group, a thienyl group, a pyrrolyl group, an oxazolyl group, and a thiazolyl group, and more preferred are a thienyl group and a thiazolyl group.

Examples of the halogen atom as R¹ and R² may include a fluorine atom, a chlorine atom, a bromine atom, and an iodine atom. Among them, preferred are a fluorine atom, a chlorine atom, and a bromine atom, and more preferred are a fluorine atom and a chlorine atom.

The acylamino group as R¹ and R² is a group of RCONH—, where R is a hydrogen atom or a hydrocarbyl group and the hydrocarbyl group may be any of a linear group, a branched group, and a cyclic group. When the acylamino group as R¹ and R² is a group containing no aromatic ring, the acylamino group is a C₁₋₃₀ group, preferably a C₁₋₂₀ group, more preferably a C₁₋₁₀ group, further preferably a C₁₋₆ group, and particularly preferably a C₁₋₄ group. When the acylamino group is a group containing an aromatic ring, the acylamino group is a C₄₋₃₀ group, preferably a C₄₋₂₀ group, more preferably a C₄₋₁₀ group, further preferably a C₄₋₆ group, and particularly preferably a C₆ group. Examples of the acylamino group as R¹ and R² may include a formamide group, an acetamide group, a propionamide group, a butyramide group, a benzamide group, a trifluoroacetamide group, a pentafluorobenzamide group, a diformamide group, a diacetamide group, a dipropioamide group, a dibutyramide group, a dibenzamide group, a ditrifluoroacetamide group, and a dipentafluorobenzamide group. Among them, preferred are a formamide group, an acetamide group, a propioamide group, a butyramide group, and a benzamide group.

The imino group as R¹ and R² may be substituted. Examples of the imino group that may be substituted may include an imino group, an N-succinimido group, an N-phthalimido group, and a benzophenoneimide group. Among them, preferred is an N-phthalimido group.

The silyl group as R¹ and R² may be substituted. Examples of the silyl group that may be substituted may include a silyl group, a trimethylsilyl group, a triethylsilyl group, a tripropylsilyl group, a triisopropylsilyl group, a dimethylisopropylsilyl group, a diethylisopropylsilyl group, a tert-butyldimethylsilyl group, a pentyldimethylsilyl group, a hexyldimethylsilyl group, a heptyldimethylsilyl group, an octyldimethylsilyl group, a 2-ethylhexyl-dimethylsilyl group, a nonyldimethylsilyl group, a decyldimethylsilyl group, a 3,7-dimethyloctyl-dimethylsilyl group, a lauryldimethylsilyl group, a triphenylsilyl group, a tri-p-xylylsilyl group, a tribenzylsilyl group, a diphenylmethylsilyl group, a tert-butyldiphenylsilyl group, and a dimethylphenylsilyl group. Among them, preferred are a trimethylsilyl group, a triethylsilyl group, and a tripropylsilyl group, more preferred is a trimethylsilyl group.

The siloxy group as R¹ and R² may be substituted. Examples of the siloxy group that may be substituted may include a siloxy group, a trimethylsiloxy group, a triethylsiloxy group, a tripropylsiloxy group, a triisopropylsiloxy group, a dimethylisopropylsiloxy group, a diethylisopropylsiloxy group, a tert-butyldimethylsiloxy group, a pentyldimethylsiloxy group, a hexyldimethylsiloxy group, a heptyldimethylsiloxy group, an octyldimethylsiloxy group, a 2-ethylhexyl-dimethylsiloxy group, a nonyldimethylsiloxy group, a decyldimethylsiloxy group, 3,7-dimethyloctyl-dimethylsiloxy group, a lauryldimethylsiloxy group, a triphenylsiloxy group, a tri-p-xylylsiloxy group, a tribenzylsiloxy group, a diphenylmethylsiloxy group, a diphenylmethylsiloxy group, a tert-butyldiphenylsiloxy group, and a dimethylphenylsiloxy group. Among them, preferred are a trimethylsiloxy group, a triethylsiloxy group, a tripropylsiloxy group, and a tert-butylmethylsiloxy group, further preferred are a trimethylsiloxy group and a tert-butyldimethylsiloxy group.

The acyl group as R¹ and R² is a group of RCO—, where R is a hydrogen atom or a hydrocarbyl group and the hydrocarbyl group may be any of a linear group, a branched group, and a cyclic group. When the acyl group as R¹ and R² is a group containing no aromatic ring, the acyl group is a C₁₋₃₀ group, preferably a C₁₋₂₀ group, more preferably a C₁₋₁₀ group, further preferably a C₁₋₆ group, and particularly preferably a C₁₋₄ group. When the acyl group is a group containing an aromatic ring, the acyl group is a C₄₋₃₀ group, preferably a C₄₋₂₀ group, more preferably a C₄₋₁₀ group, further preferably a C₄₋₇ group, and particularly preferably a C₇ group. Examples of the acyl group as R¹ and R² may include an acetyl group, a propionyl group, a butyryl group, an isobutyryl group, a pivaloyl group, a benzoyl group, a trifluoroacetyl group, and a pentafluorobenzoyl group. Among them, preferred are an acetyl group, a propionyl group, and a benzoyl group.

The hydrocarbyloxycarbonyl group as R¹ and R² may be any of a linear group, a branched group, and a cyclic group. When the hydrocarbyloxycarbonyl group as R¹ and R² is a group containing no aromatic ring, the hydrocarbyloxycarbonyl group is a C₂₋₃₀ group, preferably a C₂₋₂₀ group, more preferably a C₂₋₁₀ group, further preferably a C₂₋₆ group, and particularly preferably a C₂₋₄ group. When the hydrocarbyloxycarbonyl group is a group containing an aromatic ring, the hydrocarbyloxycarbonyl group is a C₄₋₃₀ group, preferably a C₄₋₂₀ group, more preferably a C₄₋₁₀ group, further preferably a C₄₋₇ group, and particularly preferably a C₇ group. Examples of the hydrocarbyloxycarbonyl group as R¹ and R² may include a methoxycarbonyl group, an ethoxycarbonyl group, a propoxycarbonyl group, a benzoxycarbonyl group, a naphthoxycarbonyl group, a 2-ethylhexoxycarbonyl group. Among them, preferred are a methoxycarbonyl group and an ethoxycarbonyl group.

The hydrocarbyloxysulfonyl group as R¹ and R² may be any of a linear group, a branched group, and a cyclic group. When the hydrocarbyloxysulfonyl group as R¹ and R² is a group containing no aromatic ring, the hydrocarbyloxysulfonyl group is a C₁₋₃₀ group, preferably a C₁₋₂₀ group, more preferably a C₁₋₁₀ group, further preferably a C₁₋₆ group, and particularly preferably a C₁₋₄ group. When the hydrocarbyloxysulfonyl group is a group containing an aromatic ring, the hydrocarbyloxysulfonyl group is a C₃₋₃₀ group, preferably a C₃₋₂₀ group, more preferably a C₄₋₁₀ group, further preferably a C₄₋₇ group, and particularly preferably a C₇ group. Examples of the hydrocarbyloxysulfonyl group as R¹ and R² may include a methoxysulfonyl group, an ethoxysulfonyl group, a propanoxysulfonyl group, an isopropanoxysulfonyl group, a butoxysulfonyl group, an isobutoxysulfonyl group, a sec-butoxysulfonyl group, a tert-butoxysulfonyl group, pentyloxysulfonyl group, a hexyloxysulfonyl group, a heptyloxysulfonyl group, an octyloxysulfonyl group, a 2-ethylhexyloxysulfonyl group, a nonyloxysulfonyl group, a decyloxysulfonyl group, a 3,7-dimethyloctyloxysulfonyl group, and a dodecyloxysulfonyl group. Among them, preferred are a methoxysulfonyl group, an ethoxysulfonyl group, a propanoxysulfonyl group, an isopropanoxysulfonyl group, a butoxysulfonyl group, and an isobutoxysulfonyl group, and more preferred are a methoxysulfonyl group and an ethoxysulfonyl group.

The hydrocarbyloxyphosphoryl group as R¹ and R² may be any of a linear group, a branched group, and a cyclic group. When the hydrocarbyloxyphosphoryl group as R¹ and R² is a group containing no aromatic ring, the hydrocarbyloxyphosphoryl group is a C₁₋₃₀ group, preferably a C₁₋₂₀ group, more preferably a C₁₋₁₀ group, further preferably a C₁₋₆ group, and particularly preferably a C₁₋₄ group. When the hydrocarbyloxyphosphoryl group is a group containing an aromatic ring, the hydrocarbyloxyphosphoryl group is a C₃₋₃₀ group, preferably a C₃₋₂₀ group, more preferably a C₄₋₁₀ group, further preferably a C₄₋₇ group, and particularly preferably a C₇ group. Examples of the hydrocarbyloxyphosphoryl group as R¹ and R² may include a dimethoxyphosphoryl group, a diethoxyphosphoryl group, a dipropoxyphosphoryl group, a diisopropoxyphosphoryl group, a dibutoxyphosphoryl group, and an ethylenedioxyphosphoryl group. Among them, preferred is a dimethoxyphosphoryl group.

The phosphino group as R¹ and R² may be substituted. Examples of the phosphino group that may be substituted as R¹ and R² may include a phosphino group, a phenylphosphino group, a diphenylphosphino group, a methylphosphino group, a dimethylphosphino group, an ethylphosphino group, a diethylphosphino group, a propylphosphino group, a dipropylphosphino group, a butylphosphino group, and a dibutylphosphino group. Among them, preferred are a diphenylphosphino group, a dimethylphosphino group, a diethylphosphino group, a dipropylphosphino group, and a dibutylphosphino group, more preferred are a diphenylphosphino group and a dimethylphosphino group, and particularly preferred is a diphenylphosphino group.

The phosphine oxide group as R¹ and R² may be substituted. Examples of the phosphine oxide group that may be substituted as R¹ and R² may include a phosphine oxide group, a phenylphosphine oxide group, a diphenylphosphine oxide group, a methylphosphine oxide group, a dimethyl phosphineoxide group, an ethylphosphine oxide group, a diethylphosphine oxide group, a propylphosphine oxide group, a dipropylphosphine oxide group, a butylphosphine oxide group, and a dibutylphosphine oxide group. Among them, preferred are a diphenylphosphine oxide group, a dimethylphosphine oxide group, a diethylphosphine oxide group, a dipropylphosphine oxide group, and a dibutylphosphine oxide group, more preferred are a diphenylphosphine oxide group and a dimethylphosphine oxide group, and particularly preferred is a diphenylphosphine oxide group.

The amino group as R¹ and R² may be substituted. Examples of the amino group that may be substituted as R¹ and R² may include an amino group, a phenylamino group, a diphenylamino group, a methylamino group, a dimethylamino group, an ethylamino group, a diethylamino group, a propylamino group, a dipropylamino group, a butylamino group, and a dibutylamino group. Among them, preferred are a diphenylamino group, a dimethylamino group, a diethylamino group, a dipropylamino group, and a dibutylamino group, and more preferred is a diphenylamino group.

a and b in Formula (1) are independently an integer of 0 to 12 and from the viewpoint of the stability of the compound, they are preferably an integer of 0 to 8, more preferably an integer of 0 to 6, further preferably an integer of 1 to 4, particularly preferably an integer of 1 to 2, and most preferably 2. When a is 2 or more, R¹s may be different from each other and two R¹s may be bonded with each other to form a ring structure. When b is 2 or more, R²s may be different from each other and two R²s may be bonded with each other to form a ring structure.

A¹ is any of direct bond, —O—, —S—, —S(═O)—, —S(═O)₂—, —PR³—, —NR⁴—, and —C(—R⁵)₂—, preferably direct bond, —O—, —S—, —S(═O)₂—, —NR⁴—, or —C(—R⁵)₂—, more preferably direct bond, —O—, —S—, or —S(═O)₂—, and further preferably direct bond.

R³ is a hydrogen atom or a substituent. Examples of R³ may include a hydrogen atom, a halogen atom, a hydrocarbyl group that may be substituted, and a heterocyclyl group that may be substituted. Among them, as R³, preferred are a hydrogen atom and a hydrocarbyl group that may be substituted. When R³ is a group containing a carbon atom and no aromatic ring, R³ is a C₁₋₃₀ group, preferably a C₁₋₂₀ group, more preferably a C₁₋₁₀ group, further preferably a C₁₋₆ group, and particularly preferably a C₁₋₄ group. When R³ is a group containing an aromatic ring, R³ is a C₂₋₃₀ group, preferably a C₃₋₂₀ group, more preferably a C₄₋₁₀ group, further preferably a C₄₋₆ group, and particularly preferably a C₆ group.

Examples of the halogen atom as R³ may include a fluorine atom, a chlorine atom, a bromine atom, and an iodine atom. Among them, as the halogen atom, preferred are a fluorine atom, a chlorine atom, and a bromine atom, and more preferred are a fluorine atom and a chlorine atom.

The hydrocarbyl group as R³ may be any of a linear group, a branched group, and a cyclic group. When the hydrocarbyl group as R³ is a group containing a carbon atom and no aromatic ring, the hydrocarbyl group is a C₁₋₃₀ group, preferably a C₁₋₂₀ group, more preferably a C₁₋₁₀ group, further preferably a C₁₋₆ group, and particularly preferably a C₁₋₄ group, and when the hydrocarbyl group is a group containing an aromatic ring, the hydrocarbyl group is a C₃₋₃₀ group, preferably a C₃₋₂₀ group, more preferably a C₄₋₁₀ group, further preferably a C₄₋₆ group, and particularly preferably a C₆ group. Examples of the hydrocarbyl group as R³ may include a methyl group, an ethyl group, a benzyl group, a 1-phenetyl group, a 2-phenetyl group, a vinyl group, a propenyl group, a butenyl group, a phenyl group, a 2-tolyl group, a 4-tolyl group, a 2-biphenylyl group, a 3-biphenylyl group, a 4-biphenylyl group, a terphenylyl group, a 3,5-diphenylphenyl group, a 3,4-diphenylphenyl group, a pentaphenylphenyl group, a 4-(2,2-diphenylvinyl)phenyl group, a 4-(1,2,2-triphenylvinyl)phenyl group, a fluorenyl group, a 1-naphthyl group, a 2-naphthyl group, a 1-anthryl group, a 2-anthryl group, a 9-anthryl group, a 1-phenanthryl, a 2-phenanthryl, a 3-phenanthryl, a 4-phenanthryl, a 9-phenanthryl, a 1-naphthacenyl group, a 2-naphthacenyl group, a 9-naphthacenyl group, a 1-pyrenyl group, a 2-pyrenyl group, a 4-pyrenyl group, a 6-chrysenyl group, a 1-benzo[c]phenanthryl group, a 2-benzo[c]phenanthryl group, a 3-benzo[c]phenanthryl group, a 4-benzo[c]phenanthryl group, a 5-benzo[c]phenanthryl group, a 6-benzo[c]phenanthryl group, a 1-benzo[g]chrysenyl group, a 2-benzo[g]chrysenyl group, a 3-benzo[g]chrysenyl group, a 4-benzo[g]chrysenyl group, a 5-benzo[g]chrysenyl group, a 6-benzo[g]chrysenyl group, a 7-benzo[g]chrysenyl group, an 8-benzo[g]chrysenyl group, a 9-benzo[g]chrysenyl group, a 10-benzo[g]chrysenyl group, a 11-benzo[g]chrysenyl group, a 12-benzo[g]chrysenyl group, a 13-benzo[g]chrysenyl group, a 14-benzo[g]chrysenyl group, a benzofluorenyl group, and a dibenzofluorenyl group. Among them, as the hydrocarbyl group as R³, preferred are a phenyl group, a 2-tolyl group, a 4-tolyl group, a fluorenyl group, a 1-naphthyl group, a 2-naphthyl group, a 1-anthryl group, a 2-anthryl group, a 9-anthryl group, a 1-phenanthryl group, a 2-phenanthryl group, a 3-phenanthryl group, a 4-phenanthryl group, a 9-phenanthryl group, a 1-naphthacenyl group, a 2-naphthacenyl group, a 9-naphthacenyl group, a 1-pyrenyl group, a 2-pyrenyl group, and a 4-pyrenyl group; more preferred are a phenyl group, a 2-tolyl group, a 4-tolyl group, a fluorenyl group, a 1-naphthyl group, a 2-naphthyl group, a 1-anthryl group, a 2-anthryl group, and a 9-anthryl group; further preferred are a phenyl group, a 2-tolyl group, and a 4-tolyl group; and particularly preferred is a phenyl group.

The heterocyclyl group as R³ is a C₃₋₃₀ group, preferably a C₃₋₂₀ group, more preferably a C₄₋₁₀ group, and further preferably a C₄₋₆ group. Examples of the heterocyclyl group as R³ may include a 1-pyrrolyl group, a 2-pyrrolyl group, a 3-pyrrolyl group, a pyrazinyl group, a 2-pyridyl group, a 3-pyridyl group, a 4-pyridyl group, a 1-indolyl group, a 2-indolyl group, a 3-indolyl group, a 4-indolyl group, a 5-indolyl group, a 6-indolyl group, a 7-indolyl group, a 1-isoindolyl group, a 2-isoindolyl group, a 3-isoindolyl group, a 4-isoindolyl group, a 5-isoindolyl group, a 6-isoindolyl group, a 7-isoindolyl group, a 2-furyl group, a 3-furyl group, a 2-benzofuranyl group, a 3-benzofuranyl group, a 4-benzofuranyl group, a 5-benzofuranyl group, a 6-benzofuranyl group, a 7-benzofuranyl group, a 1-isobenzofuranyl group, a 3-isobenzofuranyl group, a 4-isobenzofuranyl group, a 5-isobenzofuranyl group, a 6-isobenzofuranyl group, a 7-isobenzofuranyl group, a 2-quinolyl group, a 3-quinolyl group, a 4-quinolyl group, a 5-quinolyl group, a 6-quinolyl group, a 7-quinolyl group, an 8-quinolyl group, a 1-isoquinolyl group, a 3-isoquinolyl group, a 4-isoquinolyl group, a 5-isoquinolyl group, a 6-isoquinolyl group, a 7-isoquinolyl group, an 8-isoquinolyl group, a 2-quinoxalinyl group, a 5-quinoxalinyl group, a 6-quinoxalinyl group, a 1-carbazolyl group, a 2-carbazolyl group, a 3-carbazolyl group, a 4-carbazolyl group, a 9-carbazolyl group, a 1-phenanthridinyl group, a 2-phenanthridinyl group, a 3-phenanthridinyl group, a 4-phenanthridinyl group, a 6-phenanthridinyl group, a 7-phenanthridinyl group, an 8-phenanthridinyl group, a 9-phenanthridinyl group, a 10-phenanthridinyl group, a 1-acridinyl group, a 2-acridinyl group, a 3-acridinyl group, a 4-acridinyl group, a 9-acridinyl group, a 1,7-phenanthrolin-2-yl group, a 1,7-phenanthrolin-3-yl group, a 1,7-phenanthrolin-4-yl group, a 1,7-phenanthrolin-5-yl group, a 1,7-phenanthrolin-6-yl group, a 1,7-phenanthrolin-8-yl group, a 1,7-phenanthrolin-9-yl group, a 1,7-phenanthrolin-10-yl group, a 1,8-phenanthrolin-2-yl group, a 1,8-phenanthrolin-3-yl group, a 1,8-phenanthrolin-4-yl group, a 1,8-phenanthrolin-5-yl group, a 1,8-phenanthrolin-6-yl group, a 1,8-phenanthrolin-7-yl group, a 1,8-phenanthrolin-9-yl group, a 1,8-phenanthrolin-10-yl group, a 1,9-phenanthrolin-2-yl group, a 1,9-phenanthrolin-3-yl group, a 1,9-phenanthrolin-4-yl group, a 1,9-phenanthrolin-5-yl group, a 1,9-phenanthrolin-6-yl group, a 1,9-phenanthrolin-7-yl group, a 1,9-phenanthrolin-8-yl group, a 1,9-phenanthrolin-10-yl group, a 1,10-phenanthrolin-2-yl group, a 1,10-phenanthrolin-3-yl group, a 1,10-phenanthrolin-4-yl group, a 1,10-phenanthrolin-5-yl group, a 2,9-phenanthrolin-1-yl group, a 2,9-phenanthrolin-3-yl group, a 2,9-phenanthrolin-4-yl group, a 2,9-phenanthrolin-5-yl group, a 2,9-phenanthrolin-6-yl group, a 2,9-phenanthrolin-7-yl group, a 2,9-phenanthrolin-8-yl group, a 2,9-phenanthrolin-10-yl group, a 2,8-phenanthrolin-1-yl group, a 2,8-phenanthrolin-3-yl group, a 2,8-phenanthrolin-4-yl group, a 2,8-phenanthrolin-5-yl group, a 2,8-phenanthrolin-6-yl group, a 2,8-phenanthrolin-7-yl group, a 2,8-phenanthrolin-9-yl group, a 2,8-phenanthrolin-10-yl group, a 2,7-phenanthrolin-1-yl group, a 2,7-phenanthrolin-3-yl group, a 2,7-phenanthrolin-4-yl group, a 2,7-phenanthrolin-5-yl group, a 2,7-phenanthrolin-6-yl group, a 2,7-phenanthrolin-8-yl group, a 2,7-phenanthrolin-9-yl group, a 2,7-phenanthrolin-10-yl group, a 1-phenazinyl group, a 2-phenazinyl group, a 1-phenothiazinyl group, a 2-phenothiazinyl group, a 3-phenothiazinyl group, a 4-phenothiazinyl group, a 10-phenothiazinyl group, a 1-phenoxazinyl group, a 2-phenoxazinyl group, a 3-phenoxazinyl group, a 4-phenoxazinyl group, a 10-phenoxazinyl group, a 2-oxazolyl group, a 4-oxazolyl group, a 5-oxazolyl group, a 2-oxadiazolyl group, a 5-oxadiazolyl group, a 3-furazanyl group, a 2-thienyl group, a 3-thienyl group, a 2-methylpyrrol-1-yl group, a 2-methylpyrrol-3-yl group, a 2-methylpyrrol-4-yl group, a 2-methylpyrrol-5-yl group, a 3-methylpyrrol-1-yl group, a 3-methylpyrrol-2-yl group, a 3-methylpyrrol-4-yl group, a 3-methylpyrrol-5-yl group, a 2-tert-butylpyrrol-4-yl group, a 3-(2-phenylpropyl)pyrrol-1-yl group, a 2-methyl-1-indolyl group, a 4-methyl-1-indolyl group, a 2-methyl-3-indolyl group, a 4-methyl-3-indolyl group, a 2-tert-butyl 1-indolyl group, a 4-tert-butyl 1-indolyl group, a 2-tert-butyl 3-indolyl group, and a 4-tert-butyl 3-indolyl group. Among them, as the heterocyclyl group as R³, preferred are a 1-pyrrolyl group, a 2-pyrrolyl group, a 3-pyrrolyl group, a pyrazinyl group, a 2-pyridyl group, a 3-pyridyl group, a 4-pyridyl group, a 1-indolyl group, a 2-indolyl group, a 3-indolyl group, a 4-indolyl group, a 5-indolyl group, a 6-indolyl group, a 7-indolyl group, a 2-furyl group, a 3-furyl group, a 2-benzofuranyl group, a 3-benzofuranyl group, a 4-benzofuranyl group, a 5-benzofuranyl group, a 6-benzofuranyl group, a 7-benzofuranyl group, a 2-quinolyl group, a 3-quinolyl group, a 4-quinolyl group, a 5-quinolyl group, a 6-quinolyl group, a 7-quinolyl group, an 8-quinolyl group, a 1-carbazolyl group, a 2-carbazolyl group, a 3-carbazolyl group, a 4-carbazolyl group, a 9-carbazolyl group, a 1-acridinyl group, a 2-acridinyl group, a 3-acridinyl group, a 4-acridinyl group, a 9-acridinyl group, a 1-phenazinyl group, a 2-phenazinyl group, a 1-phenoxazinyl group, a 2-phenoxazinyl group, a 3-phenoxazinyl group, a 4-phenoxazinyl group, a 10-phenoxazinyl group, a 2-oxazolyl group, a 4-oxazolyl group, a 5-oxazolyl group, a 2-oxadiazolyl group, a 5-oxadiazolyl group, a 2-thienyl group, and a 3-thienyl group; more preferred are a 1-pyrrolyl group, a 2-pyrrolyl group, a 3-pyrrolyl group, a 2-pyridyl group, a 3-pyridyl group, a 4-pyridyl group, a 2-furyl group, a 3-furyl group, a 2-quinolyl group, a 3-quinolyl group, a 4-quinolyl group, a 5-quinolyl group, a 6-quinolyl group, a 7-quinolyl group, an 8-quinolyl group, a 1-acridinyl group, a 2-acridinyl group, a 3-acridinyl group, a 4-acridinyl group, a 9-acridinyl group, a 2-oxazolyl group, a 4-oxazolyl group, a 5-oxazolyl group, a 2-thienyl group, and a 3-thienyl group; and further preferred are a 2-pyridyl group, a 3-pyridyl group, a 4-pyridyl group, a 2-quinolyl group, a 3-quinolyl group, a 4-quinolyl group, a 5-quinolyl group, a 6-quinolyl group, a 7-quinolyl group, an 8-quinolyl group, a 1-acridinyl group, a 2-acridinyl group, a 3-acridinyl group, a 4-acridinyl group, and a 9-acridinyl group.

R⁴ is a hydrogen atom or a substituent. Examples of R⁴ may include a hydrogen atom, a hydrocarbyl group that may be substituted, a heterocyclyl group that may be substituted, an acyl group that may be substituted, and a hydrocarbyloxycarbonyl group that may be substituted. Among them, as R⁴, preferred is a hydrocarbyl group that may be substituted. Details of the hydrocarbyl groups and the like included in the specific examples and the preferred examples of R⁴ are the same as the groups corresponding to the groups in the above descriptions with respect to R¹ and R².

R⁵ is a hydrogen atom or a substituent. Examples of R⁵ may include a hydrogen atom, a hydrocarbyl group that may be substituted, a hydrocarbyloxy group that may be substituted, a hydrocarbylthio group that may be substituted, a heterocyclyl group that may be substituted, and a silyl group that may be substituted. Among them, as R⁵, preferred are a hydrogen atom and a hydrocarbyl group that may be substituted. Two R⁵s may be different from each other. Details of the hydrocarbyl groups and the like included in the specific examples and the preferred examples of R⁵ are the same as the groups corresponding to the groups in the above descriptions with respect to R¹ and R².

E¹ is monovalent group having 50 or less carbon atoms. The monovalent group having 50 or less carbon atoms as E¹ may be any of a linear group, a branched group, and a cyclic group. Examples of the monovalent group having 50 or less carbon atoms as E¹ may include a hydrocarbyl group that may be substituted, a hydrocarbyloxy group that may be substituted, a hydrocarbylthio group that may be substituted, a heterocyclyl group that may be substituted, a halogen atom, a cyano group, a hydroxy group, a mercapto group, a carboxy group, a sulfo group, a phosphoric acid group, a nitro group, an acyl group that may be substituted, an acyloxy group that may be substituted, and a dithiocarbamate group that may be substituted. Among them, as monovalent group having 50 or less carbon atoms as E¹, preferred are a hydrocarbyl group that may be substituted, a heterocyclyl group that may be substituted, and a halogen atom; more preferred are a hydrocarbyl group that may be substituted and a heterocyclyl group that may be substituted; and further preferred is a hydrocarbyl group that may be substituted.

When E¹ is a group containing a carbon atom, E¹ is a C₁₋₅₀ group, preferably a C₁₋₃₀ group, more preferably a C₂₋₂₀ group, and further preferably a C₂₋₁₀ group.

Examples of the halogen atom as E¹ may include a fluorine atom, a chlorine atom, a bromine atom, and an iodine atom. Among them, as the halogen atom as E¹, preferred are a fluorine atom, a chlorine atom, and a bromine atom, and more preferred is a chlorine atom.

Examples of the hydrocarbyl group as E¹ may include a methyl group, an ethyl group, a benzyl group, a 1-phenetyl group, a 2-phenetyl group, a vinyl group, a propenyl group, a butenyl group, a phenyl group, a 2-tolyl group, a 3-tolyl group, a 4-tolyl group, a mesityl group, a 2-biphenylyl group, a 3-biphenylyl group, a 4-biphenylyl group, a terphenylyl group, a 3,5-diphenylphenyl group, a 3,4-diphenylphenyl group, a pentaphenylphenyl group, a 4-(2,2-diphenylvinyl)phenyl group, a 4-(1,2,2-triphenylvinyl)phenyl group, a fluorenyl group, a 1-naphthyl group, a 2-naphthyl group, a 1-anthryl group, a 2-anthryl group, a 9-anthryl group, a 1-phenanthryl group, a 2-phenanthryl group, a 3-phenanthryl group, a 4-phenanthryl group, a 9-phenanthryl group, a 1-naphthacenyl group, a 2-naphthacenyl group, a 9-naphthacenyl group, a 1-pyrenyl group, a 2-pyrenyl group, a 4-pyrenyl group, a 6-chrysenyl group, a 1-benzo[c]phenanthryl group, a 2-benzo[c]phenanthryl group, a 3-benzo[c]phenanthryl group, a 4-benzo[c]phenanthryl group, a 5-benzo[c]phenanthryl group, a 6-benzo[c]phenanthryl group, a 1-benzo[g]chrysenyl group, a 2-benzo[g]chrysenyl group, a 3-benzo[g]chrysenyl group, 4-benzo[g]chrysenyl group, a 5-benzo[g]chrysenyl group, a 6-benzo[g]chrysenyl group, a 7-benzo[g]chrysenyl group, an 8-benzo[g]chrysenyl group, a 9-benzo[g]chrysenyl group, a 10-benzo[g]chrysenyl group, a 11-benzo[g]chrysenyl group, a 12-benzo[g]chrysenyl group, a 13-benzo[g]chrysenyl group, a 14-benzo[g]chrysenyl group, a benzofluorenyl group, and a dibenzofluorenyl group. Among them, as the hydrocarbyl group as E¹, preferred are a phenyl group, a 2-tolyl group, a 3-tolyl group, a 4-tolyl group, a mesityl group, a fluorenyl group, a 1-naphthyl group, a 2-naphthyl group, a 1-anthryl group, a 2-anthryl group, a 9-anthryl group, a 1-phenanthryl group, a 2-phenanthryl group, a 3-phenanthryl group, a 4-phenanthryl group, a 9-phenanthryl group, a 1-naphthacenyl group, a 2-naphthacenyl group, a 9-naphthacenyl group, a 1-pyrenyl group, a 2-pyrenyl group, and a 4-pyrenyl group; more preferred are a phenyl group, a 2-tolyl group, a 3-tolyl group, a 4-tolyl group, a mesityl group, a fluorenyl group, a 1-naphthyl group, a 2-naphthyl group, a 1-anthryl group, a 2-anthryl group, and a 9-anthryl group; further preferred are a phenyl group, a 2-tolyl group, a 4-tolyl group, and a mesityl group; and particularly preferred is a phenyl group.

Examples of the hydrocarbyloxy group as E¹ may include a methoxy group, an ethoxy group, a benzyloxy group, a 1-phenetyloxy group, a 2-phenetyloxy group, a phenoxy group, a 2-tolyloxy group, a 4-tolyloxy group, a 2-phenylphenoxy group, a 3-phenylphenoxy group, a 4-phenylphenoxy group, a 3,5-diphenylphenoxy group, a 3,4-diphenylphenoxy group, a pentaphenylphenoxy group, a 4-(2,2-diphenylvinyl)phenoxy group, a 4-(1,2,2-triphenylvinyl)phenoxy group, a 1-naphthyloxy group, a 2-naphthyloxy group, a 1-anthryloxy group, a 2-anthryloxy group, a 9-anthryloxy group, a 1-phenanthryloxy group, a 2-phenanthryloxy group, a 3-phenanthryloxy group, a 4-phenanthryloxy group, a 9-phenanthryloxy group, a 1-naphthacenyloxy group, a 2-naphthacenyloxy group, a 9-naphthacenyloxy group, a 1-pyrenyloxy group, a 2-pyrenyloxy group, a 4-pyrenyloxy group, a 6-chrysenyloxy group, a 1-benzo[c]phenanthryloxy group, a 2-benzo[c]phenanthryloxy group, a 3-benzo[c]phenanthryloxy group, a 4-benzo[c]phenanthryloxy group, a 5-benzo[c]phenanthryloxy group, a 6-benzo[c]phenanthryloxy group, a 1-benzo[g]chrysenyloxy group, a 2-benzo[g]chrysenyloxy group, a 3-benzo[g]chrysenyloxy group, a 4-benzo[g]chrysenyloxy group, a 5-benzo[g]chrysenyloxy group, a 6-benzo[g]chrysenyloxy group, a 7-benzo[g]chrysenyloxy group, an 8-benzo[g]chrysenyloxy group, a 9-benzo[g]chrysenyloxy group, a 10-benzo[g]chrysenyloxy group, a 11-benzo[g]chrysenyloxy group, a 12-benzo[g]chrysenyloxy group, a 13-benzo[g]chrysenyloxy group, and a 14-benzo[g]chrysenyloxy group. Among them, as the hydrocarbyloxy group as E¹, preferred are a phenoxy group, a 2-tolyloxy group, a 4-tolyloxy group, a 2-naphthyloxy group, a 1-anthryloxy group, a 2-anthryloxy group, a 9-anthryloxy group, a 1-phenanthryloxy group, a 2-phenanthryloxy group, a 3-phenanthryloxy group, a 4-phenanthryloxy group, a 9-phenanthryloxy group, a 1-naphthacenyloxy group, a 2-naphthacenyloxy group, a 9-naphthacenyloxy group, a 1-pyrenyloxy group, a 2-pyrenyloxy group, and a 4-pyrenyloxy group; more preferred are a phenoxy group, a 2-tolyloxy group, a 4-tolyloxy group, a 2-naphthyloxy group, a 1-anthryloxy group, a 2-anthryloxy group, a 9-anthryloxy group, and a 1-phenanthryloxy group; further preferred are a phenoxy group, a 2-tolyloxy group, and a 4-tolyloxy group; and particularly preferred is a phenoxy group.

Examples of the hydrocarbylthio group as E¹ may include a methylthio group, an ethylthio group, a benzylthio group, a 1-phenetylthio group, a 2-phenetylthio group, a phenylthio group, a 2-tolylthio group, a 4-tolylthio group, a 2-biphenylthio group, a 3-biphenylthio group, a 4-biphenylthio group, a 3,5-diphenylphenylthio group, a 3,4-diphenylphenylthio group, a pentaphenylphenylthio group, a 4-(2,2-diphenylvinyl)phenylthio group, a 4-(1,2,2-triphenylvinyl)phenylthio group, a 1-naphthylthio group, a 2-naphthylthio group, a 1-anthrylthio group, a 2-anthrylthio group, a 9-anthrylthio group, a 1-phenanthrylthio group, a 2-phenanthrylthio group, a 3-phenanthrylthio group, a 4-phenanthrylthio group, a 9-phenanthrylthio group, a 1-naphthacenylthio group, a 2-naphthacenylthio group, a 9-naphthacenylthio group, a 1-pyrenylthio group, a 2-pyrenylthio group, a 4-pyrenylthio group, a 6-chrysenylthio group, a 1-benzo[c]phenanthrylthio group, a 2-benzo[c]phenanthrylthio group, a 3-benzo[c]phenanthrylthio group, a 4-benzo[c]phenanthrylthio group, a 5-benzo[c]phenanthrylthio group, a 6-benzo[c]phenanthrylthio group, a 1-benzo[g]chrysenylthio group, a 2-benzo[g]chrysenylthio group, a 3-benzo[g]chrysenylthio group, a 4-benzo[g]chrysenylthio group, a 5-benzo[g]chrysenylthio group, a 6-benzo[g]chrysenylthio group, a 7-benzo[g]chrysenylthio group, an 8-benzo[g]chrysenylthio group, a 9-benzo[g]chrysenylthio group, a 10-benzo[g]chrysenylthio group, a 11-benzo[g]chrysenylthio group, a 12-benzo[g]chrysenylthio group, a 13-benzo[g]chrysenylthio group, and a 14-benzo[g]chrysenylthio group. Among them, as the hydrocarbylthio group as E¹, preferred are a phenylthio group, a 2-tolylthio group, a 4-tolylthio group, a 2-naphthylthio group, a 1-anthrylthio group, a 2-anthrylthio group, a 9-anthrylthio group, a 1-phenanthrylthio group, a 2-phenanthrylthio group, a 3-phenanthrylthio group, a 4-phenanthrylthio group, a 9-phenanthrylthio group, a 1-naphthacenylthio group, a 2-naphthacenylthio group, a 9-naphthacenylthio group, a 1-pyrenylthio group, a 2-pyrenylthio group, and a 4-pyrenylthio group; more preferred are a phenylthio group, a 2-tolylthio group, a 4-tolylthio group, a 2-naphthylthio group, a 1-anthrylthio group, a 2-anthrylthio group, a 9-anthrylthio group, and a 1-phenanthrylthio group; further preferred are a phenylthio group, a 2-tolylthio group, and a 4-tolylthio group; and particularly preferred is a phenylthio group.

Examples of the heterocyclyl group as E¹ may include a 1-pyrrolyl group, a 2-pyrrolyl group, a 3-pyrrolyl group, a pyrazinyl group, a 2-pyridyl group, a 3-pyridyl group, a 4-pyridyl group, a 1-indolyl group, a 2-indolyl group, a 3-indolyl group, a 4-indolyl group, a 5-indolyl group, a 6-indolyl group, a 7-indolyl group, a 1-isoindolyl group, a 2-isoindolyl group, a 3-isoindolyl group, a 4-isoindolyl group, a 5-isoindolyl group, a 6-isoindolyl group, a 7-isoindolyl group, a 2-furyl group, a 3-furyl group, a 2-benzofuranyl group, a 3-benzofuranyl group, a 4-benzofuranyl group, a 5-benzofuranyl group, a 6-benzofuranyl group, a 7-benzofuranyl group, a 1-isobenzofuranyl group, a 3-isobenzofuranyl group, a 4-isobenzofuranyl group, a 5-isobenzofuranyl group, a 6-isobenzofuranyl group, a 7-isobenzofuranyl group, a 2-quinolyl group, a 3-quinolyl group, a 4-quinolyl group, a 5-quinolyl group, a 6-quinolyl group, a 7-quinolyl group, an 8-quinolyl group, a 1-isoquinolyl group, a 3-isoquinolyl group, a 4-isoquinolyl group, a 5-isoquinolyl group, a 6-isoquinolyl group, a 7-isoquinolyl group, an 8-isoquinolyl group, a 2-quinoxalinyl group, a 5-quinoxalinyl group, a 6-quinoxalinyl group, a 1-carbazolyl group, a 2-carbazolyl group, a 3-carbazolyl group, a 4-carbazolyl group, a 9-carbazolyl group, a 1-phenanthridinyl group, a 2-phenanthridinyl group, a 3-phenanthridinyl group, a 4-phenanthridinyl group, a 6-phenanthridinyl group, a 7-phenanthridinyl group, an 8-phenanthridinyl group, a 9-phenanthridinyl group, a 10-phenanthridinyl group, a 1-acridinyl group, a 2-acridinyl group, a 3-acridinyl group, a 4-acridinyl group, a 9-acridinyl group, a 1,7-phenanthrolin-2-yl group, a 1,7-phenanthrolin-3-yl group, a 1,7-phenanthrolin-4-yl group, a 1,7-phenanthrolin-5-yl group, a 1,7-phenanthrolin-6-yl group, a 1,7-phenanthrolin-8-yl group, a 1,7-phenanthrolin-9-yl group, a 1,7-phenanthrolin-10-yl group, a 1,8-phenanthrolin-2-yl group, a 1,8-phenanthrolin-3-yl group, a 1,8-phenanthrolin-4-yl group, a 1,8-phenanthrolin-5-yl group, a 1,8-phenanthrolin-6-yl group, a 1,8-phenanthrolin-7-yl group, a 1,8-phenanthrolin-9-yl group, a 1,8-phenanthrolin-10-yl group, a 1,9-phenanthrolin-2-yl group, a 1,9-phenanthrolin-3-yl group, a 1,9-phenanthrolin-4-yl group, a 1,9-phenanthrolin-5-yl group, a 1,9-phenanthrolin-6-yl group, a 1,9-phenanthrolin-7-yl group, a 1,9-phenanthrolin-8-yl group, 1,9-phenanthrolin-10-yl group, a 1,10-phenanthrolin-2-yl group, a 1,10-phenanthrolin-3-yl group, a 1,10-phenanthrolin-4-yl group, a 1,10-phenanthrolin-5-yl group, a 2,9-phenanthrolin-1-yl group, a 2,9-phenanthrolin-3-yl group, a 2,9-phenanthrolin-4-yl group, a 2,9-phenanthrolin-5-yl group, a 2,9-phenanthrolin-6-yl group, a 2,9-phenanthrolin-7-yl group, a 2,9-phenanthrolin-8-yl group, a 2,9-phenanthrolin-10-yl group, a 2,8-phenanthrolin-1-yl group, a 2,8-phenanthrolin-3-yl group, a 2,8-phenanthrolin-4-yl group, a 2,8-phenanthrolin-5-yl group, a 2,8-phenanthrolin-6-yl group, a 2,8-phenanthrolin-7-yl group, a 2,8-phenanthrolin-9-yl group, a 2,8-phenanthrolin-10-yl group, a 2,7-phenanthrolin-1-yl group, a 2,7-phenanthrolin-3-yl group, a 2,7-phenanthrolin-4-yl group, a 2,7-phenanthrolin-5-yl group, a 2,7-phenanthrolin-6-yl group, a 2,7-phenanthrolin-8-yl group, a 2,7-phenanthrolin-9-yl group, a 2,7-phenanthrolin-10-yl group, a 1-phenazinyl group, a 2-phenazinyl group, a 1-phenothiazinyl group, a 2-phenothiazinyl group, a 3-phenothiazinyl group, a 4-phenothiazinyl group, a 10-phenothiazinyl group, a 1-phenoxazinyl group, a 2-phenoxazinyl group, a 3-phenoxazinyl group, a 4-phenoxazinyl group, a 10-phenoxazinyl group, a 2-oxazolyl group, a 4-oxazolyl group, a 5-oxazolyl group, a 2-oxadiazolyl group, a 5-oxadiazolyl group, a 3-furazanyl group, a 2-thienyl group, a 3-thienyl group, a 2-methylpyrrol-1-yl group, a 2-methylpyrrol-3-yl group, a 2-methylpyrrol-4-yl group, a 2-methylpyrrol-5-yl group, a 3-methylpyrrol-1-yl group, a 3-methylpyrrol-2-yl group, a 3-methylpyrrol-4-yl group, a 3-methylpyrrol-5-yl group, a 2-tert-butylpyrrol-4-yl group, a 3-(2-phenylpropyl)pyrrol-1-yl group, a 2-methyl-1-indolyl group, a 4-methyl-1-indolyl group, a 2-methyl-3-indolyl group, a 4-methyl-3-indolyl group, a 2-tert-butyl 1-indolyl group, a 4-tert-butyl 1-indolyl group, a 2-tert-butyl 3-indolyl group, and a 4-tert-butyl 3-indolyl group. Among them, as the heterocyclyl group as E¹, preferred are a 1-pyrrolyl group, a 2-pyrrolyl group, a 3-pyrrolyl group, a pyrazinyl group, a 2-pyridyl group, a 3-pyridyl group, a 4-pyridyl group, a 1-indolyl group, a 2-indolyl group, a 3-indolyl group, a 4-indolyl group, a 5-indolyl group, a 6-indolyl group, a 7-indolyl group, a 2-furyl group, a 3-furyl group, a 2-benzofuranyl group, a 3-benzofuranyl group, a 4-benzofuranyl group, a 5-benzofuranyl group, a 6-benzofuranyl group, a 7-benzofuranyl group, a 2-quinolyl group, a 3-quinolyl group, a 4-quinolyl group, a 5-quinolyl group, a 6-quinolyl group, a 7-quinolyl group, an 8-quinolyl group, a 1-carbazolyl group, a 2-carbazolyl group, a 3-carbazolyl group, a 4-carbazolyl group, a 9-carbazolyl group, a 1-acridinyl group, a 2-acridinyl group, a 3-acridinyl group, a 4-acridinyl group, a 9-acridinyl group, a 1-phenazinyl group, a 2-phenazinyl group, a 1-phenoxazinyl group, a 2-phenoxazinyl group, a 3-phenoxazinyl group, a 4-phenoxazinyl group, a 10-phenoxazinyl group, a 2-oxazolyl group, a 4-oxazolyl group, a 5-oxazolyl group, a 2-oxadiazolyl group, a 5-oxadiazolyl group, a 2-thienyl group, and a 3-thienyl group; more preferred are a 1-pyrrolyl group, a 2-pyrrolyl group, a 3-pyrrolyl group, a 2-pyridyl group, a 3-pyridyl group, a 4-pyridyl group, a 2-furyl group, a 3-furyl group, a 2-quinolyl group, a 3-quinolyl group, a 4-quinolyl group, a 5-quinolyl group, a 6-quinolyl group, a 7-quinolyl group, an 8-quinolyl group, a 1-acridinyl group, a 2-acridinyl group, a 3-acridinyl group, a 4-acridinyl group, a 9-acridinyl group, a 2-oxazolyl group, a 4-oxazolyl group, a 5-oxazolyl group, a 2-thienyl group, and a 3-thienyl group; and further preferred are a 2-pyridyl group, a 3-pyridyl group, a 4-pyridyl group, a 2-quinolyl group, a 3-quinolyl group, a 4-quinolyl group, a 5-quinolyl group, a 6-quinolyl group, a 7-quinolyl group, an 8-quinolyl group, a 1-acridinyl group, a 2-acridinyl group, a 3-acridinyl group, a 4-acridinyl group, and a 9-acridinyl group.

The acyl group as E¹ is a group of RCO—, where R is a hydrogen atom or a hydrocarbyl group and the hydrocarbyl group may be any of a linear group, a branched group, and a cyclic group. Examples of the acyl group as E¹ may include an acetyl group, a propionyl group, a butyryl group, an isobutyryl group, a pivaloyl group, a benzoyl group, a trifluoroacetyl group, and a pentafluorobenzoyl group. Among them, as the acyl group as E¹, preferred are an acetyl group, a propionyl group, and a benzoyl group.

The acyloxy group as E¹ is a group of RCO₂—, where R is a hydrogen atom or a hydrocarbyl group and the hydrocarbyl group may be any of a linear group, a branched group, and a cyclic group. Examples of the acyloxy group as E¹ may include an acetoxy group, a propionyloxy group, butyryloxy group, an isobutyryloxy group, a pivaloyloxy group, a benzoyloxy group, a trifluoroacetyloxy group, and a pentafluorobenzoyloxy group. Among them, as the acyloxy group as E¹, preferred are an acetoxy group, a propionyloxy group, and a benzoyloxy group.

The dithiocarbamate group as E¹ is a group of R₂N—CS—S—, where R is a hydrogen atom or a hydrocarbyl group and the hydrocarbyl group may be any of a linear group, a branched group, and a cyclic group. Examples of the dithiocarbamate group as E¹ may include a dimethyldithiocarbamate group, a diethyldithiocarbamate group, a methylethyldithiocarbamate group, a di-n-butyldicarbamate group, a dicyclohexyldithiocarbamate group, a phenyltolyldithiocarbamate group, and a dibenzyldithiocarbamate group. Among them, as the dithiocarbamate group as E¹, preferred are a dimethyldithiocarbamate group, a diethyldithiocarbamate group, and a methylethyldithiocarbamate group.

L¹ is a ligand having 50 or less carbon atoms. The bond indicated by a dotted line in Formula (1) is a coordinate bond. The ligand having 50 or less carbon atoms as L¹ may be any of a linear group, a branched group, and a cyclic group. Examples of the ligand having 50 or less carbon atoms as L¹ may include a heterocyclic compound that may be substituted, a phosphine that may be substituted, a phosphine oxide that may be substituted, and an amine that may be substituted. Among them, as the ligand having 50 or less carbon atoms as L¹, preferred is a heterocyclic compound that may be substituted. When L¹ is a group containing a carbon atom, L¹ is a C₁₋₅₀ group, preferably a C₃₋₃₀ group, more preferably a C₅₋₂₀ group, and further preferably a C₅₋₁₀ group.

Examples of the heterocyclic compound as L¹ may include piperidine, piperazine, morpholine, thiophene, furan, imidazole, pyrazole, pyridine, pyrazine, pyridazine, pyrimidine, triazole, triazine, indole, indazole, purine, thiazole, thiadiazole, oxazole, oxadiazole, quinoline, isoquinoline, phthalazine, naphthyridine, quinoxaline, quinazoline, cinnoline, pteridine, acridine, phenanthroline, phenazine, tetrazole, benzimidazole, benzoxazole, benzothiazole, benzotriazole, tetraazaindene, and carbazole. Among them, as the heterocyclic compound as L¹, preferred are imidazole, pyrazole, pyridine, pyrazine, pyridazine, pyrimidine, triazole, triazine, indole, indazole, thiazole, thiadiazole, oxazole, oxadiazole, quinoline, benzimidazole, benzoxazole, and benzothiazole; more preferred are imidazole, pyrazole, pyridine, triazine, thiazole, oxazole, quinoline, and benzimidazole; further preferred are imidazole, pyrazole, pyridine, thiazole, and oxazole; and particularly preferred is pyridine.

Examples of the phosphine as L¹ may include triphenyl phosphine, propyl diphenyl phosphine, tert-butyl diphenyl phosphine, n-butyl diphenyl phosphine, n-hexyl diphenyl phosphine, cyclohexyl diphenyl phosphine, dicyclohexyl phenyl phosphine, tricyclohexyl phosphine, trimethyl phosphine, tri(2-furyl) phosphine, tri(3-furyl) phosphine, tri(2-pyridyl) phosphine, tri(3-pyridyl) phosphine, tri(4-pyridyl) phosphine, 2-furyl diphenyl phosphine, 3-furyl diphenyl phosphine, 2-pyridyl diphenyl phosphine, 3-pyridyl diphenyl phosphine, and 4-pyridyl diphenyl phosphine. Among them, as the phosphine as L¹, preferred are triphenyl phosphine, tricyclohexyl phosphine, trimethyl phosphine, tri(2-furyl) phosphine, tri(3-furyl) phosphine, tri(2-pyridyl) phosphine, tri(3-pyridyl) phosphine, tri(4-pyridyl) phosphine, 2-furyl diphenyl phosphine, 3-furyl diphenyl phosphine, 2-pyridyl diphenyl phosphine, 3-pyridyl diphenyl phosphine, and 4-pyridyl diphenyl phosphine; and more preferred is triphenyl phosphine.

Examples of the phosphine oxide as L¹ may include triphenyl phosphine oxide, propyl diphenyl phosphine oxide, tert-butyl diphenyl phosphine oxide, n-butyl diphenyl phosphine oxide, n-hexyl diphenyl phosphine oxide, cyclohexyl diphenyl phosphine oxide, dicyclohexyl phenyl phosphine oxide, tricyclohexyl phosphine oxide, trimethyl phosphine oxide, tri(2-furyl) phosphine oxide, tri(3-furyl) phosphine oxide, tri(2-pyridyl) phosphine oxide, tri(3-pyridyl) phosphine oxide, tri(4-pyridyl) phosphine oxide, 2-furyl diphenyl phosphine oxide, 3-furyl diphenyl phosphine oxide, 2-pyridyl diphenyl phosphine oxide, 3-pyridyl diphenyl phosphine oxide, and 4-pyridyl diphenyl phosphine oxide. Among them, as the phosphine oxide as L¹, preferred are triphenyl phosphine oxide, tricyclohexyl phosphine oxide, trimethyl phosphine oxide, tri(2-furyl) phosphine oxide, tri(3-furyl) phosphine oxide, tri(2-pyridyl) phosphine oxide, tri(3-pyridyl) phosphine oxide, tri(4-pyridyl) phosphine oxide, 2-furyl diphenyl phosphine oxide, 3-furyl diphenyl phosphine oxide, 2-pyridyl diphenyl phosphine oxide, 3-pyridyl diphenyl phosphine oxide, and 4-pyridyl diphenyl phosphine oxide; and more preferred is triphenyl phosphine oxide.

Examples of the amine as L¹ may include triphenylamine, diphenylamine, propyldiphenylamine, tert-butyldiphenylamine, n-butyldiphenylamine, n-hexyldiphenylamine, cyclohexyldiphenylamine, dicyclohexylphenylamine, tricyclohexylamine, trimethylamine, and dimethylamine. Among them, as the amine as L¹, preferred are triphenylamine, diphenylamine, tricyclohexylamine, trimethylamine, and dimethylamine.

In Formula (1), c is an integer of 0 to 3, preferably an integer of 0 to 2, more preferably 0 or 1, further preferably 0.

When c is 0, between the combination of E¹ and Ar¹ and the combination of E¹ and Ar², a bond may be formed. When c is 1, between the combination of E¹ and L¹, the combination of E¹ and Ar¹, the combination of E¹ and Ar², the combination of L¹ and Ar¹, and the combination of L¹ and Ar², a bond may be formed. When c is an integer of 2 or more, between the combination of E¹ and L¹, the combination of E¹ and Ar¹, the combination of E¹ and Ar², the combination of L¹ and Ar¹, the combination of L¹ and Ar², and the combination of L¹ and L¹, a bond may be formed.

Among the compounds of Formula (1), examples of the compound capable of being suitably applied to the thin film of the present invention may include the compounds of Formula (2) below. The same symbols as those in Formula (1) represent the same mean as those in Formula (1) also in Formula (2).

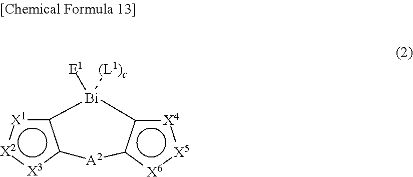

wherein A² is any of direct bond, —O—, —S—, —PR³—, —NR⁴—, and —C(—R⁵)₂—; two of X¹, X², and X³ are —CR⁶═ and remaining one thereof is —S—, —O—, or —NR⁷—; two of X⁴, X⁵, and X⁶ are —CR⁶═ and remaining one thereof is —S—, —O—, or —NR⁷—; E¹, L¹, and c are the same as defined above; R⁶ is a hydrogen atom or a substituent; R⁷ is a hydrogen atom or a substituent; when each R⁶ is adjacent to each other, each R⁶ may form together with each other a bond; when R⁶ and R⁷ are adjacent to each other, R⁶ and R⁷ may form together with each other a bond; when X¹ or X² is —CR⁶═ or —NR⁷—, R⁶ or R⁷ may form together with E¹ a bond; when X⁴ or X⁵ is —CR⁶═ or —NR⁷— and c is 1 to 3, R⁶ or R⁷ may form together with L¹ a bond; and when c is 1 to 3, each combination of the combination of E¹ and L¹ and the combination of L¹ and L¹ may form together with each other a bond.

A² is any of direct bond, —O—, —S—, —PR³—, —NR⁴—, and —C(—R⁵)₂— and is preferably direct bond, —O—, or —S—, more preferably direct bond.

Two of X¹, X², and X³ are —CR⁶═ and remaining one thereof is —S—, —O—, or —NR⁷—. Two of X⁴, X⁵, and X⁶ are —CR⁶═ and remaining one thereof is —S—, —O—, or —NR⁷—. When X¹, X², X³, X⁴, X⁵ and X⁶ are a group other than —CR⁶═, preferably at least one is —S—, more preferably both are —S—.

R⁶ is a hydrogen atom or a substituent. The substituent as R⁶ may be any one of a linear group, a branched group, and a cyclic group. Examples of R⁶ may include a hydrogen atom, a hydrocarbyl group that may be substituted, a hydrocarbyloxy group that may be substituted, a hydrocarbylthio group that may be substituted, a heterocyclyl group that may be substituted, a halogen atom, a cyano group, an acylamino group that may be substituted, an imino group that may be substituted, a silyl group that may be substituted, an acyl group that may be substituted, a hydrocarbyloxycarbonyl group that may be substituted, a hydrocarbyloxysulfonyl group that may be substituted, a hydrocarbyloxyphosphoryl group that may be substituted, a phosphino group that may be substituted, a phosphine oxide group that may be substituted, an amino group that may be substituted, a hydroxy group, a mercapto group, a carboxy group, a sulfo group, a phosphoric acid group, a phosphonic acid group, and a nitro group. From the viewpoint of the stability of the compound, as the substituent as R⁶, preferred are a hydrogen atom, a hydrocarbyl group that may be substituted, a hydrocarbyloxy group that may be substituted, a halogen atom, a cyano group, a silyl group that may be substituted, a hydrocarbyloxysulfonyl group that may be substituted, a hydrocarbyloxyphosphoryl group that may be substituted, a phosphino group that may be substituted, a phosphine oxide group that may be substituted, an amino group that may be substituted, a hydroxy group, a carboxy group, a sulfo group, a phosphoric acid group, a phosphonic acid group, and a nitro group; more preferred are a hydrogen atom, a hydrocarbyl group that may be substituted, a hydrocarbyloxy group that may be substituted, a halogen atom, a cyano group, a silyl group that may be substituted, an amino group that may be substituted, a hydroxy group, a carboxy group, a sulfo group, a phosphoric acid group, and a nitro group; further preferred are a hydrogen atom, a hydrocarbyl group that may be substituted, a hydrocarbyloxy group that may be substituted, a silyl group that may be substituted, and an amino group that may be substituted; particularly preferred are a hydrogen atom, a hydrocarbyl group that may be substituted, a hydrocarbyloxy group that may be substituted, and a silyl group that may be substituted; and the most preferred are a hydrocarbyl group that may be substituted and a silyl group that may be substituted.

Details of the groups and the atoms such as the hydrocarbyl group included in the specific examples and the preferred examples of R⁶ are the same as the groups and the atoms corresponding to those in the above descriptions with respect to R¹ and R² in Formula (1).

R⁷ is the same as defined as R⁴ in Formula (1) and specific examples and preferred examples of R⁷ are the same as those of R⁴.

When a plurality of R⁶s are a group other than a hydrogen atom and they are adjacent to each other, R⁶s may form together with each other a bond. For example, when both of two R⁶s in two —CR⁶═ as any two of X¹, X², and X³ are a group other than a hydrogen atom and they are adjacent to each other, they may form a bond. When both of two R⁶s in two —CR⁶═ as any two of X⁴, X⁵, and X⁶ are a group other than a hydrogen atom and they are adjacent to each other, they may form a bond. Preferred examples of the form in which two R⁶s are adjacent to each other may include a form in which X¹ and X² are —CR⁶═, a form in which X² and X³ are —CR⁶═, a form in which X⁴ and X⁵ are —CR⁶═, and a form in which X⁵ and X⁶ are —CR⁶═.

When R⁶ and R⁷ are a group other than a hydrogen atom and they are adjacent to each other, R⁶ and R⁷ may form together with each other a bond. For example, when R⁶ and R⁷ contained in X¹, X², and X³ are a group other than a hydrogen atom and they are adjacent to each other, they may form a bond. When R⁶ and R⁷ contained in X⁴, X⁵, and X⁶ are a group other than a hydrogen atom and they are adjacent to each other, they may form a bond. Preferred examples of the form in which R⁶ and R⁷ are adjacent to each other may include a form in which any one of X¹ and X² is —CR⁶═ and another thereof is —NR⁷—, a form in which any one of X² and X³ is —CR⁶═ and another thereof is —NR⁷—, a form in which any one of X⁴ and X⁵ is —CR⁶═ and another thereof is —NR⁷—, and a form in which any one of X⁵ and X⁶ is —CR⁶═ and another thereof is —NR⁷—.

When X¹ is —CR⁶═ or —NR⁷—, and R⁶ or R⁷ thereof is a group other than a hydrogen atom, R⁶ or R⁷ may form together with E¹ or L¹ a bond.

When X² is —CR⁶═ or —NR⁷—, and R⁶ or R⁷ thereof is a group other than a hydrogen atom, R⁶ or R⁷ may form together with E¹ or L¹ a bond.

When X⁴ is —CR⁶═ or —NR⁷—, and R⁶ or R⁷ thereof is a group other than a hydrogen atom, R⁶ or R⁷ may form together with E¹ or L¹ a bond.

When X⁵ is —CR⁶═ or —NR⁷—, and R⁶ or R⁷ thereof is a group other than a hydrogen atom, R⁶ or R⁷ may form together with E¹ or L¹ a bond.

When c is an integer of 1 to 3 and in the molecule, exists, each combination of the combination of E¹ and L¹ and the combination of L¹ and L¹ may form together with each other a bond.

Next, specific examples (from Formula 1001 to Formula 1017) of the compound of Formula (1) are shown as follows. Here, ^{t}Bu refers to a tert-butyl group, Me refers to a methyl group, and ⁱPr refers to an isopropyl group.

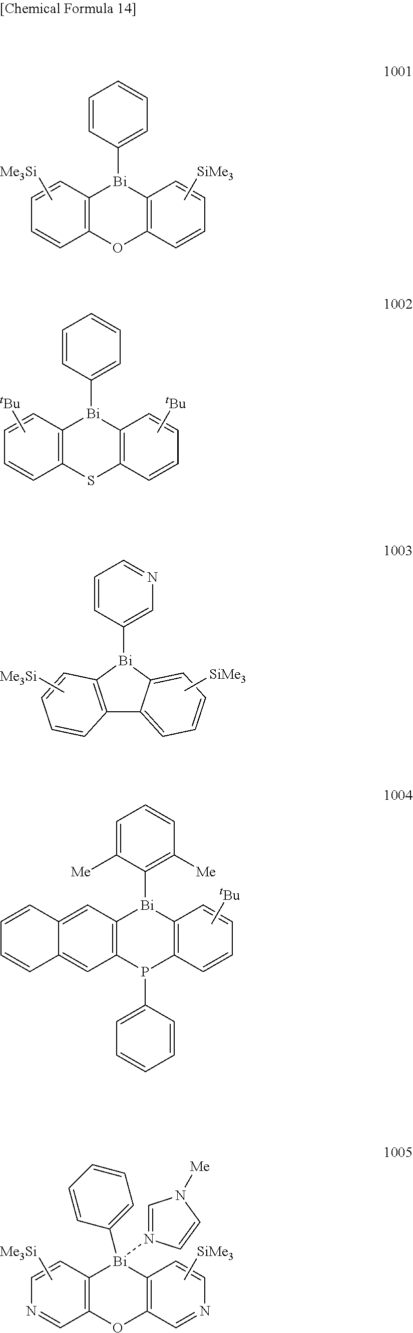

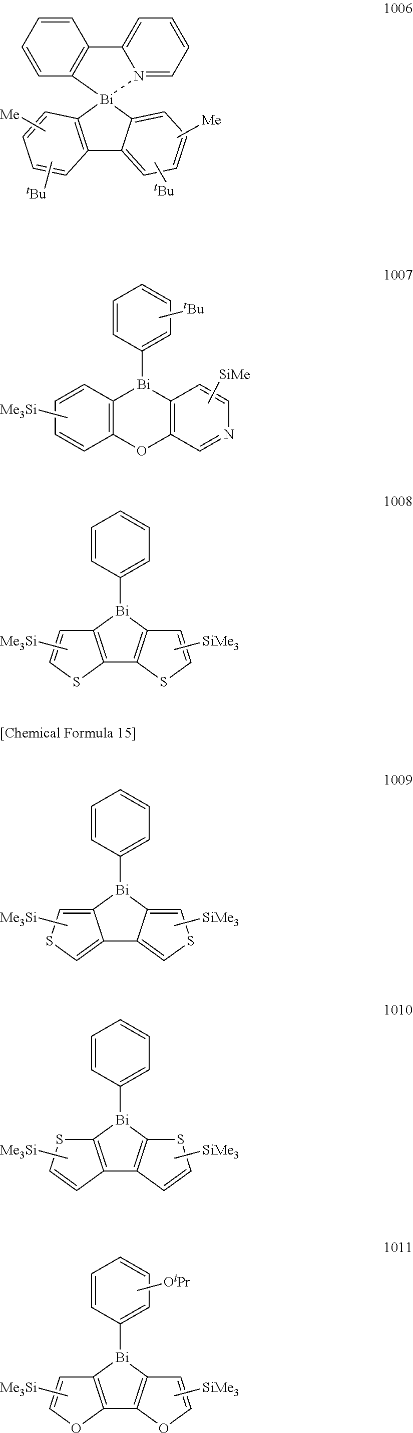

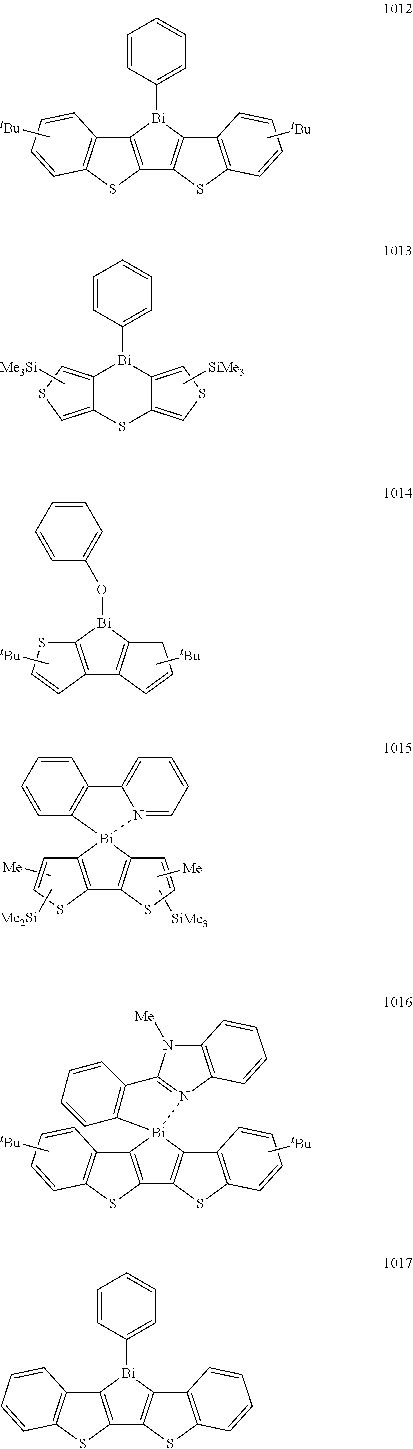

In the thin film of the present invention, a compound in which a residue of the above bismuth compounds is incorporated in the molecule thereof can be preferably used. Examples of the molecule in which a residue of the above bismuth compounds is incorporated may include organic compounds used as the charge transport material described below. Furthermore, among the organic compounds used as the charge transport material, a conjugated organic compound is preferred because a conjugation spreads and a carrier (electron or hole) mobility becomes higher.

When the above bismuth compound is contained in the organic compound, examples of the compound having a structure of the organic compound and a residue of the bismuth compound in the same molecule may include:

1. a compound containing a constitutional unit having a residue of the bismuth compound in the main chain of the organic compound;

2. a compound containing a constitutional unit having a residue of the bismuth compound in a substituent (side chain) on the main chain of the organic compound; and

3. a compound containing a constitutional unit having a residue of the bismuth compound in a terminal of the main chain of the organic compound. Examples of the compound in which a constitutional unit having a residue of the bismuth compound is contained in the main chain thereof include besides a compound in which the bismuth compound is incorporated in the main chain of a linear molecule, a compound in which three or more molecular chains are bonded to a residue of the bismuth compound.

As one preferred embodiment of the compound in which a residue of the bismuth compound is incorporated in the molecule thereof, there can be mentioned a compound containing a constitutional unit composed of a structure in which one or two or more hydrogen atom(s) is(are) removed from the compound of Formula (1). Preferably, the compound of Formula (1) is the compound of Formula (2). Further preferably, the compound of Formula (1) is the compound of Formula (3). As another preferred embodiment, there can be mentioned a compound containing as the constitutional unit composed of a structure in which one or two or more hydrogen atom(s) is(are) removed from the compound of Formula (1), a constitutional unit of any of Formula (4), Formula (5), and Formula (6) below. The compound in which a residue of the bismuth compound is incorporated in the molecule thereof may be a low molecular weight compound or a high molecular compound. The high molecular compound may be any one of a copolymer, a block copolymer, and a graft copolymer.

Examples of the compound in which a residue of the bismuth compound is incorporated in the molecule thereof may include a compound containing a residue of the bismuth compound, having a number average molecular weight in terms of polystyrene of 10³ to 10⁷, and having a residue of the bismuth compound in the main chain thereof, a substituent on the main chain, or a terminal of the main chain. In the present specification, the “residue of the bismuth compound” means a monovalent to hexavalent group remaining after subtracting one to six hydrogen atom(s) from the bismuth compound.

In addition, examples of the embodiment of the compound containing the constitutional unit having a residue of the bismuth compound in the main chain of the organic compound may include a compound containing a constitutional unit of

### Formula (11):

[Chemical Formula 16]

-(M¹)-(F¹) (11)

In Formula (11), M¹ is a residue of the bismuth compound, and F¹ is a constitutional unit other than the residue of the bismuth compound in the structure and is an optional component, so that F¹ may exist or not exist in the structure, however, preferably is contained in the structure at least in an amount of one unit. The constitutional unit of Formula (11) may be a repeating unit appearing repeatedly in the same molecule. As the repeating unit, one repeating unit may be discontinuously contained or repeating units may continuously form a block. When M¹ exists in plurality in the structure, Des may be different from each other. When F¹ exists in plurality in the structure, F¹s may be different from each other.

M¹ is, for example, a group of Formula (4):

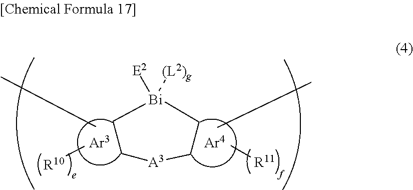

E² is the same as defined as E¹ in Formula (1) and specific examples and preferred examples of E² are the same as those of E¹. L² is the same as defined as L¹ in Formula (1) and specific examples and preferred examples of L² are the same as those of L¹. A³ is the same as defined as A¹ in Formula (1) and specific examples and preferred examples of A³ are the same as those of A¹.

R¹⁰ and R¹¹ are independently a substituent. Examples of R¹⁰ and R¹¹ independently may include a hydrocarbyl group that may be substituted, a hydrocarbyloxy group that may be substituted, a hydrocarbylthio group that may be substituted, a heterocyclyl group that may be substituted, a halogen atom, a cyano group, an acylamino group that may be substituted, an imino group that may be substituted, a silyl group that may be substituted, an acyl group that may be substituted, a hydrocarbyloxycarbonyl group that may be substituted, a hydrocarbyloxysulfonyl group that may be substituted, a hydrocarbyloxyphosphoryl group that may be substituted, a phosphino group that may be substituted, a phosphine oxide group that may be substituted, an amino group that may be substituted, a hydroxy group, a mercapto group, a carboxy group, a sulfo group, a phosphoric acid group, a phosphonic acid group, and a nitro group. Among them, as R¹⁰ and R¹¹, preferred are a hydrocarbyl group that may be substituted, a hydrocarbyloxy group that may be substituted, a halogen atom, a cyano group, a silyl group that may be substituted, a hydrocarbyloxysulfonyl group that may be substituted, a hydrocarbyloxyphosphoryl group that may be substituted, a phosphino group that may be substituted, a phosphine oxide group that may be substituted, an amino group that may be substituted, a hydroxy group, a carboxy group, a sulfo group, a phosphoric acid group, a phosphonic acid group, and a nitro group; more preferred are a hydrocarbyl group that may be substituted, a hydrocarbyloxy group that may be substituted, a cyano group, a silyl group that may be substituted, an amino group that may be substituted, a hydroxy group, a carboxy group, a sulfo group, a phosphoric acid group, and a nitro group; further preferred are a hydrocarbyl group that may be substituted, a hydrocarbyloxy group that may be substituted, a silyl group that may be substituted, and an amino group that may be substituted; and particularly preferred are a hydrocarbyl group that may be substituted and a hydrocarbyloxy group that may be substituted. Details of the hydrocarbyl groups and the like included in the specific examples and the preferred examples of R¹⁰ and R¹¹ are the same as the groups and the atoms corresponding to the groups and the atoms in the above descriptions with respect to R¹ and R² in Formula (1).

In Formula (4), g is an integer of 0 to 3, preferably an integer of 0 to 2, more preferably an integer of 0 or 1, and further preferably 0.

In Formula (4), e and f are independently an integer of 0 to 11 and from the viewpoint of the stability of the compound, e and f are preferably an integer of 0 to 8, more preferably an integer of 0 to 6, further preferably an integer of 0 to 4, particularly preferably an integer of 0 to 2, and most preferably 1. When e is 2 or more, R¹⁰s may be different from each other and two R¹⁰s may be bonded with each other to form a ring structure. When f is 2 or more, R¹¹s may be different from each other and two R¹¹s may be bonded with each other to form a ring structure.

Ar³ and Ar⁴ are independently a C₃₋₃₀ aromatic ring, preferably a C₃₋₂₀ aromatic ring, more preferably a C₃₋₄₀ aromatic ring, and further preferably a C₄₋₆ aromatic ring.

As the specific structure of Ar³ and Ar⁴, for example, the structure of Ar³ is a ring remaining after subtracting (3+e) hydrogen atoms from any one of the rings of Formula Ar-1 to Formula Ar-41 below and the structure of Ar⁴ is a ring remaining after subtracting (3+f) hydrogen atoms from any one of the rings of Formula Ar-1 to Formula Ar-41 below. Among them, preferred rings are rings of Formula Ar-1, Formula Ar-2, Formula Ar-6 to Formula Ar-8, Formula Ar-14, and Formula Ar-22 to Formula Ar-24, more preferred rings are rings of Formula Ar-1, Formula Ar-6 to Formula Ar-8, and Formula Ar-22 to Formula Ar-24, and further preferred rings are rings of Formula Ar-1, Formula Ar-7, and Formula Ar-24.

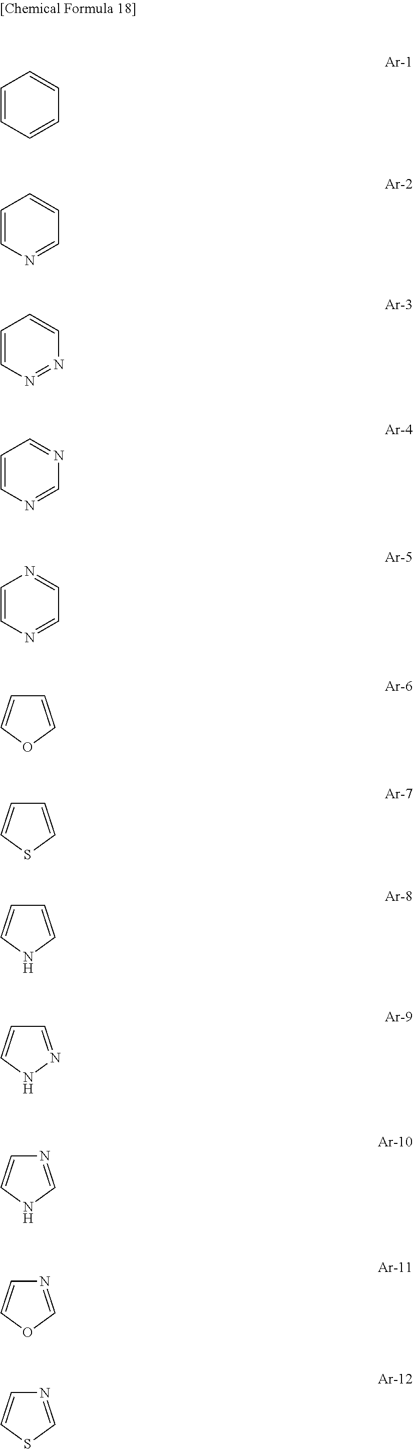

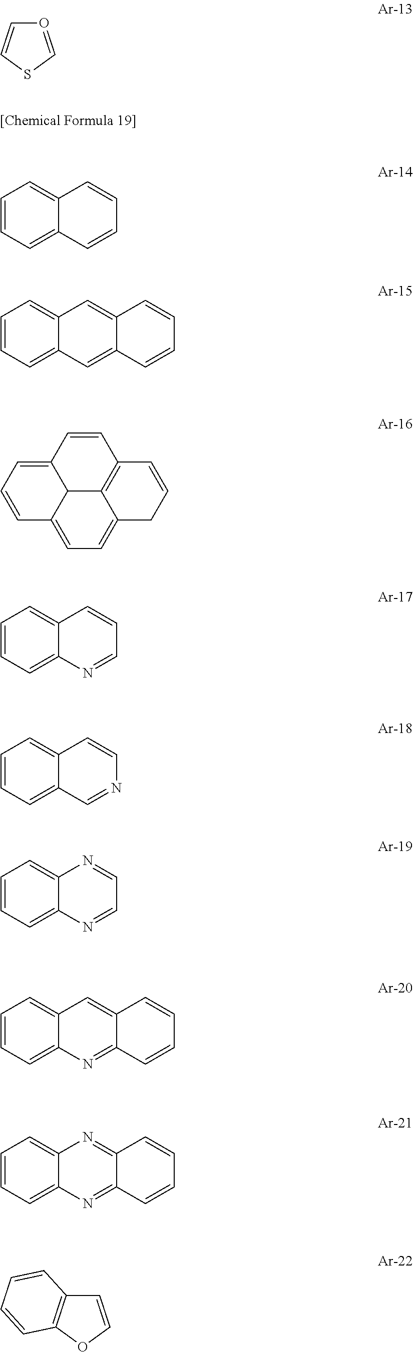

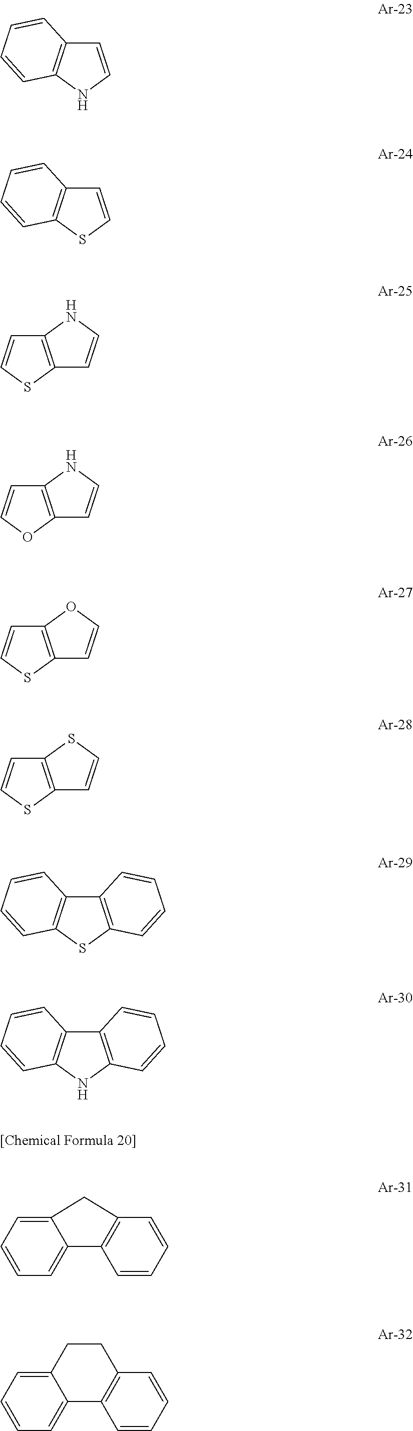

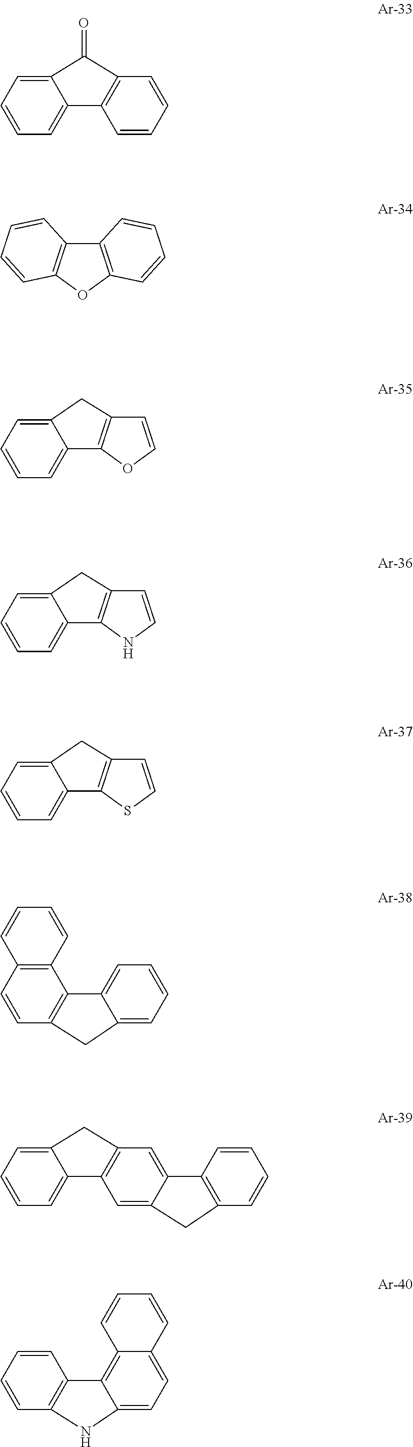

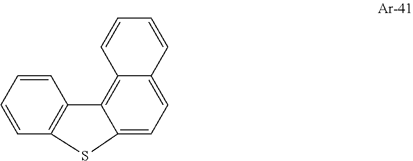 [SMILES: c1ccc2c(c1)ccc1sc3ccccc3c12]

In Formula (4), when g is 0, there may be formed a bond between the combination of E² and Ar³ and the combination of E² and Ar⁴. When g is 1, there may be formed a bond between the combination of E² and L⁴, the combination of E² and Ar³, the combination of E⁴ and Ar⁴, the combination of L² and Ar³, and the combination of L² and Ar⁴. When g is an integer of 2 or more, there may be formed a bond between the combination of E² and L⁴, the combination of E² and Ar³, the combination of E² and Ar⁴, the combination of L² and Ar³, the combination of L² and Ar⁴, and the combination of L² and L².

Examples of the preferred embodiment of the group of Formula (4) may include a group of Formula (5):

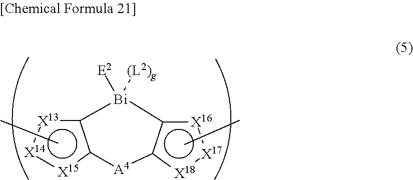

A⁴ is the same as defined as A² in Formula (2) and specific examples and preferred examples of A⁴ are also the same as those of A². E², L², and g are the same as defined above.

Two of X¹³, X¹⁴, and X¹⁵ are —CR¹⁵═ and remaining one thereof is —S—, —O—, or —NR¹⁶—. Two of X¹⁶, X¹⁷, and X¹⁸ are —CR¹⁵═ and remaining one thereof is —S—, —O—, or —NR¹⁶—. When X¹³, X¹⁴, X¹⁵, X¹⁶, X¹⁷, and X¹⁸ are a group other than —CR¹⁵═, preferably at least one is —S—, more preferably both are —S—.

R¹⁵ is the same as defined as R⁶ in Formula (4) and specific examples and preferred examples of R¹⁵ are also the same as those of R⁶.

R¹⁶ is the same as defined as R⁷ in Formula (4) and specific examples and preferred examples of R¹⁶ are also the same as those of R⁷.

When a plurality of R¹⁵s are a group other than a hydrogen atom and they are adjacent to each other, R¹⁵s may form together with each other a bond. For examples, when both of two R¹⁵s in two —CR¹⁵-s among X¹³, X¹⁴, and X¹⁵ are a group other than a hydrogen atom and they are adjacent to each other, R¹⁵s may form a bond. When both of two R¹⁵s in two —CR¹⁵-s among X¹⁶, X¹⁷, and X¹⁸ are a group other than a hydrogen atom and they are adjacent to each other, R¹⁵s may form a bond. Preferred examples of the form in which two R¹⁵s are adjacent to each other may include a form in which X¹³ and X¹⁴ are —CR¹⁵═, a form in which X¹⁴ and X¹⁵ are —CR¹⁵═, a form in which X¹⁶ and X¹⁷ are —CR¹⁵═, and a form in which X¹⁷ and X¹⁸ are —CR¹⁵═.

When R¹⁵ and R¹⁶ are a group other than a hydrogen atom and they are adjacent to each other, R¹⁵ and R¹⁶ may form together with each other a bond. For example, when R¹⁵ and R¹⁶ contained in X¹³, X¹⁴, and X¹⁵ are a group other than a hydrogen atom and they are adjacent to each other, R¹⁵ and R¹⁶ may form together with each other a bond. When R¹⁵ and R¹⁶ contained in X¹⁶, X¹⁷, and X¹⁸ are a group other than a hydrogen atom and they are adjacent to each other, R¹⁵ and R¹⁶ may form together with each other a bond. Preferred examples of the form in which R¹⁵ and R¹⁶ are adjacent to each other may include a form in which at least any one of X¹³ and X¹⁴ is —CR¹⁵═ and another thereof is —NR¹⁶—, a form in which at least any one of X¹⁴ and X¹⁵ is —CR¹⁵═ and another thereof is —NR¹⁶—, a form in which at least any one of X¹⁶ and X¹⁷ is —CR¹⁵═ and another thereof is —NR¹⁶, and a form in which at least any one of X¹⁷ and X¹⁸ is —CR¹⁵═ and another thereof is —NR¹⁶—.

In the group of Formula (5), one hydrogen atom contained in the structure of X¹³, X¹⁴, or X¹⁵ and one hydrogen atom contained in the structure of X¹⁶, X¹⁷, or X¹⁸ are eliminated, so that the group of Formula (5) is a divalent group.

When X¹³ is —CR¹⁵═ or —NR¹⁶— and R¹⁵ or R¹⁶ thereof is a group other than a hydrogen atom, R¹⁶ or R¹⁷ may form together with E² or L² a bond.

When X¹⁴ is —CR¹⁵═ or —NR¹⁶— and R¹⁵ or R¹⁶ thereof is a group other than a hydrogen atom, R¹⁶ or R¹⁷ may form together with E² or L² a bond.

When X¹⁶ is —CR¹⁵═ or —NR¹⁶— and R¹⁵ or R¹⁶ thereof is a group other than a hydrogen atom, R¹⁶ or R¹⁷ may form together with E² or L² a bond.

When X¹⁷ is —CR¹⁵═ or —NR¹⁶— and R¹⁵ or R¹⁶ thereof is a group other than a hydrogen atom, R¹⁶ or R¹⁷ may form together with E² or L² a bond.

When c is an integer of 1 to 3 and in the molecule, L² exists, the combination of E² and L² and the combination of L¹ and L¹ may form together with each other a bond.

Next, specific examples (Formula 3001 to Formula 3017) of the structure of M¹ are shown as follows. Here, ^{t}Bu is a tert-butyl group, Me is a methyl group, and ⁱPr is an isopropyl group.

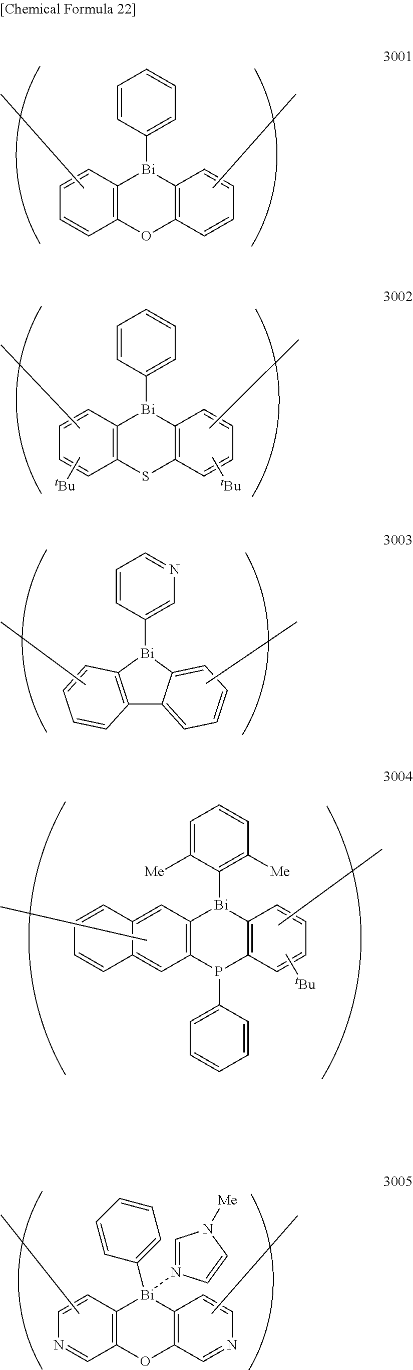

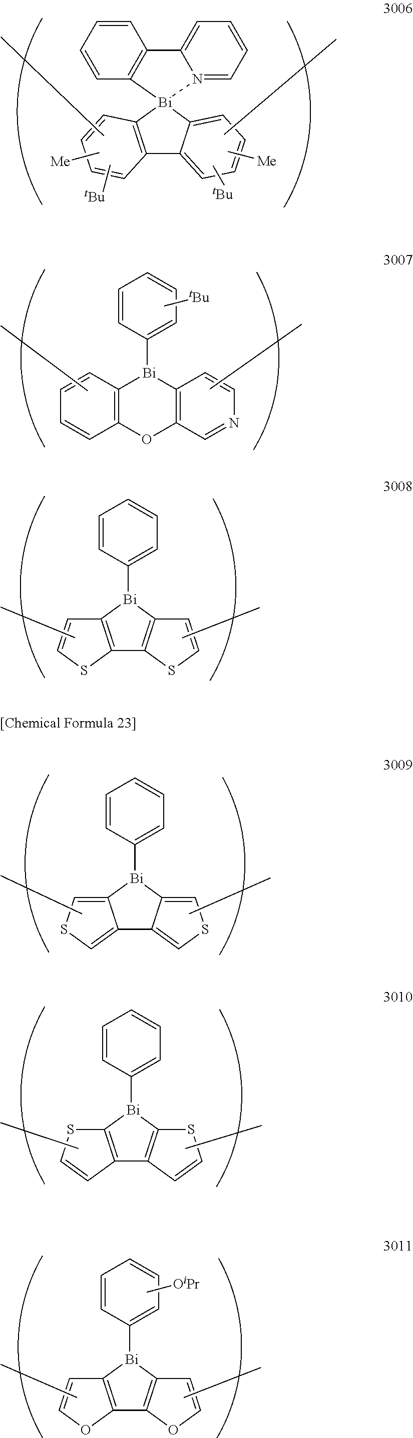

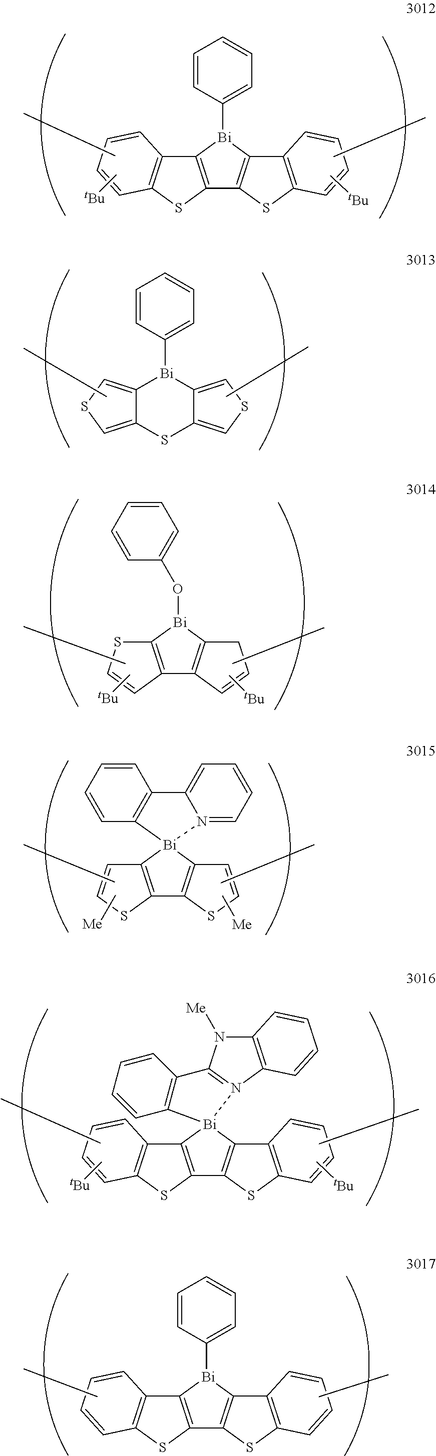

F¹ in Formula (11) is, for example, a divalent hydrocarbyl group that may have a substituent, a divalent heterocyclyl group that may have a substituent, or a divalent aromatic amine residue that may have a substituent and these groups preferably have an aromatic ring.

The divalent hydrocarbyl group as F¹ may be, for example, an atomic group remaining after subtracting two hydrogen atoms from an aromatic compound and examples thereof also may include a group having a condensed ring and a group in which two or more independent benzene rings or condensed rings are bonded with each other either directly or through a vinylene group or the like.

The divalent heterocyclyl group as F¹ refers to an atomic group remaining after subtracting two hydrogen atoms from a heterocyclic compound. The heterocyclic compound refers to, among the organic compounds having a cyclic structure, a cyclic compound having as an element constituting the ring, not only a carbon atom, but also one or more type(s) of atom(s) selected from the group consisting of an oxygen atom, a nitrogen atom, a silicon atom, a germanium atom, a tin atom, a phosphorus atom, a boron atom, a sulfur atom, a selenium atom, and a tellurium atom. Among the divalent heterocyclyl groups, preferred is an aromatic heterocyclyl group. The number of carbon atoms of a moiety of the divalent heterocyclyl group in which substituents are removed is usually 3 to 60. The total number of carbon atoms of the divalent heterocyclyl group containing substituents is usually 3 to 100.

The divalent aromatic amine residue refers to an atomic group remaining after subtracting two hydrogen atoms from an aromatic amine. The number of carbon atoms of the divalent aromatic amine group is usually 5 to 100, preferably 15 to 60. Here, in the number of carbon atoms of the divalent aromatic amine residue, the number of carbon atoms of substituents is not included.

Examples of the compound containing a constitutional unit having as a substituent on the main chain of the organic compound, a residue of the bismuth compound may include a compound of Formula (12):

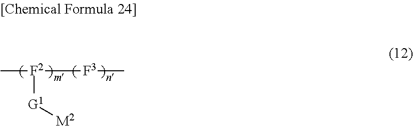

In Formula (12), M² is a residue of the bismuth compound and F² and F³ are a constitutional unit other than the residue of the bismuth compound in the structure. F³ is an optional group and may exist or not exist in the structure. These constitutional units may be a repeating unit appearing repeatedly in the same molecule. As the repeating unit, one repeating unit may be discontinuously contained or repeating units may continuously form a block. When M² exists in a plurality in the structure, M²s may be different from each other. When F² exists in plurality in the structure, F²s may be different from each other. When F³ exists in plurality in the structure, F³s may be different from each other. When G¹ exists in plurality in the structure, G¹s may be different from each other. m′ is an integer of 1 or more and n′ is an integer of 0 or more.

The compound having a residue of the bismuth compound in a terminal of the main chain of the organic compound is, for example, a compound of Formula (13):

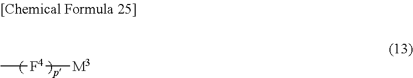

In Formula (13), M³ is a residue of the bismuth compound and F⁴ is a constitutional unit other than the residue of the bismuth compound in the structure. The constitutional unit may be repeated in plurality to form a repeating unit. When M³ exists in plurality in the structure, M³s may be different from each other. When F⁴ exists in plurality in the structure, F⁴s may be different from each other. p′ is an integer of 1 or more.

M² and M³ are independently a structure of Formula (6) or Formula (7):

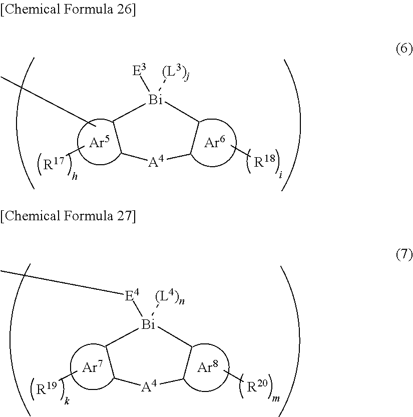

Ar⁵, Ar⁶, Ar⁷, and Ar⁸ are independently a C₂₋₃₀ aromatic ring. Ar⁵ is the same as defined as Ar³ in Formula (4) and specific examples and preferred examples of Ar⁵ are the same as those of Ar³. Ar⁷ is the same as defined as Ar¹ in Formula (1) and specific examples and preferred examples of Ar⁷ are the same as those of Ar¹. Ar⁶ is the same as defined as Ar² in Formula (1) and specific examples and preferred examples of Ar⁶ are the same as those of Ar². Ar⁸ is the same as defined as Ar² in Formula (1) and specific examples and preferred examples of Ar⁸ are the same as those of Ar².

R¹⁷ is the same as defined as R¹⁰ in Formula (4) and specific examples and preferred examples of R¹⁷ are the same as those of R¹⁰. R¹⁹ is the same as defined as R¹ in Formula (1) and specific examples and preferred examples of R¹⁹ are the same as those of R¹. R¹⁸ is the same as defined as R² in Formula (1) and specific examples and preferred examples of R¹⁸ are the same as those of R². R²⁰ is the same as defined as R² in Formula (1) and specific examples and preferred examples of R²⁰ are the same as those of R².

h in Formula (6) is an integer of 0 to 11, preferably an integer of 0 to 8, more preferably an integer of 0 to 6, further preferably an integer of 0 to 4, and particularly preferably an integer of 0 to 2. When h is 2 or more, R¹⁷s may be different from each other and two R¹⁷s may be bonded with each other to form a ring structure. i, k, and m are independently an integer of 0 to 12, preferably an integer of 0 to 8, more preferably an integer of 0 to 6, further preferably an integer of 1 to 4, and particularly preferably an integer of 1 to 2. When i is 2 or more, R¹⁸s may be different from each other and two R¹⁸s may be bonded with each other to form a ring structure. When k is 2 or more, R¹⁹s may be different from each other and two R¹⁹s may be bonded with each other to form a ring structure. When m is 2 or more, R²⁰s may be different from each other and two R²⁰s may be bonded with each other to form a ring structure.

A⁴ is the same as defined as A¹ in Formula (1) and specific examples and preferred examples of A⁴ are the same as those of A¹.

E³ is the same as defined as E¹ in Formula (1) and specific examples and preferred examples of E³ are the same as those of E¹. L³ is the same as defined as L¹ in Formula (1) and specific examples and preferred examples of L³ are the same as those of L¹. L⁴ is the same as defined as L¹ in Formula (1) and specific examples and preferred examples of L⁴ are the same as those of L¹.

E⁴ is a divalent group having 50 or less carbon atoms. Examples of E⁴ may include a hydrocarbylene group that may be substituted, a hydrocarbyleneoxy group that may be substituted, a hydrocarbylenethio group that may be substituted, and a heterocyclylene group that may be substituted. Among them, as E⁴, preferred are a hydrocarbylene group that may be substituted and a heterocyclylene group that may be substituted, and more preferred is a hydrocarbylene group that may be substituted. When E⁴ is a group containing no aromatic ring, E⁴ is a C₁₋₅₀ group, preferably a C₁₋₃₀ group, more preferably a C₁₋₂₀ group, further preferably a C₁₋₁₀ group, and particularly preferably a C₁₋₅ group. When E⁴ is a group containing an aromatic ring, E⁴ is a C₂₋₅₀ group, preferably a C₃₋₃₀ group, more preferably a C₄₋₂₀ group, further preferably a C₄₋₁₀ group, and particularly preferably a C₅₋₆ group.

Examples of the hydrocarbylene group (that is, a divalent hydrocarbyl group) as E⁴ may include a methylene group, an ethylene group, a phenylenemethylene group, a phenyleneethylene group, a vinylene group, a propenylene group, a butenylene group, a phenylene group, a biphenylylene group, a terphenylylene group, a fluorenylene group, a naphthylene group, an anthrylene group, a phenanthrylene group, a naphthacenylene group, a pyrenylene group, a chrysenylene group, a benzo[c]phenanthrylene group, a benzo[g]chrysenylene group, a benzofluorenylene group, and a dibenzofluorenylene group. Among them, as the hydrocarbylene group as E⁴, preferred are a phenylene group, a fluorenylene group, a naphthylene group, an anthrylene group, a benzofluorenylene group, and a dibenzofluorenylene group; and more preferred is a phenylene group.

Examples of the hydrocarbyleneoxy group (that is, the divalent hydrocarbyloxy group) as E⁴ may include a methyleneoxy group, an ethyleneoxy group, a phenylenemethyleneoxy group, a phenyleneethyleneoxy group, a phenyleneoxy group, a biphenylyleneoxy group, a terphenylyleneoxy group, a fluorenyleneoxy group, a naphthyleneoxy group, an anthryleneoxy group, a phenanthryleneoxy group, a naphthacenyleneoxy group, a pyrenyleneoxy group, a chrysenyleneoxy group, benzo[c]phenanthryleneoxy group, a benzo[g]chrysenyleneoxy group, a benzofluorenyleneoxy group, and a dibenzofluorenyleneoxy group. Among them, as the hydrocarbyleneoxy group as E⁴, preferred are a phenyleneoxy group, a fluorenyleneoxy group, a naphthyleneoxy group, an anthryleneoxy group, a benzofluorenyleneoxy group, and a dibenzofluorenyleneoxy group; and more preferred is a phenyleneoxy group.

Examples of the hydrocarbylenethio group (that is, the divalent hydrocarbylthio group) as E⁴ may include a methylenethio group, an ethylenethio group, a phenylenemethylenethio group, a phenyleneethylenethio group, a phenylenethio group, a biphenylylenethio group, a terphenylylenethio group, a fluorenylenethio group, a naphthylenethio group, an anthrylenethio group, a phenanthrylenethib group, a naphthacenylenethio group, pyrenylenethio group, a chrysenylenethio group, a benzo[c]phenanthrylenethio group, a benzo[g]chrysenylenethio group, a benzofluorenylenethio group, and a dibenzofluorenylenethio group. Among them, as the hydrocarbylenethio group as E⁴, preferred are a phenylenethio group, a fluorenylenethio group, a naphthylenethio group, an anthrylenethio group, a benzofluorenylenethio group, and a dibenzofluorenylenethio group; and more preferred is a phenylenethio group.

The heterocyclylene group (that is, the divalent heterocyclyl group) as E⁴ refers to a divalent group derived from a heterocyclic ring by removing two hydrogen atoms from a heterocyclic ring, and examples thereof may include groups remaining after removing two hydrogen atoms from, for example, heterocyclic rings below. Examples of the heterocyclic ring may include piperidine, piperazine, morpholine, thiophene, furan, imidazole, pyrazole, pyridine, pyrazine, pyridazine, pyrimidine, triazole, triazine, indole, indazole, purine, thiazole, thiadiazole, oxazole, oxadiazole, quinoline, isoquinoline, phthalazine, naphthyridine, quinoxaline, quinazoline, cinnoline, pteridine, acridine, phenanthroline, phenazine, tetrazole, benzimidazole, benzoxazole, benzothiazole, benzotriazole, tetraazaindene, and carbazole. Among them, as the heterocyclic ring, preferred are imidazole, pyrazole, pyridine, pyrazine, pyridazine, pyrimidine, triazole, triazine, indole, indazole, thiazole, thiadiazole, oxazole, oxadiazole, quinoline, benzimidazole, benzoxazole, and benzothiazole; more preferred are imidazole, pyrazole, pyridine, triazine, thiazole, oxazole, quinoline, and benzimidazole; further preferred are imidazole, pyrazole, pyridine, thiazole, and oxazole; and particularly preferred is pyridine.

j in Formula (6) and n in Formula (7) are independently an integer of 0 to 3, preferably an integer of 0 to 2, more preferably 0 or 1, and further preferably 0.

When j is 0, between the combination of E³ and Ar⁵ and the combination of E³ and Ar⁶, a bond may be formed. When j is 1, between the combination of E³ and L³, the combination of E³ and Ar⁵, the combination of E³ and Ar⁶, the combination of L³ and Ar⁵, and the combination of L³ and Ar⁶, a bond may be formed. When j is an integer of 2 or more, between the combination of E³ and L³, the combination of E³ and Ar⁵, the combination of E³ and Ar⁶, the combination of L³ and Ar⁵, the combination of L³ and Ar⁶, and the combination of L³ and L³, a bond may be formed.

When n is 0, between the combination of E⁴ and Ar⁷ and the combination of E⁴ and Ar⁸, a bond may be formed. When n is 1, between the combination of E⁴ and L⁴, the combination of E⁴ and Ar⁷, the combination of E⁴ and Ar⁸, the combination of L⁴ and Ar⁷, and the combination of L⁴ and Ar⁸, a bond may be formed. When n is an integer of 2 or more, between the combination of E⁴ and L⁴, the combination of E⁴ and Ar⁷, the combination of E⁴ and Ar⁸, the combination of L⁴ and Ar⁷, the combination of L⁴ and Ar⁸, and the combination of L⁴ and L⁴, a bond may be formed.

Next, specific examples (Formula 4001 to Formula 4017 and Formula 5001 to Formula 5017) of the structure of M² and M³ are shown as follows. Here, ^{t}Bu is a tert-butyl group, Me is a methyl group, and ⁱPr is an isopropyl group.

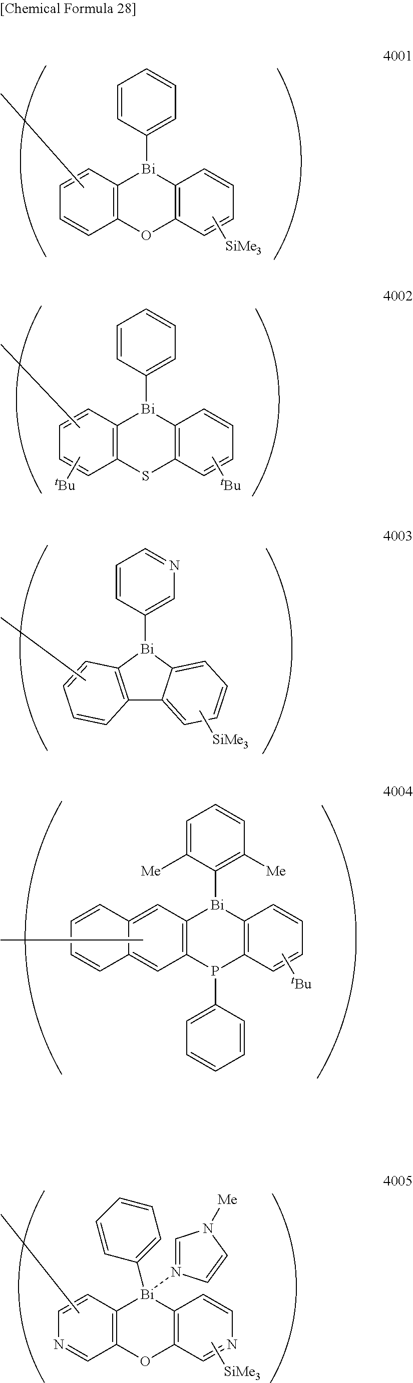

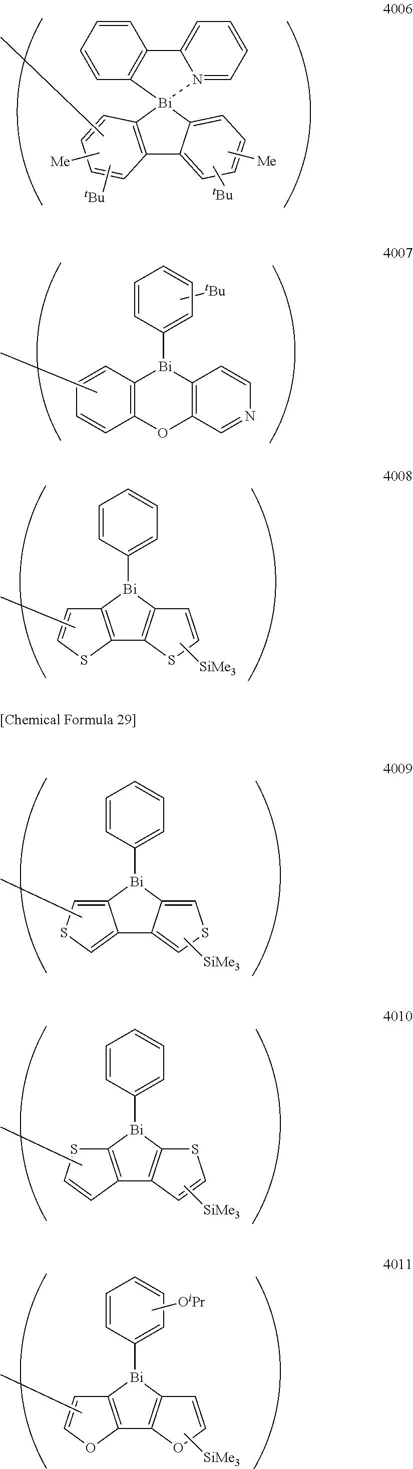

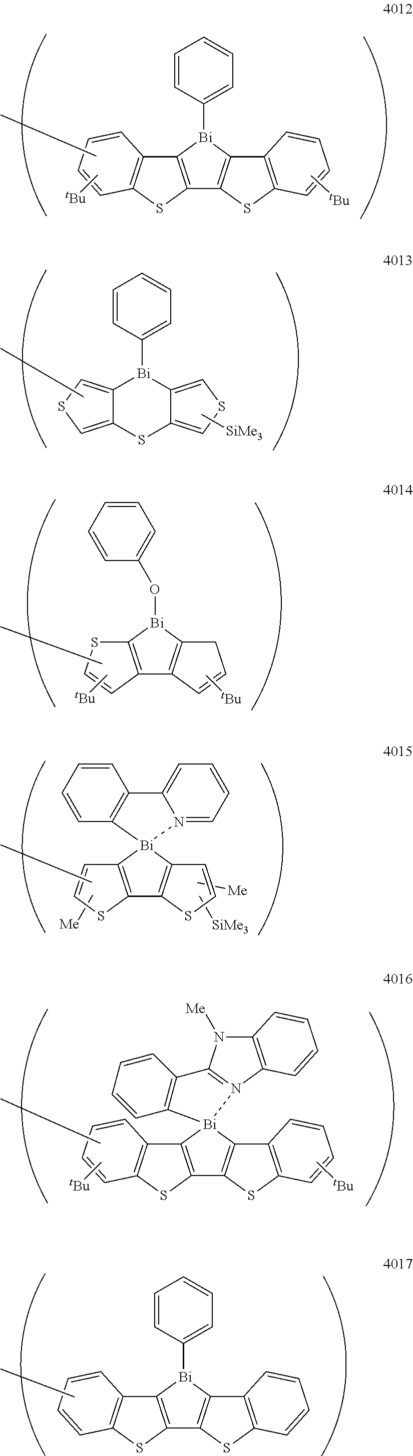

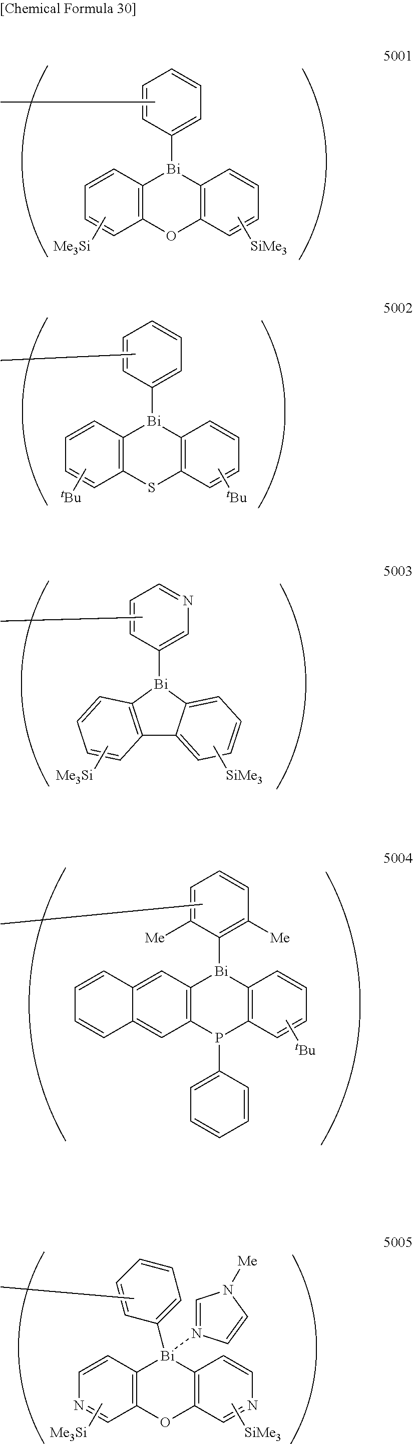

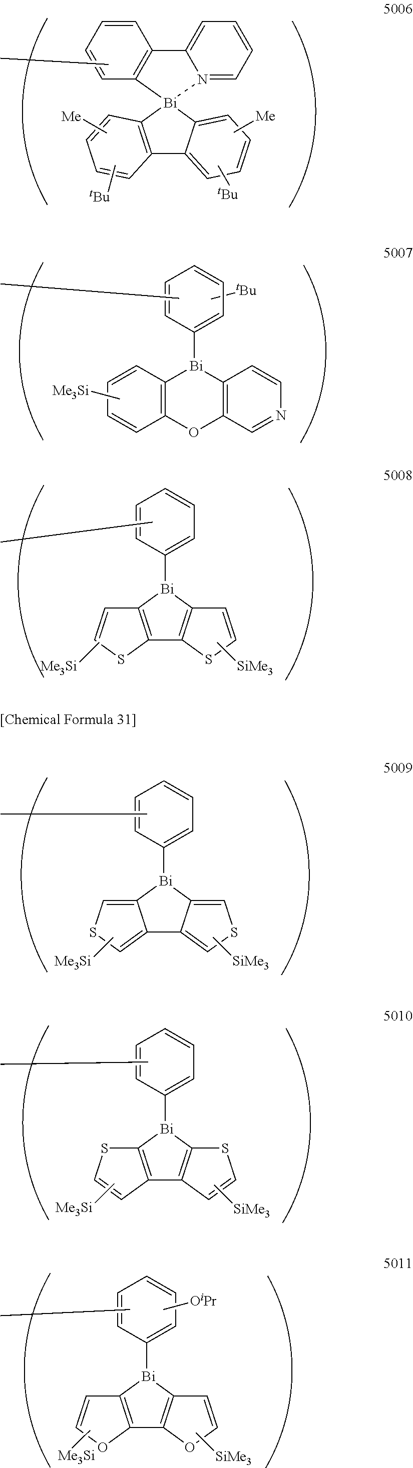

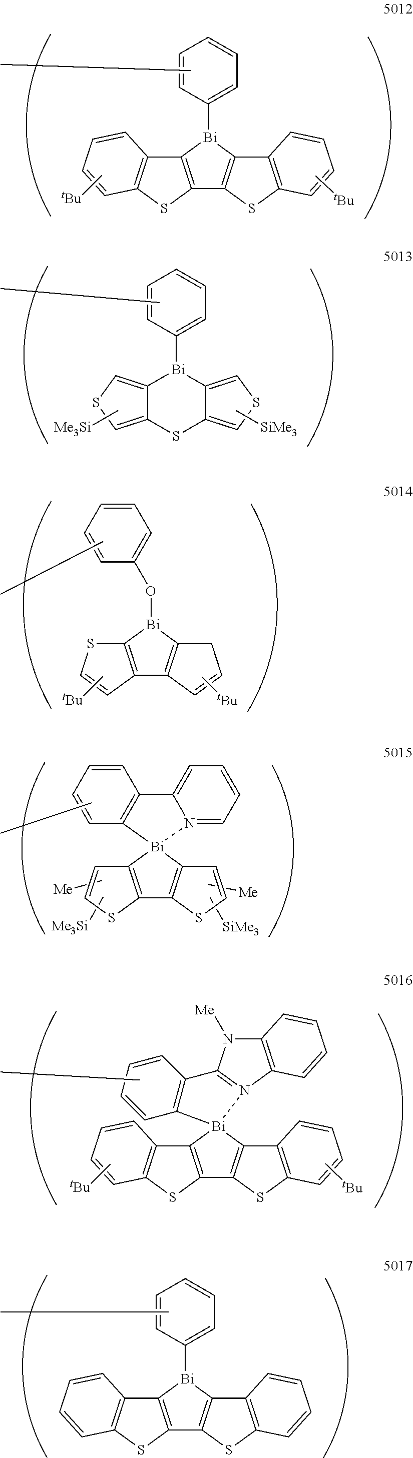

G¹ in Formula (12) is direct bond, —O—, —S—, —CO—, —CO₂—, —SO—, —SO₂—, —Si('R¹⁶)₂—, NR¹⁷—, —BR¹⁸—, —PR¹⁹—, —P(═O)(—R²⁰)—, an alkylene group that may be substituted, an alkenylene group that may be substituted, an alkynylene group that may be substituted, an arylene group that may be substituted, or a divalent heterocyclyl group that may be substituted, and when the alkylene group, the alkenylene group, or the alkynylene group contains a —CH₂— group, one or more —CH₂— group(s) contained in the alkylene group, one or more —CH₂— group(s) contained in the alkenylene group, or one or more —CH₂— group(s) contained in the alkynylene group may be replaced with a group selected from the group consisting of —O—, —S—, —CO—, —CO₂—, —SO—, —SO₂—, —Si(—R¹⁶)₂—, NR¹⁷—, —BR¹⁸—, —PR¹⁹—, and —P(═O)(—R²⁰)—. R¹⁶, R¹⁷, R¹⁸, R¹⁹, and R²⁰ are independently a group selected from the group consisting of a hydrogen atom, a hydrocarbyl group that may be substituted, a heterocyclyl group that may be substituted, and a cyano group and two R¹⁶s may be different from each other. The hydrocarbyl group and the heterocyclyl group are the same as defined as the corresponding groups as E¹ in Formula (1), and specific examples and preferred examples thereof are the same as those of the corresponding groups.

F² in Formula (12) is a trivalent hydrocarbyl group that may have a substituent, a trivalent heterocyclyl group that may have a substituent, a trivalent aromatic amine residue that may have a substituent, or the like and these groups preferably have an aromatic ring.

The trivalent hydrocarbyl group as F² is, for example, an atomic group remaining after removing three hydrogen atoms from an aromatic compound and examples thereof may include a group having a condensed ring and a group in which two or more independent benzene rings or condensed rings are bonded with each other either directly or through a vinylene group or the like.

The trivalent heterocyclyl group as F² refers to an atomic group remaining after removing three hydrogen atoms from a heterocyclic compound. The heterocyclic compound refers to, among the organic compounds having a cyclic structure, a cyclic compound having as an element constituting the ring, not only a carbon atom, but also one or more type(s) of atom(s) selected from the group consisting of an oxygen atom, a nitrogen atom, a silicon atom, a germanium atom, a tin atom, a phosphorus atom, a boron atom, a sulfur atom, a selenium atom, and a tellurium atom. Among the trivalent heterocyclyl groups, preferred is an aromatic heterocyclyl group. The number of carbon atoms of a moiety remaining after removing substituents from the trivalent heterocyclyl group is usually 3 to around 60. The total number of carbon atoms of the trivalent heterocyclyl group containing substituents is usually 3 to around 100.

The trivalent aromatic amine residue as F² refers to an atomic group remaining after removing three hydrogen atoms from an aromatic amine. The number of carbon atoms of the trivalent aromatic amine residue is usually 5 to around 100, preferably 15 to 60. Here, in the number of carbon atoms of the trivalent aromatic amine residue, the number of carbon atoms of the substituents is not included.

Preferably, F³ of Formula (12) and F⁴ of Formula (13) are individually a divalent hydrocarbyl group that may have a substituent, a divalent heterocyclyl group that may have a substituent, or a divalent aromatic amine residue that may have a substituent and these groups have preferably an aromatic ring.

The divalent hydrocarbyl group as F³ and F⁴ is, for example, an atomic group remaining after removing two hydrogen atoms from an aromatic compound and examples thereof may include a group having a condensed ring and a group in which two or more independent benzene rings or condensed rings are bonded with each other either directly or through a vinylene group or the like.

The divalent heterocyclyl group as F³ and F⁴ refers to an atomic group remaining after removing two hydrogen atoms from a heterocyclic compound. The heterocyclic compound refers to, among the organic compounds having a cyclic structure, a cyclic compound having as an element constituting the ring, not only a carbon atom, but also one or more type(s) of atom(s) selected from the group consisting of an oxygen atom, a nitrogen atom, a silicon atom, a germanium atom, a tin atom, a phosphorus atom, a boron atom, a sulfur atom, a selenium atom, and a tellurium atom. Among the divalent heterocyclyl groups, preferred is an aromatic heterocyclyl group. The number of carbon atoms of a moiety remaining after removing substituents from the divalent heterocyclyl group is usually 3 to around 60. The total number of carbon atoms of the divalent heterocyclyl group containing substituents is usually 3 to around 100.

The divalent aromatic amine residue as F³ and F⁴ refers to an atomic group remaining after removing two hydrogen atoms from an aromatic amine. The number of carbon atoms of the divalent aromatic amine residue is usually 5 to around 100, preferably 15 to 60. Here, in the number of carbon atoms of the divalent aromatic amine residue, the number of carbon atoms of the substituents is not included.

The number average molecular weight of the compound in which a residue of the bismuth compound is incorporated in the molecule thereof is 10³ to 10⁷ in terms of polystyrene and from the viewpoints of the solubility and the applicability, it is preferably 10³ to 10⁶, more preferably 10³ to 10⁵, and further preferably 2×10³ to 10⁴.

### <1.2 Thin Film of the Present Invention>

The thin film of the present invention is a thin film containing the bismuth compound. The thin film of the present invention can be caused to emit light by being put under a certain condition. The thin film of the present invention may contain besides the bismuth compound, other components. The other component may be any one of an additive added during the production of the thin film, a substrate compound used for the compound or used during the production of the compound, and a compound produced as a by-product during the production of the compound or the like.

The thin film of the present invention has a thickness of preferably 0.2 nm to 1 mm, more preferably 1 nm to 50 μm, further preferably 5 nm to 1 μm, and particularly preferably 10 nm to 200 nm. The thin film having such a thickness can easily be formed as a thin film having advantageous charge transport property, and satisfactory strength and other property.

The thin film of the present invention may contain, for enhancing hole transport property and electron transport property, besides the bismuth compound, a charge transporting material. The charge transporting material may be any one of a low molecular weight organic compound, a macromolecular compound, and an oligomer. When the charge transporting material is a macromolecular compound or an oligomer, the material is preferably a conjugated one.

The low molecular weight organic compound used for the charge transport material means a host compound (that is, a low molecular weight host compound), a charge injection compound, a charge transport compound, and the like that are used for a low molecular weight organic EL element, and specific examples thereof may include compounds described in “Organic EL display” (collaborated by Shizuo Tokito, Chihaya Adachi, and Hideyuki Murata; published by Ohmsha, Ltd.) p. 107, “Gekkan Display, vol. 9, No. 9, pp. 26 to 30 (2003)”, Japanese Patent Application Laid-open No. 2004-244400, Japanese Patent Application Laid-open No. 2004-277377, Japanese Patent Application Laid-open No. 2008-169192, for example.

Examples of the macromolecular organic compound used for the charge transport material may include a non-conjugated macromolecular organic compound and a conjugated macromolecular organic compound. From the viewpoint of the charge transportation, by the conjugated macromolecular organic compound, the conjugation spreads and the carrier (electron or hole) mobility becomes higher, which is advantageous, so that the conjugated macromolecular organic compound is preferred. Examples of the non-conjugated macromolecular organic compound may include a polyvinylcarbazole. Examples of the conjugated macromolecular organic compound include a macromolecular compound containing an aromatic ring in the main chain thereof and specific examples thereof include macromolecular compounds containing as a repeating unit in the main chain thereof, a phenylene group that may have a substituent, fluorene that may have a substituent, dibenzothiophene that may have a substituent, dibenzofuran that may have a substituent, dibenzosilole that may have a substituent, or the like, and copolymers produced by copolymerizing a monomer having these repeating units with another monomer. More specific examples thereof may include macromolecular organic compounds described in Japanese Patent Application Laid-open No. 2003-231741, Japanese Patent Application Laid-open No. 2004-059899, Japanese Patent Application Laid-open No. 2004-002654, Japanese Patent Application Laid-open No. 2004-292546, Japanese Patent Application Laid-open No. 2008-169192, U.S. Pat. No. 5,708,130, WO9954385, WO0046321, WO02077060, “Organic EL display” (collaborated by Shizuo Tokito, Chihaya Adachi, and Hideyuki Murata; published by Ohmsha, Ltd.) p. 112, “Gekkan Display, vol. 9, No. 9, pp. 47 to 51 (2002)”, and the like.

The charge transport material has preferably T1 (energy level of the lowest triplet excited state) larger than T1 of the bismuth compound and it is more preferred that difference between the two T1s is larger than 0.2 eV.

The thin film of the present invention may contain, for enhancing the mechanical characteristics of the obtained thin film, a macromolecular compound having no charge transport property. Although examples of the macromolecular compound having no charge transport property may include a non-conjugated macromolecular compound, particularly a macromolecular compound not extremely hindering charge transport property or not having a strong absorbance relative to visible light when the macromolecular compound is formed into a thin film, is also preferred. Examples of the non-conjugated macromolecular compound may include polystyrenes (such as polystyrene, isotactic polystyrene, and poly(α-methylstyrene)), polyethylenes (such as HD polyethylene), polypropylene, polyisoprene, polybutadiene, poly(4-methyl-1-pentene), poly(tetrafluoroethylene), polycarbonate, polyacrylate, polymethylacrylate, polymethylmethacrylate, polyvinyl chloride, and a copolymer (such as a random copolymer and a block copolymer) having a repeating unit constituting these non-conjugated macromolecular compounds.

When it is preferred that the thin film of the present invention generate a charge in the thin film by light absorbed by the thin film, the thin film of the present invention may contain a charge generating material. Examples of the charge generating material may include an azo compound and derivatives thereof, a diazo compound and derivatives thereof, a phthalocyanine compound containing no metal and derivatives thereof, a metal-containing phthalocyanine compound and derivatives thereof, a perylene compound and derivatives thereof, a polycyclic quinone compound and derivatives thereof, a squarylium compound and derivatives thereof, an azulenium compound and derivatives thereof, a thiapyrylium compound and derivatives thereof, and fullerenes such as 060 and derivatives thereof.

### <1.3 Production Method of Thin Film of the Present Invention and Coating Liquid for Forming the Thin Film>

Although the thin film of the present invention may be produced by any method, the thin film can be formed, for example, by dissolving the bismuth compound in an organic solvent to prepare a solution and by using the solution or the like. The solution containing the bismuth compound and an organic solvent can be used as a coating liquid for forming the thin film.

As the organic solvent used for the production of the thin film of the present invention, preferred is an organic solvent capable of advantageously dissolving or dispersing (if necessary, the solvent may be heated) components that will be contained in the thin film.

The solvent may be a solvent capable of dissolving or dispersing the components other than the solvent in the above liquid composition. Examples of the solvent may include a chlorinated solvent such as chloroform, methylene chloride, 1,2-dichloroethane, 1,1,2-trichloroethane, chlorobenzene, and o-dichlorobenzene; an ether solvent such as tetrahydrofuran and dioxane; an aromatic hydrocarbon solvent such as toluene, xylene, anisole, trimethylbenzene, and mesitylene; an aliphatic hydrocarbon solvent such as cyclohexane, methylcyclohexane, pentane, hexane, heptane, octane, nonane, and decane; a ketone solvent such as acetone, methyl ethyl ketone, and cyclohexanone; an ester solvent such as ethyl acetate, butyl acetate, methyl benzoate, and ethylcellosolve acetate; a polyhydric alcohol and derivatives thereof such as ethylene glycol, ethylene glycol monobutyl ether, ethylene glycol monoethyl ether, ethylene glycol monomethyl ether, dimethoxyethane, propylene glycol, diethoxymethane, triethylene glycol monoethyl ether, glycerin, and 1,2-hexanediol; an alcohol solvent such as methanol, ethanol, propanol, isopropanol, and cyclohexanol; a sulfoxide solvent such as dimethyl sulfoxide; and an amide solvent such as N-methyl-2-pyrrolidone and N,N-dimethylformamide.

Among these solvents, from the viewpoints of the solubility of the components other than the solvent in the liquid composition, homogeneity during the film formation, and viscosity characteristics, a chlorinated solvent, an aromatic hydrocarbon solvent, an aliphatic hydrocarbon solvent, an ester solvent, and a ketone solvent are preferred; chloroform, 1,2-dichloroethane, 1,1,2-trichloroethane, chlorobenzene, o-dichlorobenzene, toluene, xylene, anisole, cyclohexane, pentane, hexane, acetone, methyl ethyl ketone, cyclohexanone, ethyl acetate, and dimethoxyethane are preferred; and chloroform, 1,2-dichloroethane, toluene, and xylene are more preferred.

Although the solvents may be used individually, from the viewpoints of film-forming property and element characteristics, the solvents are used preferably in combination of two or more types thereof, more preferably in combination of two or three types thereof, and particularly preferably in combination of two types thereof.

The formation of the thin film of the present invention may be performed by applying the above solution or the like on a substrate and if necessary, by removing the solvent either simultaneously with the application or after the application. The application can be performed using an applying method such as a spin coating method, a casting method, a micro-gravure coating method, a gravure coating method, a bar coating method, a roll coating method, a wire bar coating method, a dip coating method, a spray coating method, a screen printing method, a flexo printing method, an offset printing method, an inkjet printing method, a dispenser printing method, a nozzle coating method, and a capillary coating method.

As one preferred embodiment of the bismuth compound, a bismuth compound having high solubility in an organic solvent can easily be prepared. Accordingly, the preparation of a coating liquid for forming the thin film containing a bismuth compound having high solubility can be easily performed. The solubility of the bismuth compound contained in the coating liquid for forming the thin film is excellent, so that the bismuth compound can be homogeneously applied and the thin film can easily be formed in a homogeneous film thickness. Therefore, using the coating liquid for forming the thin film of the present invention, a film causing small unevenness of light emission from the film surface and exhibiting homogeneous light-emitting property can easily be produced.

### <1.4 Element of the Present Invention>

Next, the element of the present invention is described. The element of the present invention has the thin film containing the bismuth compound. By using the thin film of the present invention, an element excellent in light-emitting characteristics can be obtained.

Examples of the embodiment of the element may include an element comprising an anode, a thin film layer containing the bismuth compound that is disposed on the anode, and a cathode disposed on the layer. More specifically, examples thereof may include an element comprising an anode, the thin film of the present invention disposed on the anode, and a cathode disposed on the thin film. Such an element can be used, for example, as a light-emitting element, a switching element, or a photovoltaic cell. In these elements, a layer containing the bismuth compound is a photoelectric layer. Here, the photoelectric layer refers to a layer having photoelectric function, that is, a thin film having light-emitting property, electroconductivity, and photoelectric converting function.

The element of the present invention may further contain a charge transport layer or a charge block layer between the anode and the cathode. The charge transport layer refers to a hole transport layer or an electron transport layer; the hole transport layer refers to a layer having a hole transporting function; and the electron transport layer refers to a layer having an electron transporting function. The charge block layer refers to a hole block layer or an electron block layer; the hole block layer refers to a layer having functions of transporting the electron and confining the hole transported from the anode; and the electron block layer refers to a layer having functions of transporting the hole and confining the electron transported from the cathode.

Examples of the element of the present invention may include an element comprising the electron transport layer or the hole block layer between the cathode and the light-emitting layer, an element comprising the hole transport layer or the electron block layer between the anode and the light-emitting layer, and an element comprising the electron transport layer or the hole block layer between the cathode and the light-emitting layer and comprising the hole transport layer or the electron block layer between the anode and the light-emitting layer.

Specific examples of the structure of the element of the present invention are shown as follows. Here, the symbol“/” indicates that the layers are stacked adjacent to each other. The same applies to the following items.

a) Anode/(charge injection layer)/light-emitting layer/(charge injection layer)/cathode
b) Anode/(charge injection layer)/hole transport layer/light-emitting layer/(charge injection layer)/cathode
c) Anode/(charge injection layer)/light-emitting layer/electron transport layer/(charge injection layer)/cathode
d) Anode/(charge injection layer)/hole transport layer/light-emitting layer/electron transport layer/(charge injection layer)/cathode

In the element of the present invention, the light-emitting layer, the hole transport layer, and the electron transport layer may independently be provided in two or more layers.

Among the charge transport layers (hole transport layer and electron transport layer) provided adjacent to the electrode, a layer having a function of improving the charge injection efficiency from the electrode and having an effect of lowering the driving voltage of the element may generally be called as the “charge injection layer (hole injection layer and electron injection layer)”. Examples of the element comprising the charge injection layer may include an element comprising the charge injection layer disposed adjacent to the cathode and an element comprising the charge injection layer disposed adjacent to the anode.

In the element of the present invention, for enhancing the adhesion with the electrode or improving the charge injection from the electrode, an insulation layer having a film thickness of 2 nm or less may be provided adjacent to the electrode. Examples of the material used for the insulation layer may include a metal fluoride, a metal oxide, and an organic insulation material. Examples of the element comprising an insulation layer having a film thickness of 2 nm or less may include an element comprising the insulation layer disposed adjacent to the cathode and an element comprising the insulation layer disposed adjacent to the anode.

In the element of the present invention, for enhancing the adhesion in the interface or preventing the intermixing of the layer, between the electrode and the light-emitting layer and adjacent to the electrode or in the interface between the charge transport layer and the light-emitting layer, there may be further provided a buffer layer having an average film thickness of 2 nm or less.

The element of the present invention is not limited to the above-exemplified structures and also may includes an element in which the layering order and the number of the layers, and the thickness of each layer are appropriately set in consideration of light-emitting efficiency, photoelectric efficiency, and element life.

The embodiment of each layer that the element of the present invention may comprise is described.

(Light-Emitting Layer)

The light-emitting layer may be a layer produced using the bismuth compound, that is, the thin film of the present invention. The light-emitting layer may be constituted with one layer or a plurality of layers. The light-emitting layer may further contain besides the thin film of the present invention, other light-emitting materials. Examples of the other light-emitting materials that may be contained in the light-emitting layer may include a naphthalene derivative, anthracene and derivatives thereof, perylene and derivatives thereof, dyes such as a polymethine-based dye, a xanthene-based dye, a coumarin-based dye, and a cyanine-based dye, a metal complex of 8-hydroxyquinoline and derivatives thereof, an aromatic amine, tetraphenylcyclopentadiene and derivatives thereof, and tetraphenylbutadiene and derivatives thereof.

(Hole Transport Layer)

Examples of the material used for the hole transport layer may include the compounds described in Japanese Patent Application Laid-open No. S63-70257, Japanese Patent Application Laid-open No. S63-175860, Japanese Patent Application Laid-open No. H2-135359, Japanese Patent Application Laid-open No. H2-135361, Japanese Patent Application Laid-open No. H2-209988, Japanese Patent Application Laid-open No. H3-37992, and Japanese Patent Application Laid-open No. H3-152184. Specific examples thereof may include a polyvinylcarbazole and derivatives thereof, a polysilane and derivatives thereof, a polysiloxane derivative having an aromatic amine compound group in side chains or the main chain thereof, a pyrazoline derivative, an arylamine derivative, a stilbene derivative, a triphenyldiamine derivative, a polyaniline and derivatives thereof, a polyaminophene and derivatives thereof, a polypyrrole and derivatives thereof, a poly(p-phenylenevinylene) and derivatives thereof, and a poly(2,5-thienylenevinylene) and derivatives thereof.

Although the film thickness of the hole transport layer is set so that the light-emitting efficiency or the photoelectric efficiency and the driving voltage become a moderate value, and although the optimal value thereof is varied according to the used material, a film thickness of the hole transport layer by which a pin hole is not caused is necessary. When a hole transport layer has a too large film thickness, the driving voltage of the element tends to become higher. Accordingly, the hole transport layer has a film thickness of preferably 1 nm to 1 μm, more preferably 2 to 500 nm, and particularly preferably 5 to 200 nm.

(Electron Transport Layer)

Examples of the material used for the electron transport layer may include the compounds described in Japanese Patent Application Laid-open No. S63-70257, Japanese Patent Application Laid-open No. S63-175860, Japanese Patent Application Laid-open No. H2-135359, Japanese Patent Application Laid-open No. H2-135361, Japanese Patent Application Laid-open No. H2-209988, Japanese Patent Application Laid-open No. H3-37992, and Japanese Patent Application Laid-open No. H3-152184. Specific examples thereof may include an oxadiazole derivative, anthraquinodimethane and derivatives thereof, benzoquinone and derivatives thereof, naphthoquinone and derivatives thereof, anthraquinone and derivatives thereof, tetracyanoanthraquinodimethane and derivatives thereof, a fluorenone derivative, diphenyldicyanoethylene and derivatives thereof, a diphenoquinone derivative, a metal complex of 8-hydroxyquinoline and derivatives thereof, a polyquinoline and derivatives thereof, a polyquinoxaline and derivatives thereof, and a polyfluorene and derivatives thereof.

Although the film thickness of the electron transport layer is set so that the light-emitting efficiency or the photoelectric efficiency and the driving voltage become a moderate value, and although the optimal value thereof is varied according to the used material, a film thickness of the electron transport layer by which a pin hole is not caused is necessary. When an electron transport layer has a too large film thickness, the driving voltage of the element tends to become higher. Accordingly, the electron transport layer has a film thickness of preferably 1 nm to 1 μm, more preferably 2 to 500 nm, and particularly preferably 5 to 200 nm.

(Substrate)

The element of the present invention is formed usually using a substrate. On one side of the substrate, the electrode is formed and on another side thereof, each layer of the element is formed. The substrate used in the present invention may be a substrate chemically not changed when the electrode and each layer of the element are formed and examples thereof may include substrates of a glass, a plastic, a polymer film, and a silicon. When the substrate is an opaque substrate, it is preferred that as the electrode disposed in the opposite side of the substrate, transparent or translucent electrode be formed.

(Electrode)

Usually, at least one of the anode and the cathode is a transparent or translucent electrode and the anode is preferably a transparent or translucent electrode. When the element of the present invention is a photovoltaic cell, at least any one electrode of the anode and the cathode may be formed in a comb shape. In this case, although the electrode may be opaque, the electrode is preferably a transparent or translucent electrode.

Examples of the material used for the anode may include an electroconductive metal oxide film and a translucent metal thin film. Specific examples thereof may include indium oxide, zinc oxide, tin oxide, a complex thereof (such as indium-tin-oxide (ITO) and indium-zinc-oxide), antimony-tin-oxide, NESA, gold, platinum, silver, and copper. Among them, preferred are ITO, indium-zinc-oxide, and tin oxide. As the anode, an organic transparent electroconductive film such as a polyaniline and derivatives thereof and a polyaminophene and derivatives thereof may be used.

Examples of the forming method of the anode may include a vacuum evaporation method, a sputtering method, an ion plating method, and a plating method.

The film thickness of the anode can be set by taking into consideration optical transparency and electric conductivity. The anode has a film thickness of preferably 10 nm to 10 μm, more preferably 20 nm to 1 μm, and particularly preferably 50 to 500 nm.

As the material used for the cathode, a material having a small work function is preferred and examples thereof may include a metal such as lithium, sodium, potassium, rubidium, cesium, beryllium, magnesium, calcium, strontium, barium, aluminum, scandium, vanadium, zinc, yttrium, indium, cerium, samarium, europium, terbium, and ytterbium; an alloy of two or more metals among these metals; an alloy of one or more metal(s) among these metals with one or more metal(s) among gold, silver, platinum, copper, manganese, titanium, cobalt, nickel, tungsten, and tin; graphite; and compounds in which atoms of the above metals are intercalated between layers of graphite. Examples of the above alloy may include a magnesium-silver alloy, a magnesium-indium alloy, a magnesium-aluminum alloy, an indium-silver alloy, a lithium-aluminum alloy, a lithium-magnesium alloy, a lithium-indium alloy, and a calcium-aluminum alloy.

Examples of the forming method of the anode and the cathode may include a vacuum evaporation method, a sputtering method, and a laminating method by thermocompression-bonding a metal thin film. There may also be formed a cathode in a layered structure of two or more layers.

The film thickness of the cathode can be set by taking into consideration electric conductivity and durability. The cathode has a film thickness of preferably 10 nm to 10 μm, more preferably 20 nm to 1 μm, and particularly preferably 50 to 500 nm.

Between the cathode and the organic substance layer, there may also be provided a layer composed of a conductive macromolecule or a layer composed of a metal oxide, a metal fluoride, an organic insulation material, or the like that has an average film thickness of 2 nm or less.

(Protective Layer)

In the element of the present invention, for protecting the element from the outside to use the element stably for a long period, after the formation of the cathode, a protective layer and/or a protective cover for protecting the element may be formed.

Examples of the material used for such a protective layer may include a macromolecular compound, a metal oxide, a metal fluoride, and a metal boride. Examples of the protective cover may include a glass plate and a plastic plate of which surface is subjected to a low water permeability-coefficient treatment. Among them, preferred is a protective cover laminated with the element using a thermocurable resin or a photocurable resin to seal the element.

(Charge Injection Layer)

Examples of the charge injection layer may include a layer containing an electroconductive macromolecule, a layer containing a material having an ionization potential of an intermediate value between a value of an ionization potential of an anode material and a value of an ionization potential of a hole transport material contained in the hole transport layer (when it is provided between the anode and the hole transport layer), and a layer containing a material having an electron affinity of an intermediate value between a value of an electron affinity of a cathode material and a value of an electron affinity of an electron transport material contained in the electron transport layer (when it is provided between the cathode and the electron transport layer).

The material used for the charge injection layer may be selected according to the relationship with a material of the electrode or materials of adjacent layers. Examples of the material used for the charge injection layer may include: a polyaniline and derivatives thereof; a polyaminophene and derivatives thereof; a polypyrrole and derivatives thereof; a polyphenylenevinylene and derivatives thereof; a polythienylenevinylene and derivatives thereof; a polyquinoline and derivatives thereof; a polyquinoxaline and derivatives thereof; a conductive macromolecule such as a polymer containing in the main chain or side chains thereof, an aromatic amine structure; a metal phthalocyanine (such as copper phthalocyanine); and carbon.

The charge injection layer has a film thickness of preferably 1 nm to 100 nm, more preferably 1 nm to 50 nm, and further preferably 1 nm to 10 nm.

When the element of the present invention is a light-emitting element, this light-emitting element can be used in a planar light source, a segment display device, a dot-matrix display device, a backlight for a liquid crystal display device, and an illuminator.

For obtaining a planar light emission using the light-emitting element, it is satisfactory to dispose a planar anode and a planar cathode so that they overlap. Examples of the method for obtaining a pattern-shaped light emission may include a method for providing a mask in which a pattern-shaped window is provided on the surface of a planar light-emitting element, a method for forming substantially a non-light-emitting part by forming a part of the organic layer in an extremely large thickness, and a method for forming one electrode or both electrodes of the anode and the cathode in a pattern shape. By forming a pattern by any method among them and by disposing some electrodes so that ON/OFF of the electrodes can be independently performed, a segment display element capable of displaying a figure, a letter, a simple mark, and the like can be obtained. Furthermore, by forming both of the anode and the cathode in a stripe shape and by disposing them so that they cross each other at right angles, a dot-matrix display element can be obtained.

With respect to the dot-matrix display element, by coating the element with a plurality of types of light-emitting materials emitting lights of different colors or by using a color filter or a light emission converting filter, a partial color display or a multicolor display becomes possible. The dot-matrix display element can be driven by passive driving and by combining it with TFT or the like, the dot-matrix display element becomes possible to be driven by active driving. These display elements can be used in a display device such as a computer, a television, a portable terminal, a cellular phone, a car navigation, and a view finder for a video camera.

The planar light-emitting element is a selfluminous thin-type element and can be suitably used as a planar light source for a backlight of a liquid crystal display device or a planar light source for illumination. By using a flexible substrate, the planar light-emitting element can be used as a curved surface-shaped light source or display device.

When the element of the present invention is a switching element, this switching element can be used in a liquid crystal display device having an active matrix drive circuit.

When the element of the present invention is a photovoltaic cell, this photovoltaic cell can be used in a solar cell.

The element of the present invention is also used in a light wavelength converting switch element.

The thin film of the present invention is also useful as an electroconductive material, so that the thin film is also useful as a charge transport material and a charge injection material. The thin film of the present invention is also useful as a material for an organic transistor element, an organic photovoltaic cell, and the like, a substrate for synthesis of a compound, and a material for an additive, a modifier, a drug, a sensor, and the like.

2. Novel Composition of the Present Invention

The present invention provides a novel compound of Formula (3)

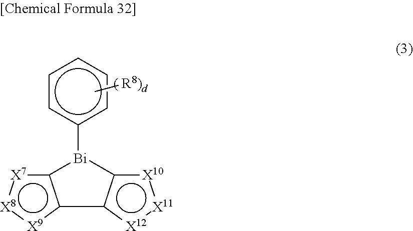

wherein R⁸ is a substituent; d is an integer of 0 to 5, wherein when d is 2 or more, each R⁸ may be different from each other and when the each R⁸ are adjacent to each other, each R⁸ may form together with each other a bond; two of X⁷, X⁸, and X⁹ are —CR⁹═ and remaining one thereof is —S—; two of X¹⁰, X¹¹, and X¹² are —CR⁹═ and remaining one thereof is —S—; R⁹ is a hydrogen atom or a substituent; Plurality of R⁹ may be different from each other; the substituent as R⁹ is selected from the group consisting of a hydrocarbyl group that may have a substituent, a hydrocarbyloxy group that may have a substitutent, and a silyl group that may have a substitutent; at least one of R⁹ is the substituent; and when a plurality of R⁹ are the substituent, each R⁹ adjacent to each other may form together with each other a bond.

R⁸ is the same as defined as R¹ in Formula (1) and specific examples and preferred examples of R⁸ are the same as those of R¹. d in Formula (3) is an integer of 0 to 5, preferably an integer of 0 to 3, more preferably 0 or 1, and further preferably 0. When d is 2 or more, R⁸s may be different from each other and when they are adjacent to each other, R⁸s may form together with each other a bond.

Two of X⁷, X⁸, and X⁹ are —CR⁹═ and remaining one thereof is —S—. Two of X¹⁰, X¹¹, and X¹² are —CR⁹═ and remaining one thereof is —S—. Here, at least one of R⁹s is a group other than a hydrogen atom and preferably, two or more of R⁹s are a group other than a hydrogen atom.

When a plurality of R⁹s are a group other than a hydrogen atom and they are adjacent to each other, R⁹s may form together with each other a bond. For example, when both of two R⁹s in two —CR⁹═ among X⁷, X⁸, and X⁹ are a group other than a hydrogen atom and they are adjacent to each other, two R⁹s may form together with each other a bond. When both of two R⁹s in two —CR⁹═ among X¹⁰, X¹¹, and X¹² are a group other than a hydrogen atom and they are adjacent to each other, two R⁹s may form together with each other a bond. Preferred examples of the form in which two R⁹s are adjacent to each other may include a form in which X⁷ and X⁸ are —CR⁹═, a form in which X⁹ and X¹⁰ are —CR⁹═, a form in which X¹⁰ and X¹¹ are —CR⁹═, and a form in which X¹¹ and X¹² are —CR⁹═.

R⁹ is a hydrogen atom or a substituent. Examples of R⁹ may include a hydrogen atom, a halogen atom, a hydrocarbyl group that may be substituted, a hydrocarbyloxy group that may be substituted, and a silyl group that may be substituted. Among them, as R⁹, preferred are a hydrogen atom, a hydrocarbyl group that may be substituted, and a silyl group that may be substituted, and more preferred are a hydrogen atom and a silyl group that may be substituted.

When R⁹ is a group containing a carbon atom and no aromatic ring, R⁹ is a C₁₋₃₀ group, preferably a C₁₋₂₀ group, more preferably a C₁₋₁₀ group, further preferably a C₁₋₆ group, and particularly preferably a C₁₋₄ group. When R⁹ is a group containing an aromatic ring, R⁹ is a C₂₋₃₀ group, preferably a C₃₋₂₀ group, more preferably a C₄₋₁₀ group, further preferably a C₄₋₆ group, and particularly preferably a C₆ group.

Examples of the hydrocarbyl group as R⁹ may include a methyl group, an ethyl group, a 1-propyl group, 2-propyl group, a 1-butyl group, a 2-butyl group, a sec-butyl group, a tert-butyl group, a pentyl group, a hexyl group, an octyl group, a decyl group, a dodecyl group, a 2-ethylhexyl group, a 3,7-dimethyloctyl group, a cyclopropyl group, a cyclopentyl group, a cyclohexyl group, a 1-adamantyl group, a 2-adamantyl group, a norbornyl group, an ammoniumethyl group, a benzyl group, an α,α-dimethylbenzyl group, a 1-phenetyl group, a 2-phenetyl group, a vinyl group, a propenyl group, a butenyl group, an oleyl group, an eicosapentaenyl group, a docosahexaenyl group, a 2,2-diphenylvinyl group, a 1,2,2-triphenylvinyl group, a 2-phenyl-2-propenyl group, a phenyl group, a 2-tolyl group, a 4-tolyl group, a 4-trifluoromethylphenyl group, a 4-methoxyphenyl group, a 4-cyanophenyl group, a 2-biphenylyl group, a 3-biphenylyl group, a 4-biphenylyl group, a terphenylyl group, a 3,5-diphenylphenyl group, a 3,4-diphenylphenyl group, a pentaphenylphenyl group, a 4-(2,2-diphenylvinyl)phenyl group, a 4-(1,2,2-triphenylvinyl)phenyl group, a fluorenyl group, a 1-naphthyl group, a 2-naphthyl group, a 9-anthryl group, a 2-anthryl group, a 9-phenanthryl group, a 1-pyrenyl group, a chrysenyl group, a naphthacenyl group, and a coronyl group. Among them, as the hydrocarbyl group as R⁹, preferred are a methyl group, an ethyl group, a 1-propyl group, a 2-propyl group, a 1-butyl group, a 2-butyl group, a sec-butyl group, a tert-butyl group, a pentyl group, a hexyl group, an octyl group, a decyl group, a dodecyl group, a 2-ethylhexyl group, a benzyl group, a vinyl group, a propenyl group, a butenyl group, a phenyl group, a 2-tolyl group, and a 4-tolyl group; more preferred are a methyl group, an ethyl group, a 1-propyl group, a 2-propyl group, a 1-butyl group, a 2-butyl group, a sec-butyl group, a tert-butyl group, a pentyl group, a hexyl group, an octyl group, a decyl group, a dodecyl group, and a 2-ethylhexyl group; further preferred are a methyl group, an ethyl group, a tert-butyl group, and a 2-ethylhexyl group; and particularly preferred is a methyl group.

Examples of the hydrocarbyloxy group as R⁹ may include a methoxy group, an ethoxy group, a 1-propanoxy group, a 2-propanoxy group, a 1-butoxy group, a 2-butoxy group, a sec-butoxy group, a tert-butoxy group, a pentyloxy group, a hexyloxy group, an octyloxy group, a decyloxy group, a dodecyloxy group, a 2-ethylhexyloxy group, a 3,7-dimethyloctyloxy group, a cyclopropanoxy group, a cyclopentyloxy group, a cyclohexyloxy group, a 1-adamantyloxy group, a 2-adamantyloxy group, a norbornyloxy group, an ammoniumethoxy group, a trifluoromethoxy group, a benzyloxy group, an α,α-dimethybenzyloxy group, a 2-phenetyloxy group, a 1-phenetyloxy group, a phenoxy group, an alkoxyphenoxy group, an alkylphenoxy group, a 1-naphthyloxy group, a 2-naphthyloxy group, and a pentafluorophenyloxy group. Among them, as the hydrocarbyloxy group as R⁹, preferred are a methoxy group, an ethoxy group, a 1-propanoxy group, a 2-propanoxy group, a 1-butoxy group, a 2-butoxy group, a sec-butoxy group, a tert-butoxy group, a pentyloxy group, a hexyloxy group, an octyloxy group, a decyloxy group, a dodecyloxy group, a 2-ethylhexyloxy group, and a 3,7-dimethyloctyloxy group; and further preferred are a methoxy group and an ethoxy group.

Next, specific examples (Formula 2001 to Formula 2013) of the compound of Formula (3) are shown as follows. Here, ^{t}Bu is a tert-butyl group, Me is a methyl group, and ⁱPr is an isopropyl group.

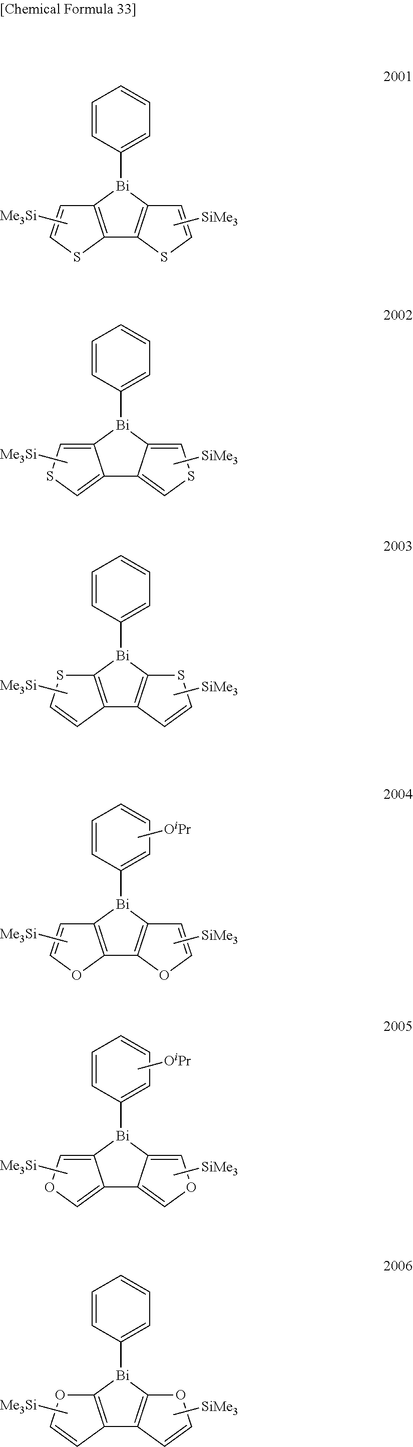

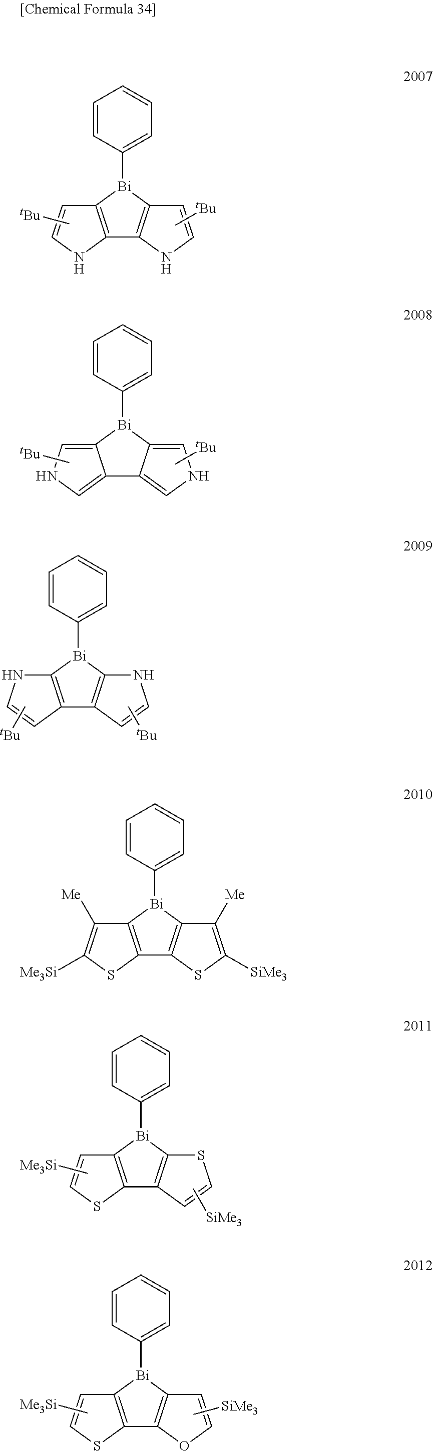

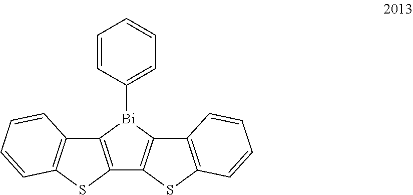

The compound of Formula (3) has a particularly high solubility in an organic solvent and can provide a homogeneous film excellent in a device application by an applying method.

The present invention provides a novel compound of Formula (3′):

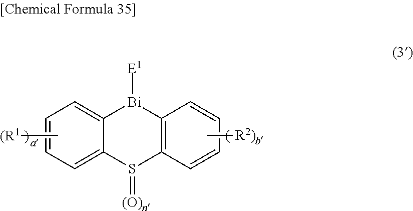

wherein R¹, R², and E¹ are the same as defined above; a′ and b′ are each independently an integer of 0 to 4, wherein when a′ is 2 or more, each R¹ may be different from each other and two R¹ may be bonded with each other to form a ring structure, and when b′ is 2 or more, each R² may be different from each other and two R² may be bonded with each other to form a ring structure; and n′ is 1 or 2.

a′ and b′ are an integer of 0 to 4, preferably an integer of 0 to 2, and more preferably 0 or 1.

The present invention further provides a compound (hereinafter, also called as the “macromolecular compound of the present invention”) having a number average molecular weight in terms of polystyrene of 10³ to 10⁷ and containing a constitutional unit composed of a structure in which one or two or more hydrogen atom(s) is(are) removed from the compound of Formula (1). The compound of Formula (1) is preferably a compound of Formula (2). The constitutional unit may be repeated in a plurality of times to form a repeating unit.

The macromolecular compound of the present invention is a compound having a number average molecular weight in terms of polystyrene of 10³ to 10⁷, preferably 10³ to 10⁶, and more preferably 10⁴ to 10⁵. The compound having a number average molecular weight in the above range can easily maintain the solubility thereof in a solvent advantageously and can easily produce a coating liquid capable of easily being applied homogeneously.

Examples of an embodiment of the macromolecular compound of the present invention may include the embodiments below.

(i) A compound having a number average molecular weight in terms of polystyrene of 10³ to 10⁷ and having the constitutional unit of Formula (4) in the molecule thereof. The constitutional unit of Formula (4) is preferably contained in the main chain in the molecule.
(ii) A compound having a number average molecular weight in terms of polystyrene of 10³ to 10⁷ and having the constitutional unit of Formula (5) in the molecule thereof. The constitutional unit of Formula (5) is preferably contained in the main chain in the molecule.
(iii) A compound having a number average molecular weight in terms of polystyrene of 10³ to 10⁷ and having the constitutional unit of Formula (6) in the molecule thereof. The constitutional unit of Formula (6) is preferably contained as a side chain or in a terminal of the main chain in the molecule.
(iv) A compound having a number average molecular weight in terms of polystyrene of 10³ to 10⁷ and containing the constitutional unit of Formula (7). The constitutional unit of Formula (7) is preferably contained as a side chain or in a terminal of the main chain in the molecule.
(v) A compound having a number average molecular weight in terms of polystyrene of 10³ to 10⁷ and containing the constitutional unit of Formula (11).
(vi) a compound having a number average molecular weight in terms of polystyrene of 10³ to 10⁷ and containing the constitutional unit of Formula (12).
(vii) A compound having a number average molecular weight in terms of polystyrene of 10³ to 10⁷ and containing the constitutional unit of Formula (13).

Each of the compounds of Formula (1), Formula (2), and Formula (3) and the compound containing a structure unit composed of a structure in which one or two or more hydrogen atom(s) is(are) removed from these compounds can utilize maximally a phosphorescence, so that the compound has preferably a small energy difference (S1−T1) between the lowest singlet excitation energy (S1) and the lowest triplet excitation energy (T1), and specifically, preferably, of 1.5 eV or less, more preferably of 1.3 eV or less, further preferably of 1.0 eV or less, and particularly preferably of 0.5 eV or less.

### EXAMPLES

Hereinafter, the present invention is described more specifically with reference to Examples, which should not be construed as limiting the scope of the present invention.

¹H and ¹³C NMR spectra were measured using JEOL Model JNM-EX-270 spectrum meter and JEOL Model JNM-EX-400. The MS spectrum was measured using SHIMADZU-GCMS-QP5050A. For the measurement of FAB-MS, an SX102A-type double-focusing mass spectrometer (manufactured by JEOL Ltd.) was used. The recycle-type preparative GPC was measured by GL Science LC-908-type MODEL 576 using as the filler, Shodex Kf001, KF002 and the detection was performed by RI. The gas chromatography (hereinafter, also abbreviated as GC) was measured using GC-14B (manufactured by Shimadzu Corporation) equipped with a silicon OV-17 (2%-1m) filler column. For the thin-layer chromatography (hereinafter, also abbreviated as TLC), a silica gel was used. The emission spectrum was measured by a fluorescence spectrophotometer (trade name: FP-6500; manufactured by JASCO Corporation) at an excitation wavelength of 380 nm. The excitation life was measured by a fluorescence spectrophotometer (trade name: Fluorolog-Tau3; manufactured by Jobin Yvon-Spex Instruments S.A., Inc.) as an excitation life at an emission peak wavelength of the emission spectrum. All synthetic reactions were effected in a nitrogen stream. Diethyl ether and tetrahydrofuran (hereinafter, also abbreviated as THF) used for the synthesis were dried over sodium-benzophenone and were distilled to be used.

The energy difference between S1 and T1 was calculated by the method below.

Using a quantum chemistry calculation program Gaussian 03, by the B3LYP-level density functional method, the structure of the compound in the ground state was optimized. At this time, as the ground function, LANL2DZ was used for the bismuth atom and 6-31G*was used for the other atoms. Thereafter, using the same ground, by the B3LYP-level time-dependent density functional method, the lowest singlet excitation energy (S1) and the lowest triplet excitation energy (T1) were measured and the energy difference ΔE±S1−T1 was calculated.

### Calculation Example

S1 and T1 of the compound below were measured and the energy difference thereof (S1−T1) was calculated and was 1.32 eV.

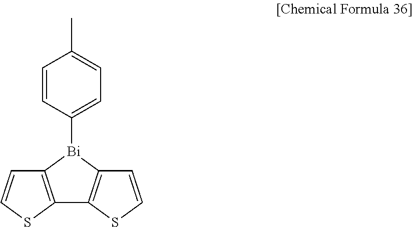

This compound emitted red light by an ultraviolet ray excitation (365 nm) in a solution state (solvent: chloroform) at room temperature. Such a red light emission was not observed in the atmosphere, but was observed only in an inert gas atmosphere.

### Synthesis Example of Bismuth Compound

### Synthesis Example 1

### Synthesis of 1-phenyl-3,6-bis(trimethylsilyl)dithienobismole

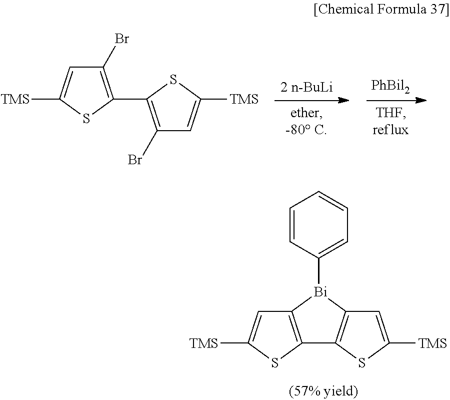

The above synthetic reaction was effected according to the following procedure to synthesize 1-phenyl-3,6-bis(trimethylsilyl)dithienobismole. In the formula, TMS is a trimethylsilyl group.

Into a 30 mL two-neck flask equipped with a reflux condenser, 0.446 g (0.952 mmol) of 4,4′-dibromo-2,2′-bis(trimethylsilyl)bithiophene and 10 mL of ether were charged and the resultant reaction mixture was cooled down to −80° C. Thereto, 1.25 mL (1.59 M hexane solution, 1.98 mmol) of n-butyl lithium was added and the temperature of the resultant reaction mixture was returned gradually to room temperature, followed by stirring the reaction mixture for around 1 hour. About 0.2 mL of the reaction mixture was sampled and the sample was hydrolyzed, followed by subjecting the hydrolyzed sample to GC (gas chromatography) to confirm the generation of a dilithiated body. On the other hand, into a 30 mL two-neck flask equipped with a dropping funnel and a reflux condenser, 10 mL of THF and 0.514 g (0.952 mmol) of diiodophenyl bismuth were charged and thereto, the dilithiated body synthesized at room temperature was added. The resultant reaction mixture was heated to 50° C. to distil off ether and the resultant reaction mixture was heated to 70° C. to reflux the reaction mixture over one night. About 0.2 mL of the reaction mixture was sampled and the sample was hydrolyzed, followed by subjecting the hydrolyzed sample to GC to confirm the disappearance of the dilithiated body. From the reaction mixture, the solvent was distilled off by an evaporator and the resultant residue was hydrolyzed, followed by extracting the hydrolyzed residue with toluene. Then, the extract was dried over magnesium sulfate anhydride and from the extract, the solvent was distilled off by an evaporator. The resultant residue was subjected to a treatment by GPC (gel permeation chromatography) using toluene as the developing solvent thereby obtaining a crude product. The crude product was recrystallized in ethanol to obtain 0.322 g (yield: 57%) of 1-phenyl-3,6-bis(trimethylsilyl) dithienobismole as a light yellow needle crystal.

NMR data of the obtained substance are shown as follows.

### Numerical Data 1

mp 114-116° C.; MS (m/z) 594 (M⁺); ¹H NMR (in CDCl₃) δ=0.32 (s, 18H, TMS protons), 7.22 (s, 2H, thiophene ring protons), 7.29-7.37 (m, 3H, m-phenyl and p-phenyl protons), 7.84 (dd, 21-1, J=2.3 and 7.7 Hz, o-phenyl protons) ¹³C NMR (in CDCl₃) δ=0.10, 110.1, 127.8, 130.6, 137.7, 140.5, 141.6, 154.0, 161.4. Anal. Calcd for C₂₀H₂₅BiS₂Si₂: C, 40.39; H, 4.24. Found: C, 40.28; H, 4.13.

S1 and T1 of the obtained compound were measured and the energy difference thereof (S1−T1) was calculated and was 1.24 eV.

### Synthesis Example 2

### Synthesis of 1-phenyl-2,7-dimethyl-3,6-bis(trimethylsilyl)dithienobismole

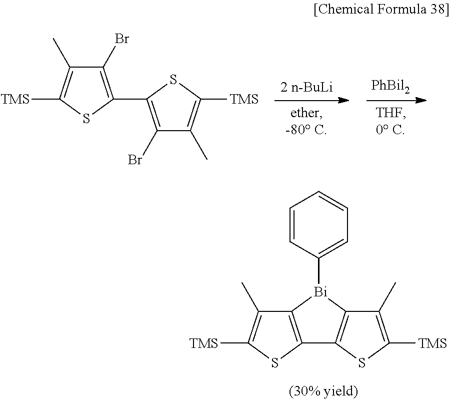

The above synthetic reaction was effected according to the following procedure to synthesize 1-phenyl-2,7-dimethyl-3,6-bis(trimethylsilyl)dithienobismole.

Into a 10 mL two-neck flask, 0.468 g (1 mmol) of 4,4′-dibromo-3,3′-dimethyl-2,2′-bis(trimethylsilyl)bithiophene and 5 mL of ether were charged and the resultant reaction mixture was cooled down to −80° C. Thereto, 1.27 mL (1.56 M hexane solution, 2 mmol) of n-butyl lithium was added and the temperature of the resultant reaction mixture was returned gradually to room temperature, followed by stirring the reaction mixture for around 1 hour. About 0.2 mL of the reaction mixture was sampled and the sample was hydrolyzed, followed by subjecting the hydrolyzed sample to GC to confirm the generation of a dilithiated body. On the other hand, into a 20 mL Schlenk tube equipped with a dropping funnel, 5 mL of THF and 0.540 g (1 mmol) of diiodophenyl bismuth were charged and the resultant reaction mixture was ice-cooled to 0° C. Thereinto, the dilithiated body was slowly dropped and while maintaining the temperature of the resultant reaction mixture at 0° C., the reaction mixture was stirred over one night. By TLC (thin-layer chromatography), the disappearance of the dilithiated body was confirmed. From the reaction mixture, the solvent was distilled off by an evaporator and the resultant residue was hydrolyzed, followed by extracting the hydrolyzed residue with toluene. The extract was dried over magnesium sulfate anhydride and from the extract, the solvent was distilled off by an evaporator. The resultant residue was subjected to a treatment by GPC using toluene as the developing solvent thereby obtaining a crude product. The crude product was recrystallized in ethanol thereby obtaining 0.1888 g (yield: 30%) of phenyl-3,3′-dimethyl-2,2′-bis(trimethylsilyl)dithienobismole as a yellow rhomb crystal.

NMR data of the obtained substance are shown as follows.

### Numerical Data 2

mp 159-161° C.; MS (m/z) 622 (M⁺); ¹H NMR (in CDCl₃) δ=0.34 (s, 18H, TMS protons), 2.33 (s, 6H, methyl protons), 7.27-7.35 (m, 3H, m-phenyl and p-phenyl protons), 7.84 (dd, 2H, J=2.3 and 7.7 Hz, o-phenyl protons) ¹³CNMR (in CDCl₃) δ=0.19, 18.9, 127.6, 130.6, 133.3, 137.7, 150.0, 154.4, 159.3, 162.9. Anal. Calcd for C₂₂H₂₉BiS₂Si₂: C, 42.43; H, 4.69. Found: C, 42.58; H, 4.36.

S1 and T1 of the obtained compound were measured and the energy difference thereof (S1-T1) was calculated and was 1.19 eV.

### Synthesis Example 3

### Synthesis of 1-phenyl-2,4-di(benzo[b]thieno)bismole

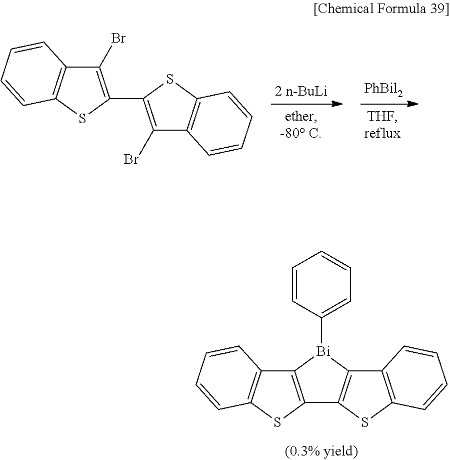

The above synthetic reaction was effected according to the following procedure to synthesize 1-phenyl-2,4-di(benzo[b]thieno)bismole.

Into a 20 mL Schlenk tube, 0.424 g (1.00 mmol) of 3,3′-dibromo-2,2′-bi(benzo[b]thiophene) and 5 mL of ether were charged and the resultant reaction mixture was cooled down to −80° C. Thereto, 1.27 mL (1.56 M hexane solution, 2.00 mmol) of n-butyl lithium was added and the temperature of the resultant reaction mixture was returned gradually to room temperature, followed by stirring the reaction mixture for around 1 hour. By GC, the generation of a dilithiated body was confirmed. Thereinto, 0.540 g (1.00 mmol) of diiodophenyl bismuth dissolved in 5 mL of THF was dropped at 0° C. and the resultant reaction mixture maintained at 0° C. was stirred over one night. By TLC, the disappearance of the substrate was confirmed. From the reaction mixture, the solvent was distilled off by an evaporator and the resultant residue was hydrolyzed, followed by extracting the hydrolyzed residue with toluene. Then, the extract was dried over magnesium sulfate anhydride and from the extract, the solvent was distilled off by an evaporator. The resultant residue was subjected to recrystallization in toluene thereby obtaining 0.1120 g (yield: 20%) of 1-phenyl-di(benzo[b]thieno)bismole as a yellow needle crystal.

NMR data of the obtained substance are shown as follows.

### Numerical Data 3

mp>300° C.; MS (m/z) 550 (M⁺); ¹H NMR (in CDCl₃) δ=7.19-7.41 (m, 7H, m and p-phenyl and phenylene protons), 7.76 (dd, 2H, o-phenyl protons) 7.79 (dd, 2H, phenylene protons) 7.96 (dd, 2H, phenylene protons); ¹³C NMR (in CDCl₃) δ=122.77, 124.05, 124.25, 125.04, 127.96, 131.01, 137.42, 143.17, 145.38, 155.99, 156.54, 157.25.; Anal. Calcd for C₂₂H₁₃BiS₂: C, 48.00; H, 2.38. Found: C, 48.07; H, 2.20.

S1 and T1 of the obtained compound were measured and the energy difference thereof (S1-T1) was calculated and was 1.14 eV.

### Synthesis Example 4

### Synthesis of 10-chlorophenothiabismine-5,5-dioxide derivative

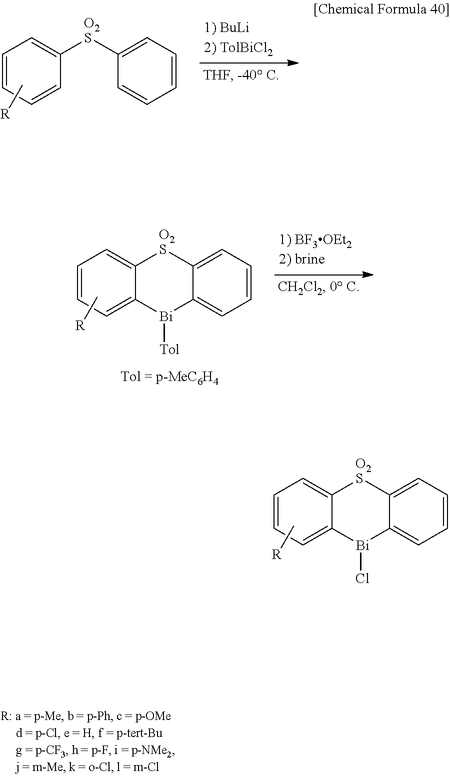

The above synthetic reaction was effected according to the following procedure to synthesize each of the 10-chlorophenothiabismine-5,5-dioxide derivatives of (a) to (l) below.

Into a 100 mL two-neck flask, phenylarylsulfone (10 mmol) and 100 mL of THF were charged and the resultant reaction mixture was cooled down to −40° C. Thereto, n-butyryl lithium (1.6 M hexane solution, 20 mmol) was added to prepare a dilithiated body suspension. To this suspension, 50 mL of a dichloro(4-methylphenyl)bismuthane (TolBiCl₂)(10 mmol) ether suspension was added and while returning the temperature of the resultant reaction mixture to room temperature, the reaction mixture was stirred for 3 hours. The reaction mixture was charged into 50 mL of a saturated brine and the resultant reaction mixture was extracted with ethyl acetate, followed by concentrating the extract by an evaporator. The obtained oily residue was separating-purified by silica gel column chromatography (hexane:ethyl acetate=5:1) thereby obtaining 10-(4′-methylphenyl)phenothiabismine-5,5-dioxide as a crude product. This compound (1 mmol) was dissolved in 5 mL of dichloromethane and to the resultant solution, a boron trifluoride diethyl ether complex (3 mmol) was added at 0° C. By TLC, the disappearance of the substrate was confirmed and to the reaction mixture, 5 mL of a saturated brine was added, followed by extracting the resultant reaction mixture with ethyl acetate. The extract was concentrated by an evaporator and the obtained oily residue was crystallized in methanol thereby obtaining a 10-chlorophenothiabismine-5,5-dioxide derivative.

NMR data of each derivative are shown as follows.

### Numerical Data 4-1

### 10-chloro-2-methylphenothiabismine-5,5-dioxide (a)

(yield: 18%)

mp 186-189° C.; ¹H NMR (400 MHz, CDCl₃): δ2.24 (3H, s), 7.26 (1H, d, J=7.6 Hz), 7.47 (1H, t, J=8.0 Hz), 7.72 (1H, t, J=8.0 Hz), 8.24 (1H, d, J=7.6 Hz), 8.33 (1H, d, J=7.6 Hz), 8.65 (1H, s), 8.83 (1H, d, J=8.0 Hz). Anal. Calc. for C₁₃H₁₀BiClO₂S: C, 32.89; H, 2.12. Found: C, 32.71; H, 2.08%.

### Numerical Data 4-2

### 10-chloro-2-phenylphenothiabismine-5,5-dioxide (b)

(yield: 19%)

mp 151-154° C.; ¹H NMR (400 MHz, CDCl₃): δ7.41 (1H, d, J=7.2 Hz), 7.47 (2H, t, J=7.6 Hz), 7.50 (1H, dt, J=0.8, 7.6 Hz), 7.60 (2H, d, J=8.0 Hz), 7.66 (1H, dd, J=1.6, 8.0 Hz), 7.75 (1H, dt, J=1.2, 7.2 Hz), 8.37 (1H, dd, J=1.2, 8.0 Hz), 8.41 (1H, d, J=8.0 Hz), 8.85 (1H, d, J=7.2 Hz), 9.05 (1H, d, J=1.6 Hz).

### Numerical Data 4-3

### 10-chloro-2-methoxyphenothiabismine-5,5-dioxide (c)

(yield: 32%)

mp 146-149° C.; ¹H NMR (400 MHz, CDCl₃): δ3.83 (3H, s), 6.90 (1H, dd, J=2.2, 8.5 Hz), 7.47 (1H, t, J=7.6 Hz), 7.72 (1H, t, J=7.6 Hz), 8.29 (1H, d, J=7.6 Hz), 8.31 (1H, d, J=7.6 Hz), 8.43 (1H, d, J=2.2 Hz), 8.82 (1H, d, J=7.6 Hz). Anal. Calc. for C₁₃H₁₀BiClO₃S: C, 31.82; H, 2.05. Found: C, 31.83; H, 2.03%.

### Numerical Data 4-4

### 2,10-dichlorophenothiabismine-5,5-dioxide (d)

(yield: 23%)

mp 169-172° C.; ¹H NMR (400 MHz, CDCl₃): δ7.44 (1H, dd, J=2.0, 8.4 Hz), 7.50 (1H, dt, J=1.2, 7.6 Hz), 7.77 (1H, dt, J=1.2, 7.6 Hz), 8.27 (1H, d, J=8.4 Hz), 8.35 (1H, d, J=8.0 Hz), 8.80 (1H, d, J=1.6 Hz), 8.85 (1H, d, J=7.6 Hz). Anal. Calc. for C₁₂H₇BiCl₂O₂S: C, 29.11; H, 1.42. Found: C, 29.20; H, 1.48%.

### Numerical Data 4-5

### 10-chlorophenothiabismine-5,5-dioxide (e)

(yield: 30%)

mp 222-225° C.; ¹H NMR (400 MHz, CDCl₃): δ7.40 (2H, dt, J=1.2, 7.2 Hz), 7.55 (2H, dt, J=1.2, 7.2 Hz), 8.15 (2H, dd, J=1.2, 7.2 Hz), 8.64 (2H, dd, J=1.2, 7.2 Hz). Anal. Calc. for C₁₂H₈BiClO₂S: C, 31.30; H, 1.75. Found: C, 30.8; H, 1.7%.

### Numerical Data 4-6

### 10-chloro-2-tert-butylphenothiabismine-5,5-dioxide (f)

(yield: 15%)

mp 183-185° C.; ¹H NMR (400 MHz, CDCl₃): δ1.35 (9H, s), 7.46-7.49 (2H, m), 7.72 (1H, dt, J=1.2, 7.6 Hz), 8.28 (1H, d, J=8.0 Hz), 8.34 (1H, d, J=8.0 Hz), 8.83 (1H, d, J=7.6 Hz), 8.90 (1H, d, J=1.6 Hz). Anal. Calc. for C₁₆H₁₆BiClO₂S: C, 37.19; H, 3.12. Found: C, 37.15; H, 3.08%.

### Numerical Data 4-7

### 10-chloro-2-trifluoromethylphenothiabismine-5,5-dioxide (g)

(yield: 9%)

mp 116-119° C.; ¹H NMR (400 MHz, CDCl₃): δ7.51 (1H, t, J=6.0 Hz), 7.73 (1H, d, J=6.4 Hz), 7.79 (1H, t, J=6.0 Hz), 8.38 (1H, d, J=6.0 Hz), 8.43 (1H, d, J=6.2 Hz), 8.87 (1H, d, J=6.0 Hz), 9.06 (1H, s).

### Numerical Data 4-8

### 10-chloro-2-fluorophenothiabismine-5,5-dioxide (h)

(yield: 15%)

mp 195-197° C.; ¹H NMR (400 MHz, CDCl₃): δ7.12 (1H, dt, J=8.4, 2.4 Hz), 7.50 (1H, t, J=7.6 Hz), 7.76 (1H, dt, J=6.0, 1.2 Hz), 8.34-8.39 (2H, m), 8.59 (1H, dd, J=6.8, 2.8 Hz), 8.39 (1H, d, J=7.6 Hz).

### Numerical Data 4-9

### 2-dimethylamino-10-chlorophenothiabismine-5,5-dioxide (i)

(yield: 22%)

mp 253-257° C.; ¹H NMR (400 MHz, CDCl₃): δ3.07 (6H, s), 6.55 (1H, dd, J=2.4, 8.8 Hz), 7.43 (1H, dt, J=0.8, 7.6 Hz), 7.67 (1H, dt, J=1.2, 7.6 Hz), 8.17 (1H, d, J=2.4 Hz), 8.17 (1H, d, J=8.8 Hz), 8.26 (1H, dd, J=0.8, 7.6 Hz), 8.79 (1H, d, J=8.0 Hz). Anal. Calc. for C₁₄H₁₃BiClNO₂S: C, 33.38; H, 2.60; N, 2.78. Found: C, 33.65; H, 2.59; N, 2.73%.

### Numerical Data 4-10

### 10-chloro-3-methylphenothiabismine-5,5-dioxide (j)

(yield: 4%)

mp 102-104° C.; ¹H NMR (400 MHz, CDCl₃): δ2.40 (3H, s), 7.47 (1H, dt, J=0.8, 7.6 Hz), 7.54 (1H, dd, J=1.2, 7.6 Hz), 7.72 (1H, dd, J=1.2, 7.6 Hz), 8.16 (1H, d, J=0.8 Hz), 8.33 (1H, dd, J=1.2, 7.6 Hz), 8.71 (1H, d, J=7.2 Hz), 8.82 (1H, dd, J=0.8, 7.6 Hz). Anal. Calc. for C₁₃H₁₀BiClO₂S: C, 32.89; H, 2.12. Found: C, 32.96; H, 2.11%.

### Numerical Data 4-11

### 4,10-dichlorophenothiabismine-5,5-dioxide (k)

(yield: 22%)

mp 179-181° C.; ¹H NMR (400 MHz, CDCl₃): δ7.38 (1H, dd, J=1.2, 8.0 Hz), 7.47-7.57 (2H, m), 7.89 (1H, dt, J=1.2, 7.2 Hz), 8.43 (1H, dd, J=1.2, 8.0 Hz), 8.74 (1H, dd, J=0.8, 7.2 Hz), 8.89 (1H, dd, J=1.2, 7.2 Hz). Anal. Calc. for C₁₂H₇BiCl₂O₂S: C, 29.11; H, 1.42. Found: C, 29.63; H, 1.47%.

### Numerical Data 4-12

### 1,10-dichlorophenothiabismine-5,5-dioxide (1)

(yield: 35%)

mp 189-193° C.; ¹H NMR (400 MHz, CDCl₃): δ7.43 (1H, t, J=7.6 Hz), 7.54 (1H, dt, J=1.2, 7.6 Hz), 7.74 (1H, dd, J=0.8, 8.0 Hz), 7.84 (1H, dt, J=1.2, 7.6 Hz), 8.24 (1H, dd, J=0.8, 7.6 Hz), 8.44 (1H, dd, J=0.8, 7.6 Hz), 9.08 (1H, dd, J=0.8, 7.6 Hz).

### Synthesis Example 5

### Synthesis of 10-chloro-2,8-dihydroxyphenothiabismine-5,5-dioxide

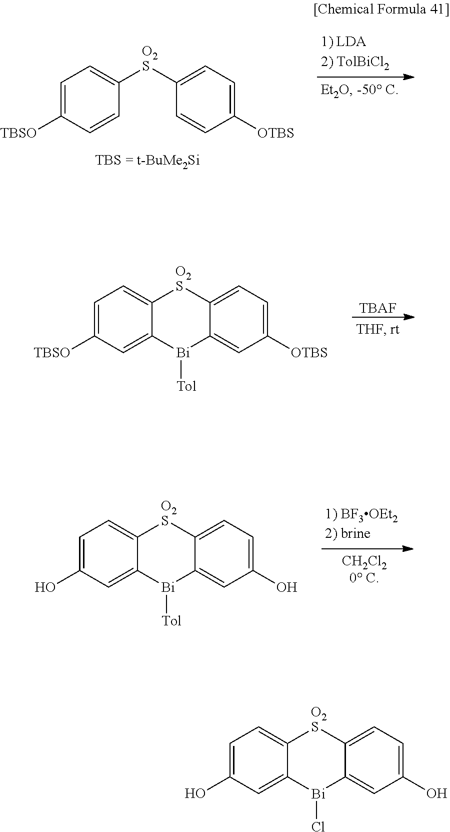

The above synthetic reaction was effected according to the following procedure to synthesize 10-chloro-2,8-dihydroxyphenothiabismine-5,5-dioxide.

Into a 100 mL two-neck flask, 4,4′-bis(tert-butyldimethylsilyloxy)diphenylsulfone) (4.31 g, 9 mmol) and 30 mL of ether were charged and the resultant reaction mixture was cooled down to −50° C. Thereto, 20 mL of a lithium isopropylamide (LDA, 18.9 mmol) ether solution was added and the temperature of the resultant reaction mixture was elevated to room temperature to prepare a dilithiated body solution. To this solution, 50 mL of a dichloro(4-methylphenyl)bismuthane (10 mmol) ether suspension was added and while returning the temperature of the resultant reaction mixture to room temperature, the reaction mixture was stirred for 3 hours. The reaction mixture was charged into 50 mL of a saturated brine and the resultant reaction mixture was extracted with ethyl acetate, followed by concentrating the extract by an evaporator. The obtained oily residue was separating-purified by silica gel column chromatography (hexane:ethyl acetate=20:1) thereby obtaining 3.2 g (yield: 48%) of 2,8-bis(tert-butyldimethylsilyloxy)-10-(4′-methylphenyl)phenothiabismine-5,5-dioxide as a crude product. 820 mg (1.1 mmol) of this compound was dissolved in 10 mL of THF and to the resultant solution, 2.1 mL (1M, THF, 2.1 mmol) of a tetrabutylammonium fluoride solution was added at 0° C. to effect the reaction at room temperature. By TLC, the disappearance of the substrate was confirmed and to the reaction mixture, 5 mL of a saturated brine was added, followed by extracting the resultant reaction mixture with ethyl acetate. The extract was concentrated by an evaporator and the obtained oily residue was crystallized in methanol thereby obtaining 287 mg (yield: 47%) of 10-(4′-methylphenyl)-2,8-dihydroxyphenothiabismine-5,5-dioxide. This compound (287 mg, 0.52 mmol) was dissolved in 5 mL of dichloromethane and to the resultant solution, a boron trifluoride diethyl ether complex (3 mmol) was added at 0° C. By TLC, the disappearance of the substrate was confirmed and to the reaction mixture, 5 mL of a saturated brine was added, followed by extracting the resultant reaction mixture with ethyl acetate. The extract was concentrated by an evaporator and the obtained oily residue was crystallized in methanol thereby obtaining 222 mg (yield: 87%) of 10-chloro-2,8-dihydroxyphenothiabismine-5,5-dioxide.

NMR data of the obtained substance are shown as follows.

### Numerical Data 5

mp 250° C. (decomp.); ¹H NMR (400 MHz, DMSO-d₆): 6.74 (2H, dd, J=2.4, 8.4 Hz), 8.07 (2H, d, J=8.4 Hz), 8.28 (2H, d, J=2.4 Hz), 10.50 (2H, s); IR (KBr): ν=3560, 3500, 3550 (br), 1580, 1560, 1420, 1320, 1300, 1290, 1210, 1150, 1120, 1100, 1060, 1010, 880, 870, 830, 710, 690, 580, 560, 530 and 510 cm⁻¹.

### Synthesis Example 6

### Synthesis of 10-chlorophenothiabismine-5-oxide derivative

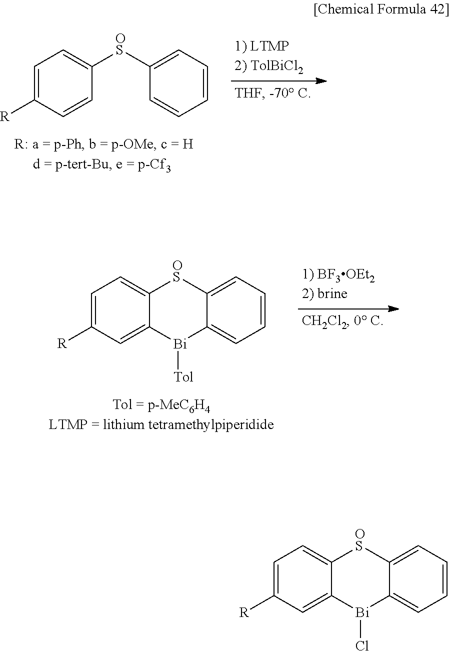

Into a 100 mL two-neck flask, phenylarylsulfoxide (1 mmol) and 10 mL of THF were charged and the resultant reaction mixture was cooled down to −70° C. Thereto, a lithium 2,2,6,6-tetramethylpiperidine (LTMP, 2 mmol) THF solution was added to prepare a dilithiated body solution. To this solution, 10 mL of a dichloro(4-methylphenyl)bismuthane (1 mmol) ether suspension was added and while returning the temperature of the resultant reaction mixture to room temperature, the reaction mixture was stirred for 3 hours. The reaction mixture was charged into 25 mL of a saturated brine and the resultant reaction mixture was extracted with ethyl acetate, followed by concentrating the extract by an evaporator. The obtained oily residue was separating-purified by silica gel column chromatography (hexane:ethyl acetate=5:1) thereby obtaining 10-(4′-methylphenyl)phenothiabismine-5-oxide as a crude product. This crude product (0.5 mmol) was dissolved in 5 mL of dichloromethane and to the resultant solution, a boron trifluoride diethyl ether complex (1.5 mmol) was added at 0° C. By TLC, the disappearance of the substrate was confirmed and to the reaction mixture, 5 mL of a saturated brine was added, followed by extracting the resultant reaction mixture with ethyl acetate. The extract was concentrated by an evaporator and the obtained oily residue was crystallized in methanol thereby obtaining a 10-chlorophenothiabismine-5-oxide derivative.

NMR data of each derivative are shown as follows.

### Numerical Data 6-1

### 10-chloro-2-phenylphenothiabismine-5-oxide (a)

(yield: 7%)

mp 171-172° C.; ¹H NMR (400 MHz, CDCl₃): δ 7.38 (1H, t, J=7.2 Hz), 7.42-7.46 (3H, m), 7.55-7.60 (4H, m), 8.17 (1H, d, J=7.6 Hz), 8.21 (1H, d, J=8.0 Hz), 8.65 (1H, d, J=7.6 Hz), 8.85 (1H, d, J=1.6 Hz).

### Numerical Data 6-2

### 10-chloro-2-methoxyphenothiabismine-5-oxide (b)

(yield: 16%)

mp 219-222° C.; ¹H NMR (400 MHz, CDCl₃): δ 3.86 (3H, s), 6.84 (1H, dd, J=2.8, 8.0 Hz), 7.39 (1H, dt, J=1.2, 7.6 Hz), 7.55 (1H, dt, J=1.2, 7.6 Hz), 8.11 (2H, d, J=8.0 Hz), 8.21 (1H, d, J=2.8 Hz), 8.62 (1H, d, J=6.4 Hz).

### Numerical Data 6-3

### 10-chlorophenothiabismine-5-oxide (c)

(yield: 10%)

¹H NMR (400 MHz, CDCl₃): δ 7.40 (2H, dt, J=1.1, 7.5 Hz), 7.55 (21-1, dt, J=1.1, 7.3 Hz), 8.15 (2H, dd, J=0.7, 7.5 Hz), 8.63 (21-1, dd, J=0.8, 7.3 Hz).

### Numerical Data 6-4

### 10-chloro-2-tert-butylphenothiabismine-5-oxide (d)

(yield: 10%)

mp 99-102° C.; ¹H NMR (400 MHz, CDCl₃): δ 1.33 (9H, s), 7.38-7.42 (2H, m), 7.55 (1H, dt, J=1.2, 7.2 Hz), 8.10 (1H, d, J=8.0 Hz), 8.13 (1H, dd, J=1.2, 7.6 Hz), 8.63 (1H, dd, J=1.2, 7.6 Hz), 8.70 (1H, d, J=1.6 Hz).

### Numerical Data 6-5

### 10-chloro-2-trifluoromethylphenothiabismine-5-oxide (e)

(yield: 8%)

mp 114-118° C.; ¹H NMR (400 MHz, CDCl₃): δ 7.44 (1H, t, J=7.2 Hz), 7.60 (1H, t, J=7.2 Hz), 7.66 (1H, d, J=8.0 Hz), 8.18-8.21 (2H, m), 8.65 (1H, d, J=8.0 Hz), 8.87 (1H, s).

### Light-Emitting Characteristics of 1-phenyl-3,6-bis(trimethylsilyl)dithienobismole

1-phenyl-3,6-bis(trimethylsilyl)dithienobismole emitted red light by an ultraviolet ray excitation (365 nm) in a solid powder state and in a solution state (solvent: chloroform or 2-methyltetrahydrofuran). The red light emission in a solution state was not observed in the atmosphere, but was observed only in an inert gas atmosphere.

This red light emission exhibited both in the solid powder state and in the solution (solvent:chloroform or 2-methyltetrahydrofuran) a light emission peak at around 625 nm. The excitation life of the red light emission was measured in a chloroform solution and a component having a life of 5.6 μs was observed.

### Light-Emitting Characteristics of 1-phenyl-2,7-dimethyl-3,6-bis(trimethylsilyl)dithienobismole

1-phenyl-2,7-dimethyl-3,6-bis(trimethylsilyl)dithienobismole emitted red light by an ultraviolet ray excitation (365 nm) in a solid powder state and in a solution state (chloroform). The red light emission was not observed in the atmosphere, but was observed only in an inert gas atmosphere.

This red light emission exhibited both in a solid powder state and in a solution (solvent:chloroform) a light emission peak at around 635 nm. The excitation life of the red light emission was measured in a chloroform solution and a component having a life of 6.3 μs was observed.

### Light-Emitting Characteristics Of 1-phenyl-2,4-di(benzo[b]thieno)bismole

1-phenyl-2,4-di(benzo[b]thieno)bismole emitted red light by an ultraviolet ray excitation (365 nm) in a solution state (solvent:chloroform). The red light emission was not observed in the atmosphere, but was observed only in an inert gas atmosphere.

This red light emission exhibited both in the solution (solvent:chloroform) a light emission peak at around 600 nm. The excitation life of the red light emission was measured in a chloroform solution and a component having a life of 2.1 μs was observed.

### <Production Example of Thin Film 1>

1-phenyl-3,6-bis(trimethylsilyl)dithienobismole obtained in Synthesis Example 1 was added to chloroform/1,2-dichloroethane (weight ratio=2/1) to dissolve 1-phenyl-3,6-bis(trimethylsilyl)dithienobismole thereby preparing prepare a 1% by weight bismuth compound solution. 1-phenyl-3,6-bis(trimethylsilyl)dithienobismole was extremely rapidly dissolved in chloroform/1,2-dichloroethane (weight ratio=2/1). Using the obtained solution, a film was formed on a glass substrate by a spin coating method at a rate of 1,000 rpm. The obtained film was measured by a pin sensing-type film thickness meter (trade name: DEKTAK; manufactured by Veeco Instruments Inc.) and, it was confirmed that a homogeneous thin film of about 80 nm was obtained. While blowing an argon gas to the thin film, the thin film was irradiated with an ultraviolet ray (365 nm) and then, it was observed that the whole surface of the thin film homogeneously emitted red light.

<Production Example of Thin Film 2>

1-phenyl-2,7-dimethyl-3,6-bis(trimethylsilyl)dithienobismole obtained in Synthesis Example 2 and poly(9-vinylcarbazole) (weight ratio=1/4) were added to toluene to dissolve 1-phenyl-2,7-dimethyl-3,6-bis(trimethylsilyl)dithienobismole thereby preparing a 1% by weight solution of the bismuth compound and poly(9-vinylcarbazole). 1-phenyl-3,6-bis(trimethylsilyl)dithienobismole was extremely rapidly dissolved in toluene. Using the obtained solution, a film was formed on a glass substrate by a spin coating method at a rate of 1,000 rpm. The obtained film was measured by a pin sensing-type film thickness meter (trade name: DEKTAK; manufactured by Veeco Instruments Inc.) and it was confirmed that a homogeneous thin film of about 40 nm was obtained. While blowing an argon gas to the thin film, the thin film was irradiated with an ultraviolet ray (365 nm) and then, it was observed that the whole surface of the thin film homogeneously emitted red light.

<Production Example of Element 1>

On a glass substrate on which an ITO film was formed in a thickness of 150 nm by a sputtering method, a thin film of the bismuth compound was produced in a film thickness of 80 nm according to <Production example of thin film 1> in a nitrogen atmosphere and next, lithium fluoride and further aluminum were deposited thereon in about 1 nm and about 80 nm respectively to prepare a cathode thereby producing an element. The element was irradiated with an ultraviolet ray (365 nm) and then, a homogeneous red light emission was observed on a lighting face.

### <Production Example of Element 2>

On a glass substrate on which an ITO film was formed in a thickness of 150 nm by a sputtering method, a thin film of the bismuth compound and poly(9-vinylcarbazole) was produced in a film thickness of 40 nm according to <Production example of thin film 2> in a nitrogen atmosphere and next, lithium fluoride and further aluminum were deposited thereon in about 0.5 nm and about 80 nm respectively to prepare a cathode thereby producing an element. The element was irradiated with an ultraviolet ray (365 nm) and then, a homogeneous red light emission was observed on a lighting face.

<Stability of Compound>

Each of 1-phenyl-3,6-bis(trimethylsilyl)dithienobismole, 1-phenyl-2,7-dimethyl-3,6-bis(trimethylsilyl)dithienobismole, and 1-phenyl-2,4-di(benzo[b]thieno)bismole was dissolved in hexane (10⁻⁵ g/L) and the solution state was left to stand over one night. Before and after the leaving, the UV-VIS absorption spectra of the solution were measured and the forms of the spectra before and after the leaving were compared with each other. With respect to 1-phenyl-3,6-bis(trimethylsilyl)dithienobismole, the absorption spectrum was largely changed, so that the decomposition of the compound was confirmed. On the other hand, with respect to 1-phenyl-2,7-dimethyl-3,6-bis(trimethylsilyl)dithienobismole and 1-phenyl-2,4-di(benzo[b]thieno)bismole, there was substantially no change in the absorption spectrum, so that the compound was confirmed to be not decomposed. With respect to 1-phenyl-2,7-dimethyl-3,6-bis(trimethylsilyl)dithienobismole and 1-phenyl-2,4-di(benzo[b]thieno)bismole, this solution state was left to stand further for several weeks and then, no decomposition of the compound was observed, so that the compound existed stably.

1. A thin film comprising a compound of Formula (1): 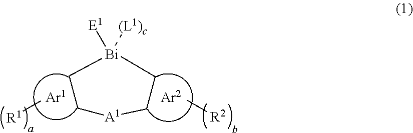
wherein Ar¹ and Ar² are each independently a C₃₋₃₀ aromatic ring; R¹ and R² are a substituent; a and b are each independently an integer of 0 to 12, wherein when a is 2 or more, each R¹ is optionally different from each other and two R¹ are optionally bonded with each other to form a ring structure, and when b is 2 or more, each R² is optionally different from each other and two R² are optionally bonded with each other to form a ring structure; A¹ is any of direct bond, —O—, —S—, —S(═O)—, —S(═O)₂—, —PR³—, —NR⁴—, and —C(—R⁵)₂—; R³ is a hydrogen atom or a substituent; R⁴ is a hydrogen atom or a substituent; R⁵ is a hydrogen atom or a substituent and two R⁵ are optionally different from each other; E¹ is a monovalent group having 50 or less carbon atoms; L¹ is a ligand having 50 or less carbon atoms; c is an integer of 0 to 3, wherein when c is 2 or more, each L¹ is optionally different from each other; and each combination of a combination of E¹ and Ar¹ and a combination of E¹ and Ar² optionally forms a bond; and when c is 1 to 3, each combination of a combination of L¹ and E¹, a combination of L¹ and Ar¹, a combination of L¹ and Ar², and a combination of L¹ and L¹ optionally forms a bond.

2. The thin film according to claim 1, wherein the compound of Formula (1) is a compound of Formula (2): 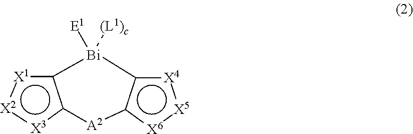
wherein A² is any of direct bond, —O—, —S—, —PR³—, —NR⁴—, and —C(—R⁵)₂—; two of X¹, X², and X³ are —CR⁶═ and remaining one thereof is —S—, —O—, or —NR⁷—; two of X⁴, X⁵, and X⁶ are —CR⁶═ and remaining one thereof is —S—, —O—, or —NR⁷—; E¹, L¹, and c are the same as defined above; R⁶ is a hydrogen atom or a substituent; R⁷ is a hydrogen atom or a substituent; when each R⁶ is adjacent to each other, each R⁶ optionally forms together with each other a bond and when R⁶ and R⁷ are adjacent to each other, R⁶ and R⁷ optionally form together with each other a bond; when X¹ or X² is —CR⁶═ or —NR⁷—, R⁶ or R⁷ optionally forms together with E¹ a bond; when X⁴ or X⁵ is —CR⁶═ or —NR⁷— and c is 1 to 3, R⁶ or R⁷ optionally forms together with L¹ a bond; and when c is 1 to 3, each combination of a combination of E¹ and L¹ and a combination of L¹ and L¹ optionally forms together with each other a bond).

3. The thin film according to claim 2, wherein, in Formula (1) or (2), A¹ or A² is direct bond; two of X¹, X², and X³ are —CR⁶═ and remaining one thereof is —S—; and two of X⁴, X⁵, and X⁶ are —CR⁶═ and remaining one thereof is —S—.

4. A thin film comprising a compound that has a number average molecular weight in terms of polystyrene of 10³ to 10⁷ and comprises a constitutional unit composed of a structure in which one or two or more hydrogen atoms are removed from a compound of Formula (1): 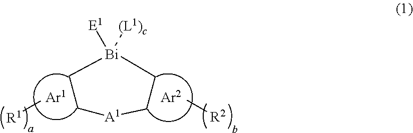
wherein Ar¹ and Ar² are each independently a C₃₋₃₀ aromatic ring; R¹ and R² are each a substituent; a and b are each independently an integer of 0 to 12, wherein when a is 2 or more, each R¹ is optionally different from each other and two R¹ are optionally bonded with each other to form a ring structure, and when b is 2 or more, R² are optionally different from each other and two R² are optionally bonded with each other to form a ring structure; A¹ is any of direct bond, —O—, —S—, —S(═O)—, —S(═O)₂—, —PR³—, —NR⁴—, and —C(—R⁵)₂—; R³ is a hydrogen atom or a substituent; R⁴ is a hydrogen atom or a substituent; R⁵ is a hydrogen atom or a substituent and two R⁵ are optionally different from each other; E¹ is a monovalent group having 50 or less carbon atoms; L¹ is a ligand having 50 or less carbon atoms; c is an integer of 0 to 3, wherein when c is 2 or more, each L¹ is optionally different from each other; and each combination of a combination of E¹ and Ar¹ and a combination of E¹ and Ar² optionally forms a bond; and when c is 1 to 3, each combination of a combination of L¹ and E¹, a combination of L¹ and Ar¹, a combination of L¹ and Ar², and a combination of L¹ and L¹ optionally forms a bond.

5. The thin film according to claim 1, wherein the thin film has a film thickness in a range of 0.2 nm to 1 mm.

6. An element having the thin film according to claim 1.

7. A thin film forming composition comprising a compound of Formula (1): 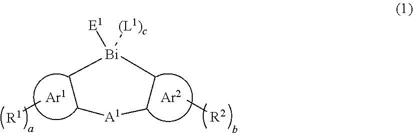
wherein Ar¹ and Ar² are each independently a C₃₋₃₀ aromatic ring; R¹ and R² are each a substituent; a and b are independently an integer of 0 to 12, wherein when a is 2 or more, each R¹ is optionally different from each other and two R¹ are optionally bonded with each other to form a ring structure, and when b is 2 or more, each R² is optionally different from each other and two R² are optionally bonded with each other to form a ring structure; A¹ is any of direct bond, —O—, —S—, —S(═O)—, —S(═O)₂—, —PR³—, —NR⁴—, and —C(—R⁵)₂—; R³ is a hydrogen atom or a substituent; R⁴ is a hydrogen atom or a substituent; R⁵ is a hydrogen atom or a substituent and two R⁵ are optionally different from each other; E¹ is a monovalent group having 50 or less carbon atoms; L¹ is a ligand having 50 or less carbon atoms; c is an integer of 0 to 3, wherein when c is 2 or more, each L¹ is optionally different from each other; and each combination of a combination of E¹ and Ar¹ and a combination of E¹ and Ar² optionally forms a bond; and when c is 1 to 3, each combination of a combination of L¹ and E¹, a combination of L¹ and Ar¹, a combination of L¹ and Ar², and a combination of L¹ and L¹ optionally forms a bond; and
an organic solvent.

8. A compound of Formula (3): 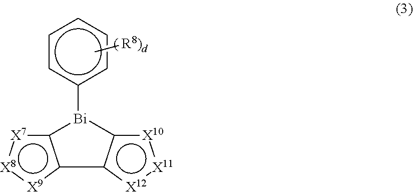
wherein R⁸ is a substituent; d is an integer of 0 to 5, wherein when d is 2 or more, each R⁸ is optionally different from each other and when each R⁸ is adjacent to each other, each R⁸ optionally forms together with each other a bond; two of X⁷, X⁸, and X⁹ are —CR⁹═ and remaining one thereof is —S—; two of X¹⁰, X¹¹, and X¹² are —CR⁹═ and remaining one thereof is —S—; R⁹ is a hydrogen atom or a substituent; a plurality of R⁹ are optionally different from each other; the substituent as R⁹ is selected from the group consisting of a hydrocarbyl group optionally having a substituent, a hydrocarbyloxy group optionally having a substituent, and a silyl group optionally having a substituent; at least one of R⁹ is the substituent; and when a plurality of R⁹ are the substituent, each R⁹ adjacent to each other optionally forms together with each other a bond.

9. A compound of Formula (3′): 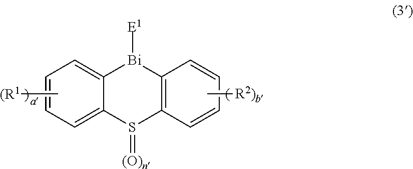
wherein R¹ and R² are a substituent; a′ and b′ are each independently an integer of 0 to 4, wherein when a′ is 2 or more, each R¹ is optionally different from each other and two R¹ are optionally bonded with each other to form a ring structure, and when b′ is 2 or more, each R² is optionally different from each other and two R² are optionally bonded with each other to form a ring structure; E¹ is a monovalent group having 50 or less carbon atoms; and n′ is 1 or 2.

10. A compound having a number average molecular weight in terms of polystyrene of 10³ to 10⁷ and comprising a constitutional unit composed of a structure in which one or two or more hydrogen atoms are removed from a compound of Formula (1): 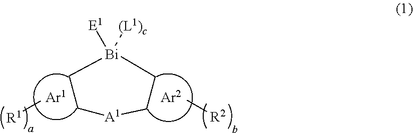
wherein Ar¹ and Ar² are each independently a C₃₋₃₀ aromatic ring; R¹ and R² are each a substituent; a and b are each independently an integer of 0 to 12, wherein when a is 2 or more, R¹ are optionally different from each other and two R¹ are optionally bonded with each other to form a ring structure, and when b is 2 or more, each R² is optionally different from each other and two R² are optionally bonded with each other to form a ring structure; A¹ is any of direct bond, —O—, —S—, —S(═O)—, —S(═O)₂—, —PR³—, —NR⁴—, and —C(—R⁵)₂—; R³ is a hydrogen atom or a substituent; R⁴ is a hydrogen atom or a substituent; R⁵ is a hydrogen atom or a substituent and two R⁵ are optionally different from each other; E¹ is a monovalent group having 50 or less carbon atoms; L¹ is a ligand having 50 or less carbon atoms; c is an integer of 0 to 3, wherein when c is 2 or more, each L¹ is optionally different from each other; and each combination of a combination of E¹ and Ar¹ and a combination of E¹ and Ar² optionally forms a bond; and when c is 1 to 3, each combination of a combination of L¹ and E¹, a combination of L¹ and Ar¹, a combination of L¹ and Ar², and a combination of L¹ and L¹ optionally forms a bond.

11. The compound according to claim 10, wherein the compound of Formula (1) is a compound of Formula (2): 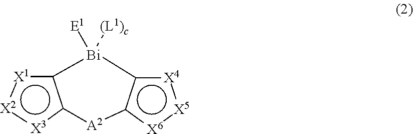
wherein A² is any of direct bond, —O—, —S—, —PR³—, —NR⁴—, and —C(—R⁵)₂—; two of X¹, X², and X³ are —CR⁶═ and remaining one thereof is —S—, —O—, or —NR⁷—; two of X⁴, X⁵, and X⁶ are —CR⁶═ and remaining one thereof is —S—, —O—, or —NR⁷—; E¹, L¹, and c are the same as defined above; R⁶ is a hydrogen atom or a substituent; R⁷ is a hydrogen atom or a substituent; when each R⁶ is adjacent to each other, R⁶ optionally forms together with each other a bond; when R⁶ and R⁷ are adjacent to each other, R⁶ and R⁷ optionally form together with each other a bond; when X¹ or X² is —CR⁶═ or —NR⁷—, R⁶ or R⁷ optionally forms together with E¹ a bond; when X⁴ or X⁵ is —CR⁶═ or —NR⁷— and c is 1 to 3, R⁶ or R⁷ optionally forms together with L¹ a bond; and when c is 1 to 3, each combination of a combination of E¹ and L¹ and a combination of L¹ and L¹ optionally forms together with each other a bond.

12. The thin film according to claim 1, wherein in the compound of Formula (1), an energy difference (S1−T1) between a lowest singlet excitation energy (S1) and a lowest triplet excitation energy (T1) obtained by a computational scientific technique is 1.5 (eV) or less.
